(19) United States
(12) Patent Application Publication
(10) Pub. No.: US 2024/0339671 A1
(43) Pub. Date: Oct. 10, 2024

(54) Semi-Solid Electrolyte Systems for High-Voltage Aqueous Zinc-Ion Batteries

(71) Applicant: Board of Regents, The University of Texas System, Austin, TX (US)

(72) Inventors: Guoping Xiong, Richardson, TX (US); Siyu Tian, Richardson, TX (US); Kyeongjae Cho, Richardson, TX (US); Taesoon Hwang, Richardson, TX (US)

(21) Appl. No.: 18/631,895

(22) Filed: Apr. 10, 2024

Related U.S. Application Data
(60) Provisional application No. 63/495,240, filed on Apr. 10, 2023.

(51) Int. Cl. H01M 10/26; H01M 10/42

(52) U.S. Cl. CPC H01M 10/26; H01M 10/4235; H01M 2300/0005; H01M 2300/0085

(57) ABSTRACT

Disclosed herein are semi-solid electrolyte systems based on layered clay materials capable of higher water intercalation for high-voltage aqueous zinc-ion batteries. In alternate embodiments, an electrolyte system for aqueous zinc-ion batteries is based on a bentonite (BT) clay or a laponite clay (LP) and methods for intercalation. Additionally described herein are electrochemical cells including the semi-solid electrolyte. In alternate embodiments, the semi-solid electrolyte is also used as a separator in the electrochemical cell.

### CROSS-REFERENCE TO RELATED APPLICATION

This application claims priority to, and the benefit of, U.S. Provisional Patent Application No. 63/495,240, filed Apr. 10, 2023, entitled “Bentonite-based Electrolyte Systems for High-Voltage Aqueous Zinc-Ion Batteries,” which is incorporated by reference herein in its entirety.

### BACKGROUND

With the continuous consumption of limited fossil energy and the aggravation of environmental pollution, there is an urgent need to utilize renewable energy sources such as wind and sunlight. Therefore, high-performance energy storage devices that connect renewable energy sources-based electricity generators to electric power grid are highly in demand [3-5]. Among the energy storage devices, aqueous zinc-ion batteries have attracted tremendous research interest because of their advantages, such as low safety risks, abundant elemental resources, low cost, and eco-friendliness. Despite the recent progress in enhancing the electrochemical performance of aqueous zinc-ion batteries, their practical applications are still impeded by the unsatisfactory working voltage arising from water decomposition, including hydrogen evolution and oxygen evolution reactions. Generally, the working voltages of aqueous zinc-ion batteries using vanadium-based and manganese-based cathodes are below 1.6 and 1.8 V, respectively.

Aqueous zinc-ion batteries (AZIBs) have attracted tremendous research interest for grid-scale energy storage applications because of their benefits, such as low safety risks, abundant elemental resources, low cost, and eco-friendliness. Although the electrochemical performance of AZIBs has been improved over the past few years, there are still significant challenges impeding their practical use, attributed to the ubiquitous water-induced issues at Zn/electrolyte interfaces such as water decompositions (e.g., hydrogen evolution reaction-HER), zinc corrosions, and dendrite growth. These issues can cause fast performance degradation, rapid self-discharge, and quick catastrophic failure of AZIBs during charge/discharge. Even in resting, Zn metal anodes continuously react with water over the long term, leading to unsatisfactory shelf life of AZIBs. At elevated temperatures, water-induced parasitic reactions become more severe owing to the acceleration of chemical reactions, which further hindering the widespread usage of AZIBs.

In aqueous zinc-ion batteries, water plays a critical role in determining the physicochemical properties of electrolytes, electrode/electrolyte interfacial chemistries, and ultimately the electrochemical performance of batteries. The main bottleneck of aqueous electrolytes is the narrow electrochemical stability window of water, which is 1.23 V determined by its thermodynamic oxidation (oxygen evolution reaction) and reduction (hydrogen evolution reaction) potentials. Therefore, many strategies have been proposed to extend the electrochemical stability window of aqueous electrolyte systems, including water-in-salt and molecular crowding. In these electrolyte systems, a high concentration of salt or organic molecules is needed to stabilize the water molecules, which can extend the battery working voltage up to 2.1 V with the trade-offs of a substantially increased cost and a low battery capacity. In previous studies, different inorganic particles have also been added to the liquid electrolyte to enhance the cyclic stability of aqueous zinc-ion batteries. For instance, multiple natural clays (kaolinite, illite, chlorite, halloysite, attapulgite, vermiculite and allophane) have been added into the liquid electrolyte to formulate a colloidal electrolyte for aqueous zinc-ion batteries. Other aqueous electrolyte systems containing inorganic particles such as lithium magnesium silicate, palygorskite, SiO₂, V₂O₅, ZnO, and SnO have also been reported in previous studies. Although these natural clays and inorganic particles are cost-competitive and can enhance the cyclic stability of aqueous batteries, they fail to extend the battery working voltage above 1.8 V, exerting severe limitations on the energy/power densities of aqueous batteries and consequently their practical applications.

### SUMMARY

Disclosed herein are semi-solid electrolyte systems based on layered clay materials capable of higher water intercalation for high-voltage aqueous zinc-ion batteries. In alternate embodiments, an electrolyte system for aqueous zinc-ion batteries is based on a bentonite (BT) clay or a laponite clay (LP) and methods for intercalation. The semi-solid electrolyte system has several advantages, including low water activity, high ionic conductivity, high viscosity and high storage modulus. Therefore, the high-voltage aqueous zinc-ion batteries exhibit high capacity and excellent cyclic stability at a high working voltage of 2.4 V. Meanwhile, other issues associated with conventional liquid electrolytes, such as electrolyte leakage, Zn dendrite growth, Zn corrosion and byproduct formation are simultaneously reduced.

In some aspects, disclosed herein is an electrolyte including: a layered clay material including one or more intercalated ions, wherein the one or more intercalated ions form an intercalation layer.

In some aspects, the one or more intercalated ions are selected from lithium ions, calcium ions, potassium ions, magnesium ions, sodium ions, ammonium ions, fluoride ions, chloride ions, hydrogen ions, lanthanum ions, indium ions, and combinations thereof.

In some aspects, the layered clay material includes naturally occurring or synthetic swelling clays, or combinations thereof.

In some aspects, the layered clay material includes silicate, alumina, magnesia, or combinations thereof.

In some aspects, the intercalation layer further includes water.

In some aspects, an intercalation layer distance is varied by intercalation ion composition.

In some aspects, described herein is an electrochemical cell including: An anode and a cathode; and a semi-solid electrolyte including: a layered clay material including one or more intercalated ions, wherein the one or more intercalated ions form an intercalation layer; and an aqueous electrolyte.

In some aspects, in the electrochemical cell, the one or more intercalated ions are selected from lithium ions, calcium ions, potassium ions, magnesium ions, sodium ions, fluoride ions, chloride ions, ammonium ions, hydrogen ions, lanthanum ions, indium ions, or combination thereof.

In some aspects, in the electrochemical cell, the layered clay material includes naturally occurring or synthetic swelling clays, or combinations thereof.

In some aspects, in the electrochemical cell, the layered clay material includes silicate, alumina, magnesia, or combinations thereof.

In some aspects, in the electrochemical cell, the aqueous electrolyte salt includes a concentration of 1-3 Molar.

In some aspects, in the electrochemical cell, the semi-solid electrolyte includes up to 100% w/v of layered clay material in aqueous electrolyte.

In some aspects, in the electrochemical cell, the intercalation layer absorbs water from the aqueous electrolyte.

In some aspects, in the electrochemical cell, the semi-solid electrolyte acts as a separator.

In some aspects, in the electrochemical cell, the anode is a zinc-based anode.

In some aspects, in the electrochemical cell, the cathode includes vanadium-based oxides, manganese-based materials, Prussian blue analogues, cobalt-based oxides, polyanionic compounds, or combinations thereof.

In some aspects, the electrochemical cell operates at over 2 volts.

### BRIEF DESCRIPTION OF DRA WINGS

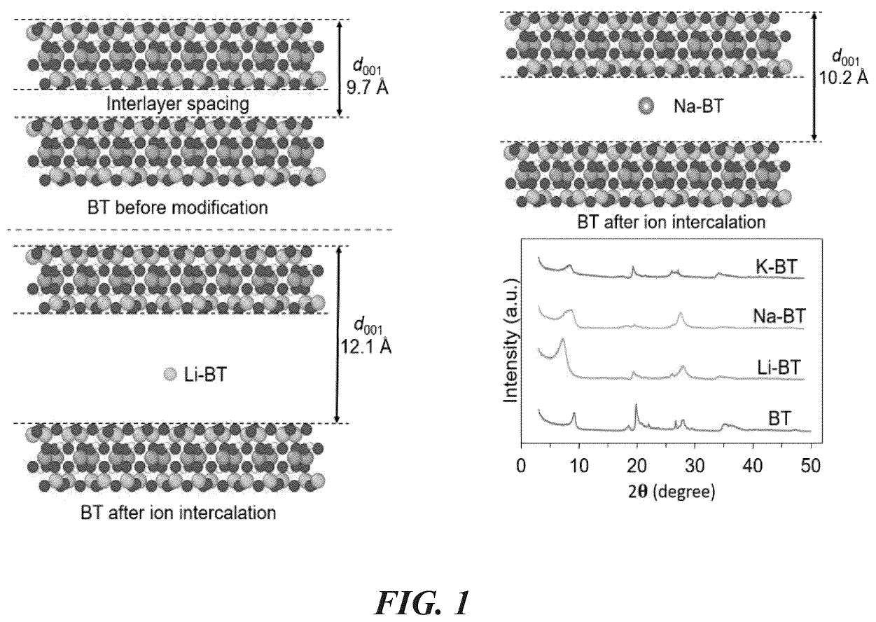

FIG. 1 shows chemical modifications of the swelling BT clay by Li⁺, K⁺, and Na⁺ via ion exchange, as confirmed by the XRD results (bottom right).

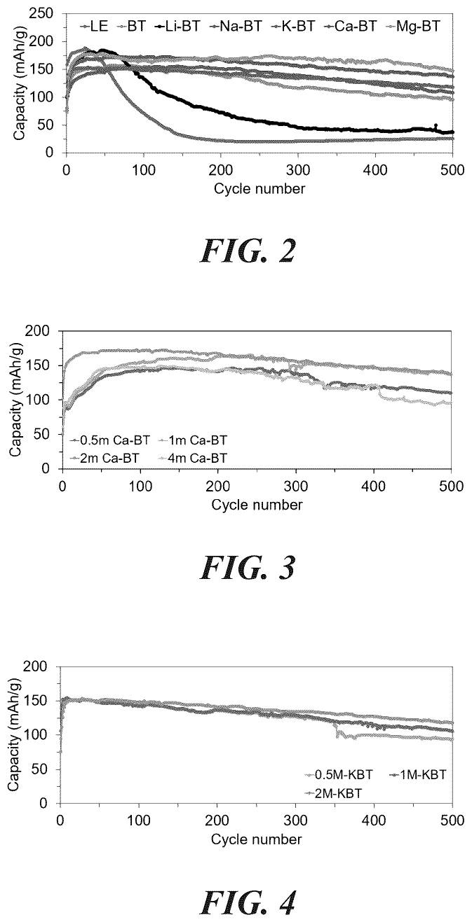

FIG. 2 shows cyclic stability of aqueous zinc-ion batteries based on different functionalized BT at a current density of 1 A/g and a working voltage window of 0.4-2.4 V.

FIG. 3 shows cyclic stability of aqueous zinc-ion batteries based on the BT functionalized by different CaCl₂) concentrations at a current density of 1 A/g and a working voltage window of 0.4-2.4 V. For instance, 0.5 m Ca-BT represents the BT functionalized in 0.5 mol/kg CaCl₂) solution.

FIG. 4 shows cyclic stability of aqueous zinc-ion batteries based on the BT functionalized by different KCl concentrations at a current density of 1 A/g and a working voltage window of 0.4-2.4 V. For instance, 0.5 m K-BT represents the BT functionalized in 0.5 mol/kg KCl solution.

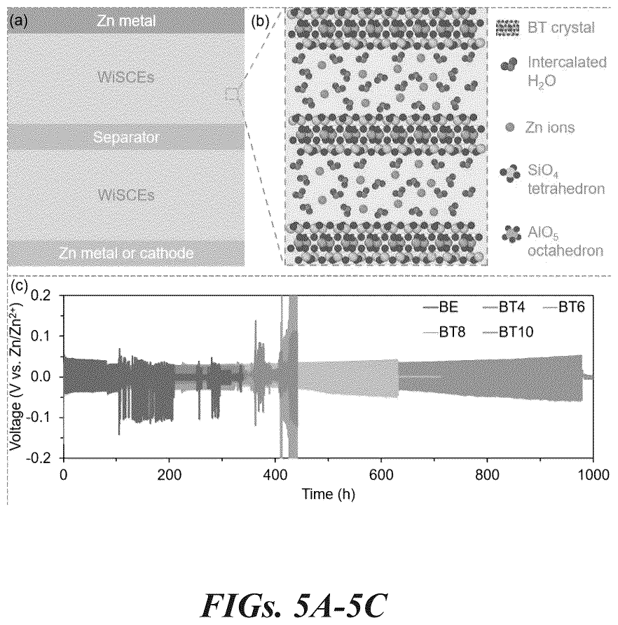

FIGS. 5A-5C show a schematical illustrations of (a) configuration of WiSCE-based cells, (b) hydration swelling of BT, and (c) cyclic stability of Zn∥Zn symmetric cells based on WiSCEs with different BT contents at a current density of 1 mA/cm2 and an areal capacity of 1 mAh/cm².

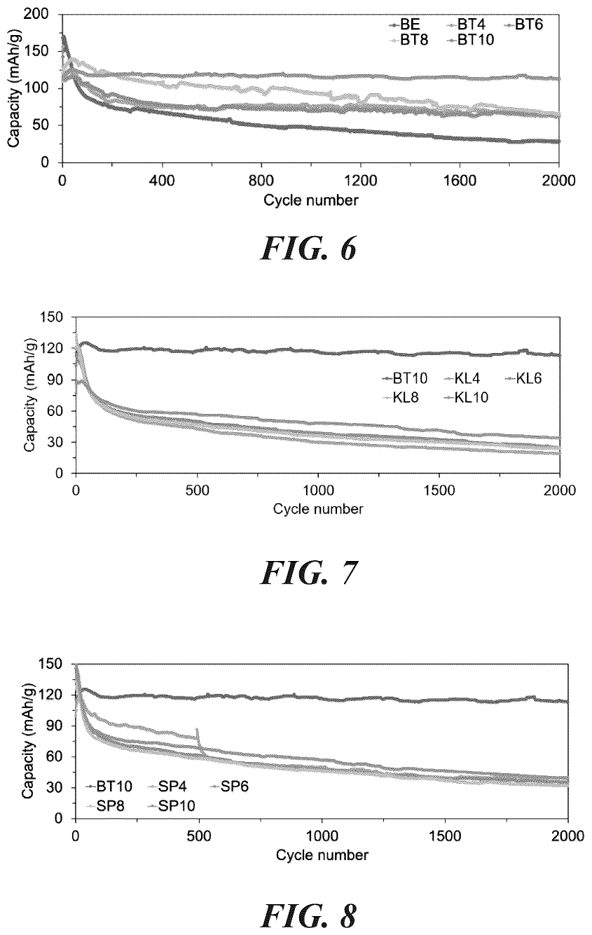

FIG. 6 shows cyclic stability of Zn∥NVO full cells based on BE and WiSCEs with different BT contents at a current density of 3 A/g.

FIG. 7 shows cyclic stability of Zn∥NVO full cells using BT10 and KL-based electrolytes with different KL contents at a current density of 3 A/g.

FIG. 8 shows cyclic stability of Zn∥NVO full cells using BT10 and SP-based electrolytes with different SP contents at a current density of 3 A/g.

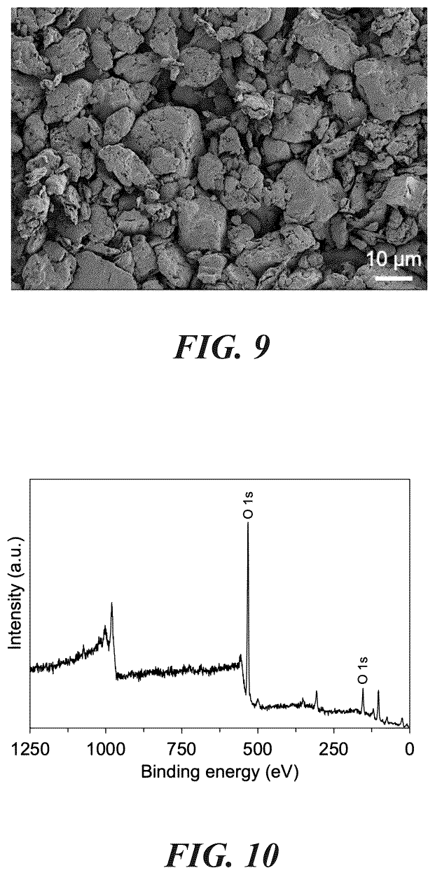

FIG. 9 shows SEM image of the BT powders.

FIG. 10 shows x-ray photoelectron spectroscopy of the BT powders.

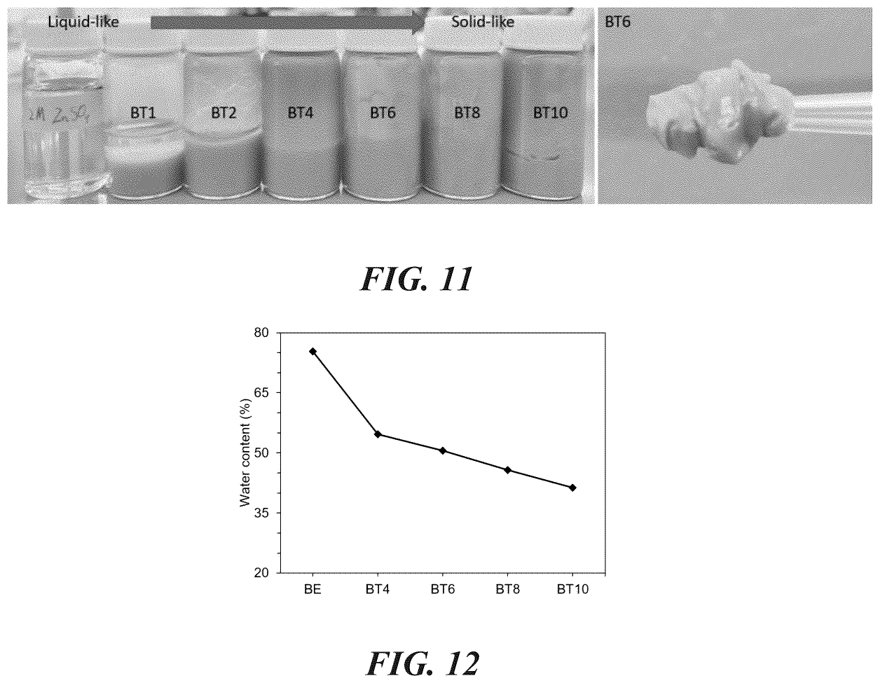

FIG. 11 shows optical images of the BE and WiSCEs with different amounts of BT.

FIG. 12 shows water content in the WiSCEs derived from TGA test.

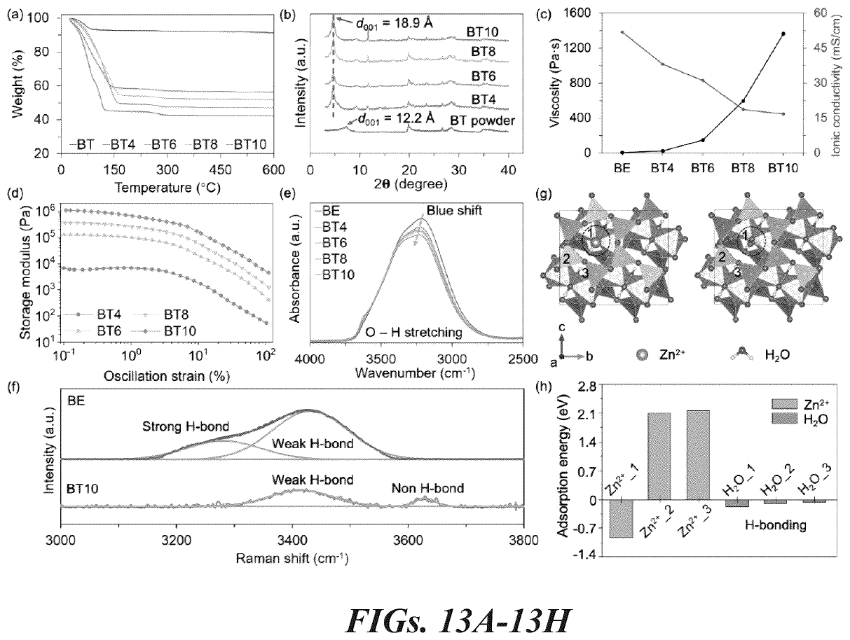

FIGS. 13A-13H show physical and chemical properties of BT and WiSCEs: (a) TGA curves, (b) XRD curves, (c) ionic conductivities and viscosities of the WiSCEs with different amounts of BT, (d) storage modulus, (e) FTIR spectra, (f) Raman spectra, (g) atomic surface model of Zn²⁺ and H₂O adsorption at site 1 (Zn²⁺_1 and H₂O_1) of the BT crystal, and (h) adsorption energies of Zn²⁺ and H₂O at different sites.

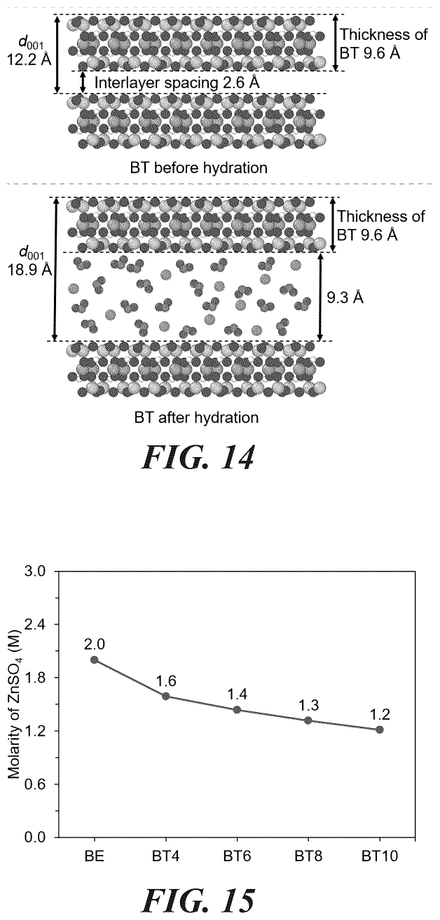

FIG. 14 shows a schematic illustration of the BT structural change before and after hydration swelling.

FIG. 15 shows molarity of ZnSO₄ in the BE and WiSCEs with different amounts of BT.

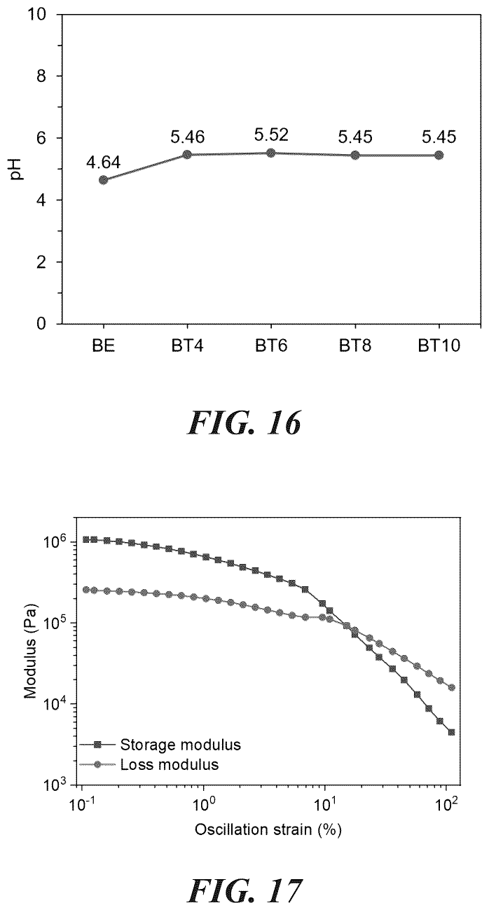

FIG. 16 shows pH of the BE and WiSCEs with different amounts of BT.

FIG. 17 shows storage and loss modulus of the BT10 electrolyte under different oscillation strains at a fix angular frequency of 10 rad/s.

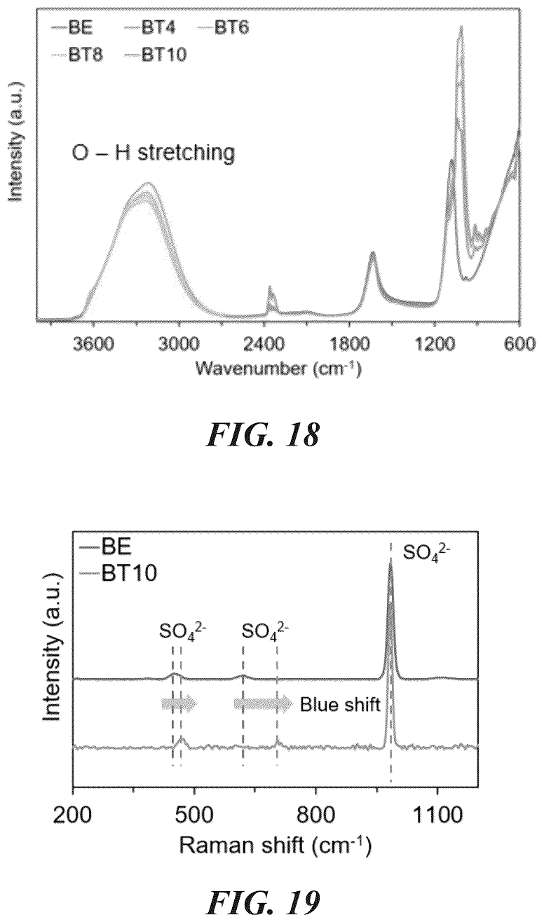

FIG. 18 shows FTIR spectra of the BE and WiSCEs with different BT concentrations.

FIG. 19 shows Raman spectra of the BE and BT10 electrolytes.

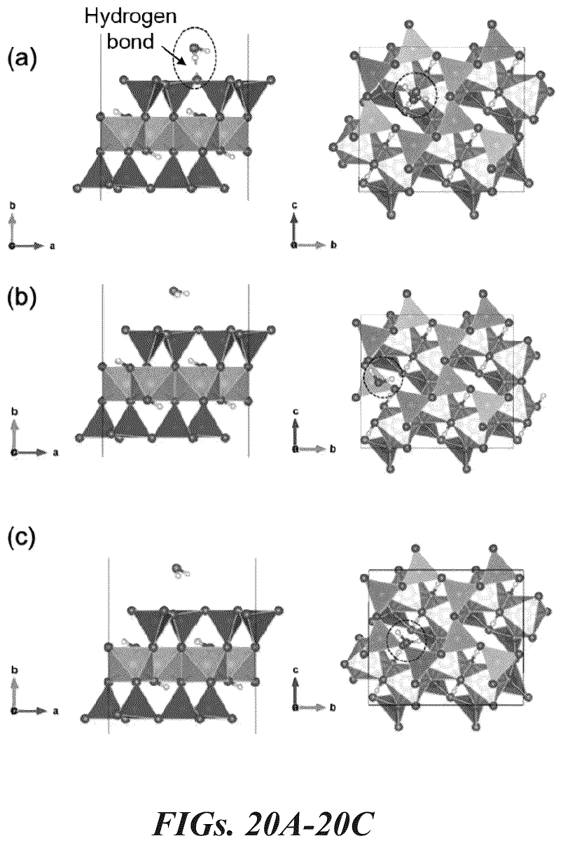

FIGS. 20A-20C show atomic surface models of H₂O adsorption at different sites (a) site 1, (b) site 2, and (c) site 3.

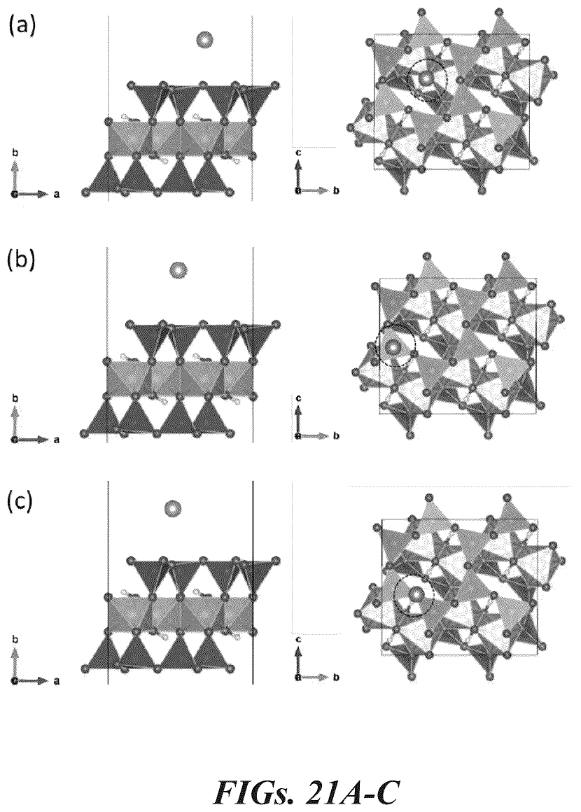

FIGS. 21A-21C show atomic surface models of Zn²⁺ adsorption at different sites (a) site 1, (b) site 2, and (c) site 3.

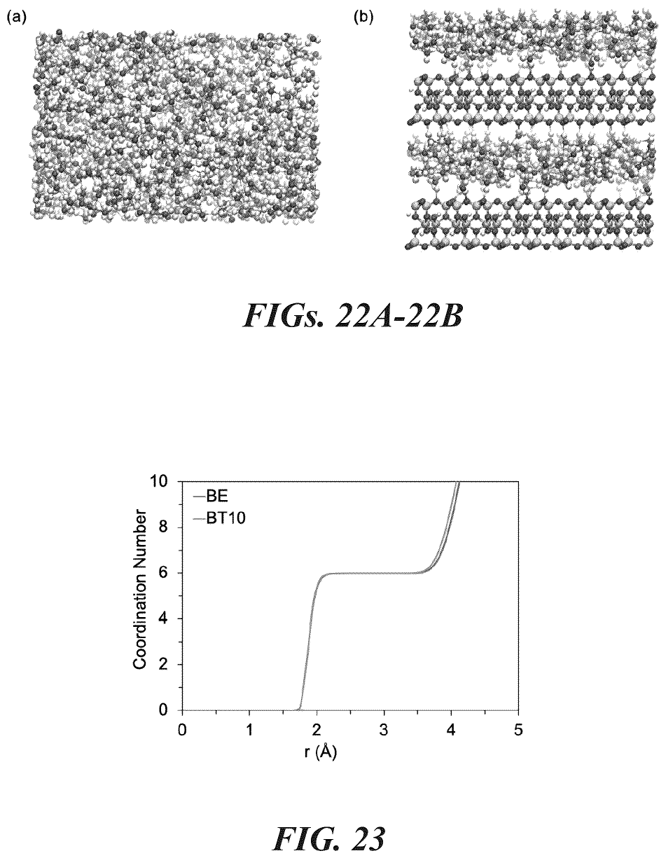

FIGS. 22A-22B show molecular models of the (a) BE and (b) BT10 electrolytes.

FIG. 23 shows the coordination number of Zn²⁺ in BE and BT10 electrolytes.

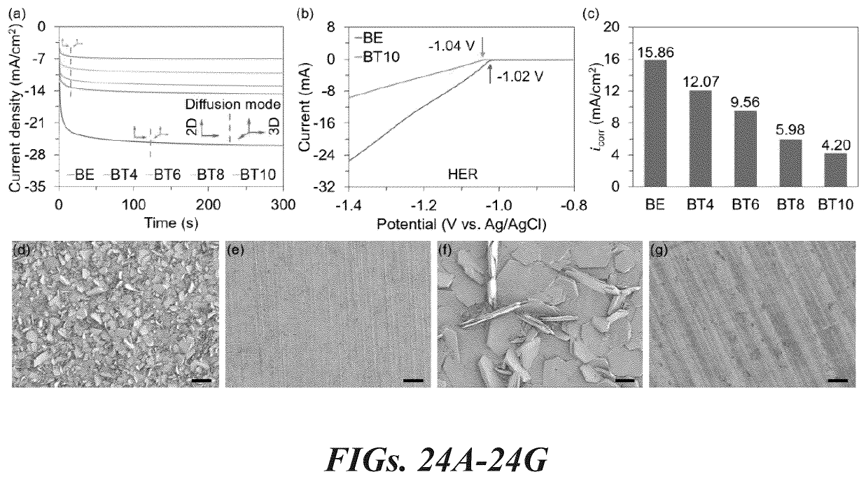

FIGS. 24A-24G show (a) CA curves of WiSCEs with different amounts of BT, (b) LSV curves of BE and BT10 electrolytes, (c) the corrosion current densities of Zn metal electrodes in the WiSCEs fitted from Tafel curves, SEM images of Zn metal soaked in (d) BE and (e) BT10 electrolytes for 30 days at room temperature, and SEM images of Zn metal soaked in (f) BE and (g) BT10 electrolytes for 10 days at 50° C. as shown with a scale bar of 50 μm.

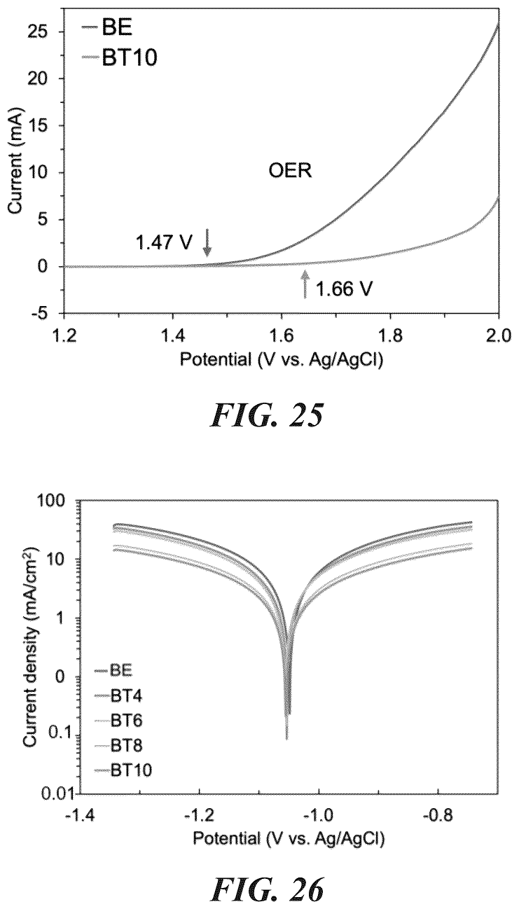

FIG. 25 shows LSV curves of the Zn metal electrode in BE and BT10 electrolytes showing the oxygen evolution behavior.

FIG. 26 shows Tafel curves of Zn metal electrode in BE and WiSCEs with different amounts of BT.

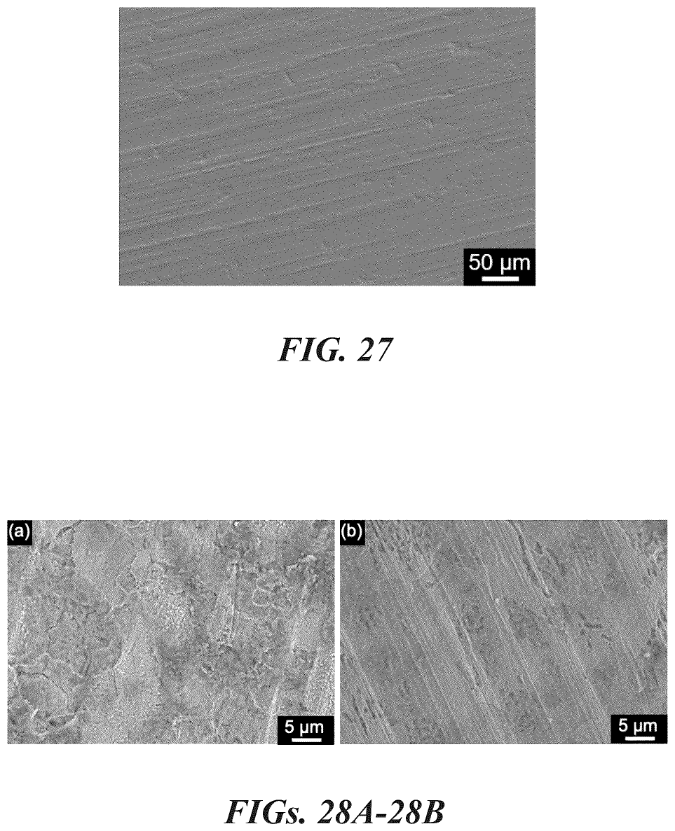

FIG. 27 shows SEM image of bare Zn.

FIGS. 28A-28B show SEM images of bare Zn soaked in BT10 electrolyte for (a) 30 days at room temperature and (b) 10 days at 50° C.

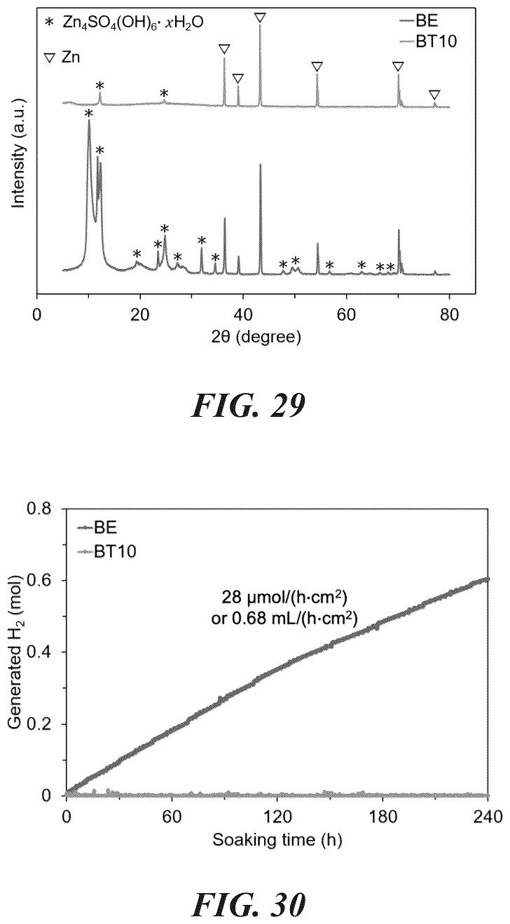

FIG. 29 shows XRD curves of Zn metal anodes soaked in BE and BT10 electrolytes at 50° C. for 10 days.

FIG. 30 shows hydrogen evolutions of the Zn metal soaked in BE and BT10 electrolytes.

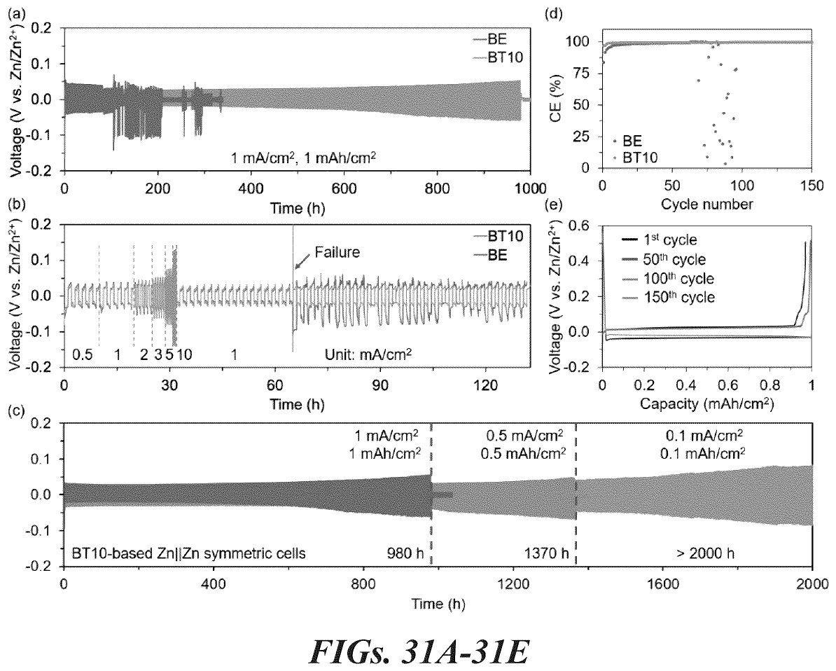

FIGS. 31A-31E show (a) cyclic stability of Zn∥Zn symmetric cells in BE and BT10 electrolytes at a current density of 1 mA/cm2 and a capacity of 1 mAh/cm², (b) rate capability of Zn∥Zn symmetric cells in BE and BT10 electrolytes, (c) cyclic stability of Zn∥Zn symmetric cells in BE and BT10 electrolytes at different current densities and areal capacities, (d) coulombic efficiencies, and (e) voltage profiles of Cu∥Zn half cells in BE and BT10 electrolytes at a current density of 1 mA/cm².

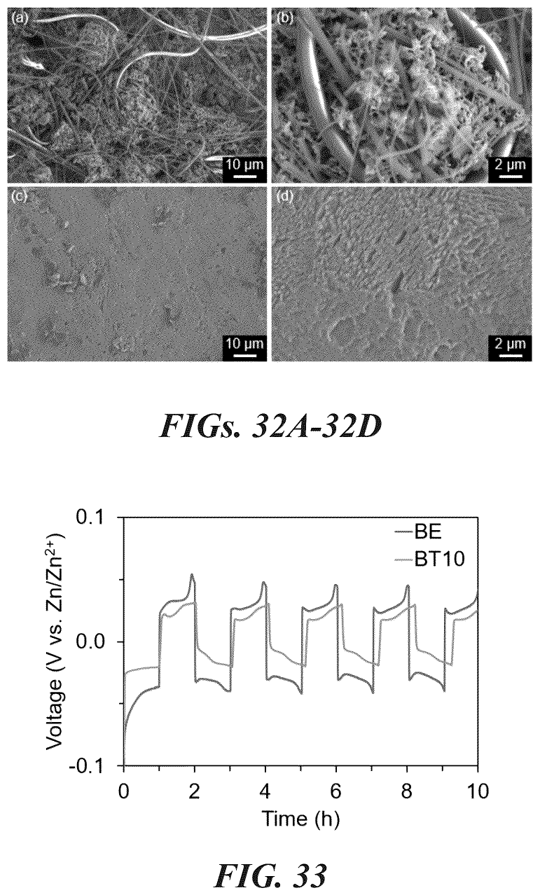

FIGS. 32A-32D show SEM images of the cycled Zn metal anodes in (a)-(b) BE and (c)-(d) BT10 electrolytes.

FIG. 33 shows the detailed voltage profiles of the Zn∥Zn symmetric cells based on BE and BT10 electrolytes at a current density of 1 mA/cm² and a capacity of 1 mAh/cm².

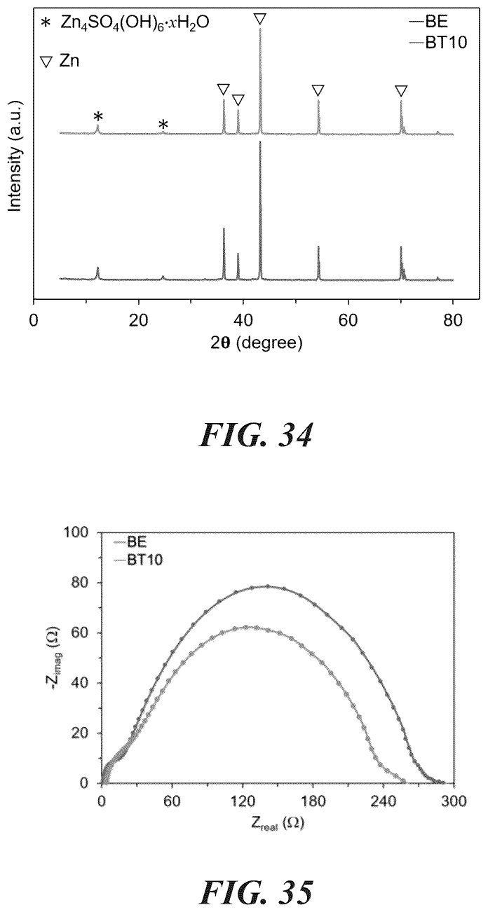

FIG. 34 shows XRD curves of the cycled Zn metal anodes in BE and BT10 electrolytes.

FIG. 35 shows EIS curves of Zn∥Zn symmetric cells based on the BE and BT10 electrolytes.

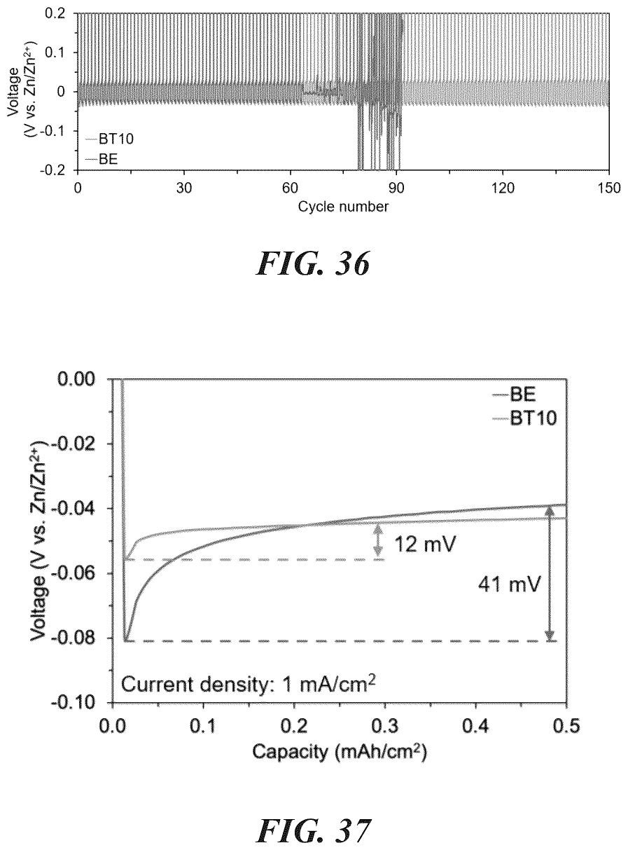

FIG. 36 shows voltage profiles of the Cu∥Zn cells based on BE and BT10 electrolytes.

FIG. 37 shows nucleation overpotentials of the Cu∥Zn half cells based on BE and BT10 electrolytes at 1 mA/cm2.

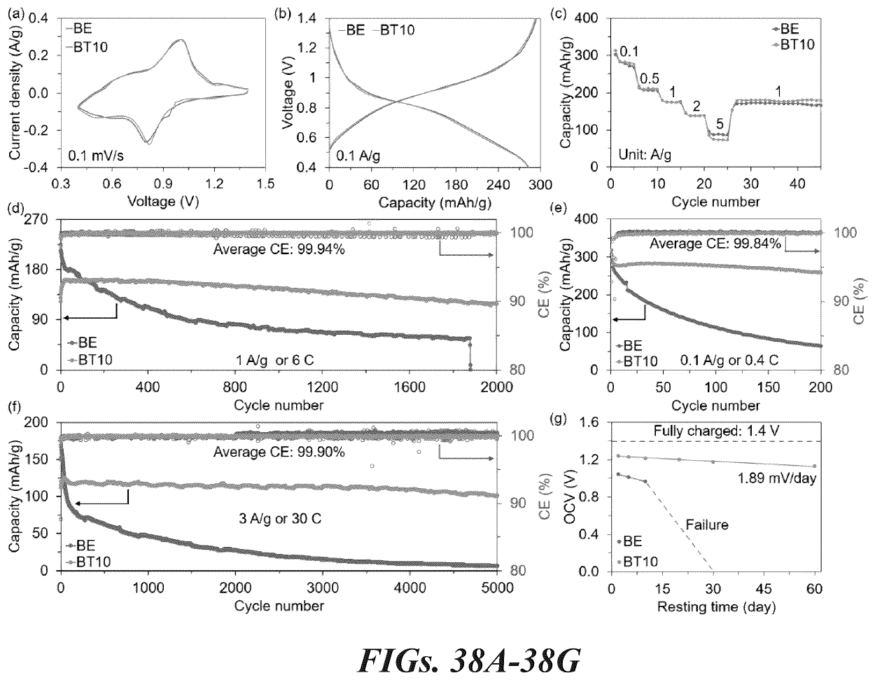

FIGS. 38A-38G show electrochemical performance of Zn∥NVO full cells based on BE and BT10 electrolytes: (a) CV curves at a scan rate of 0.1 mV/s, (b) galvanostatic charge/discharge curves at a current density of 0.1 A/g, (c) rate capabilities, long-term cyclic stability of Zn∥NVO full cells based on BE and BT10 electrolytes at different current densities of (d) 1 A/g, (e) 0.1 A/g, and (f) 3 A/g, and (g) self-discharge performance of fully charged Zn∥NVO full cells based on BE and BT10 electrolytes.

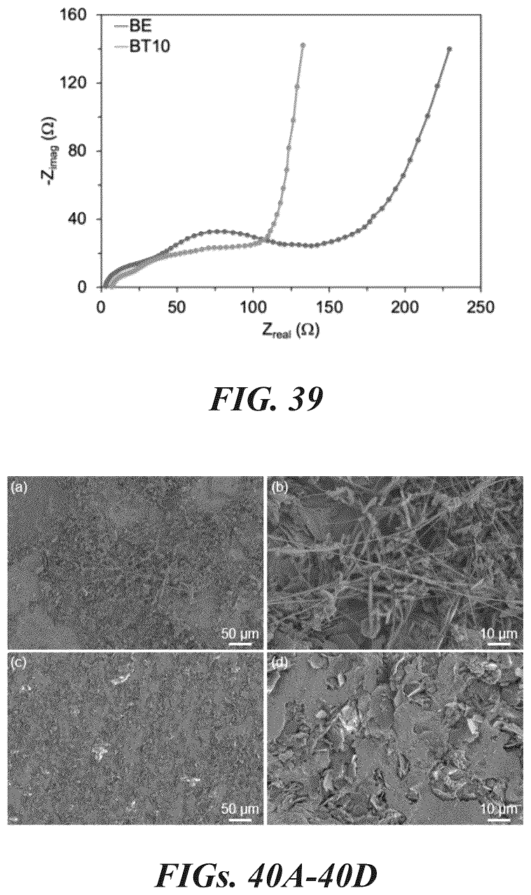

FIG. 39 shows EIS curves of the Zn∥NVO full cells based on BE and BT10 electrolytes.

FIGS. 40A-40D show SEM images of the cycled (1000 cycles at 3 A/g) Zn metal anodes in Zn∥NVO full cells based on BE (FIGS. 40A-40B) and BT10 (FIGS. 40C-40D) electrolytes.

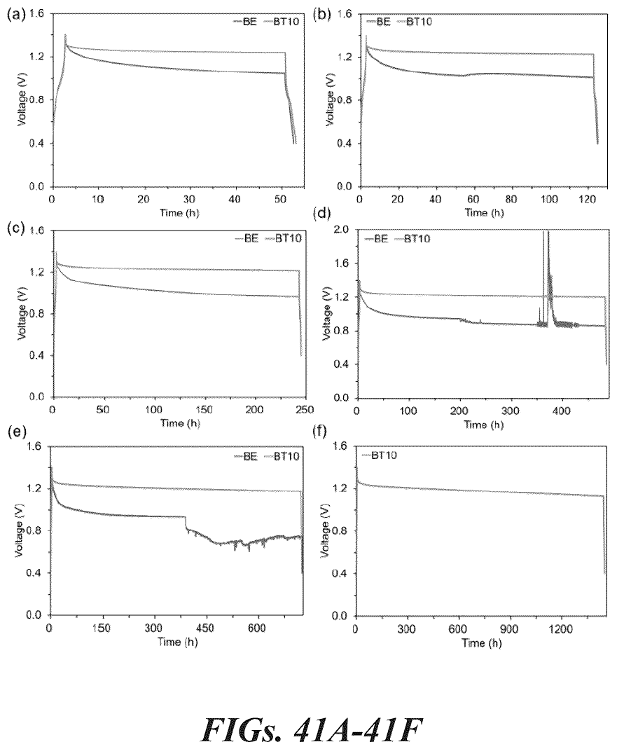

FIGS. 41A-41F show open circuit voltage of the Zn∥NVO full cells based on BE and BT10 electrolytes during self-discharge test.

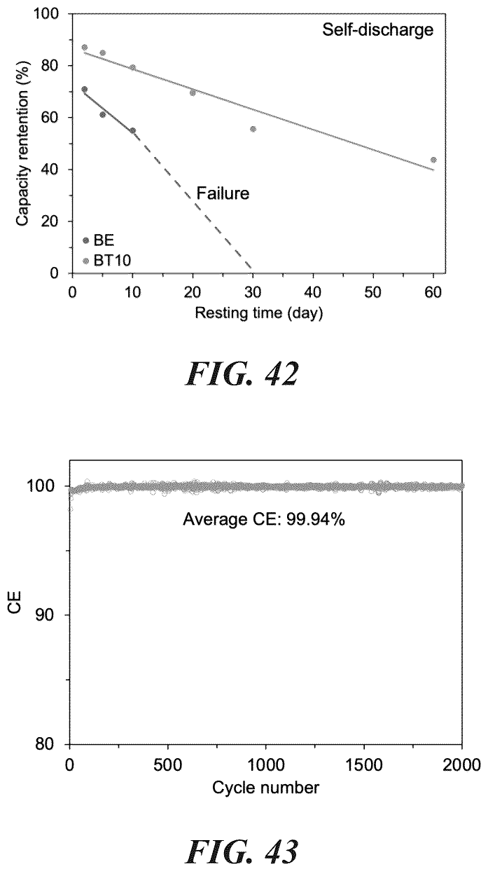

FIG. 42 shows capacity retention rate of the Zn∥NVO full cells based on BE and BT10 electrolytes during self-discharge test.

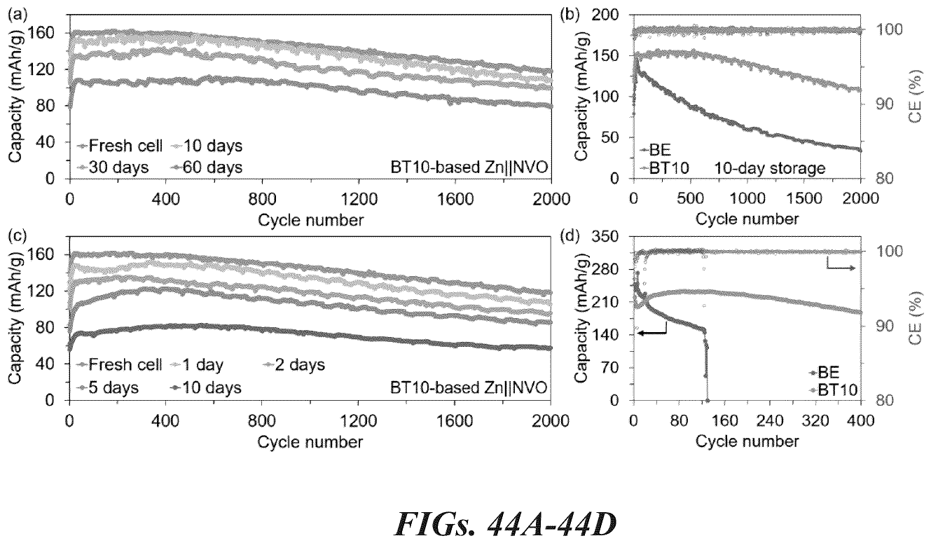

FIG. 43 shows CE of the BT10-based full cell during cyclic charge/discharge at 1 A/g over 2000 cycles. The full cell was stored at room temperature for 60 days before charge/discharge.

FIGS. 44A-44D show (a) cyclic stability of BT10-based full cells after being stored at room temperature for up to 60 days, (b) cyclic stability of BE- and BT10-based full cells after 10-day storage at room temperature, (c) cyclic stability of BT10-based full cells after storage at 50° C. for up to 10 days, and (d) cyclic stability of BT10-based full cells working at 50° C. at a current density of 1 A/g.

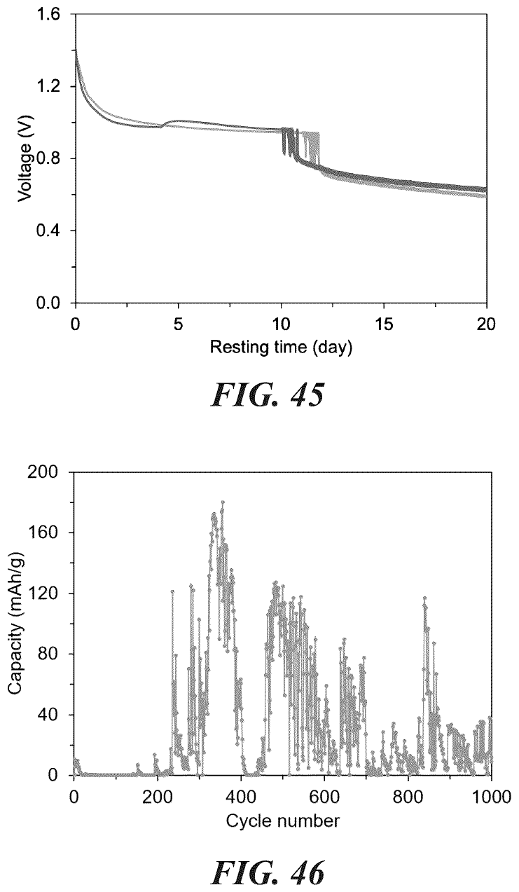

FIG. 45 shows the resting test of freshly assembled Zn∥NVO full cells based on BE.

FIG. 46 shows cyclic stability of the BE-based Zn∥NVO cell after storing at 50° C. for 1 day.

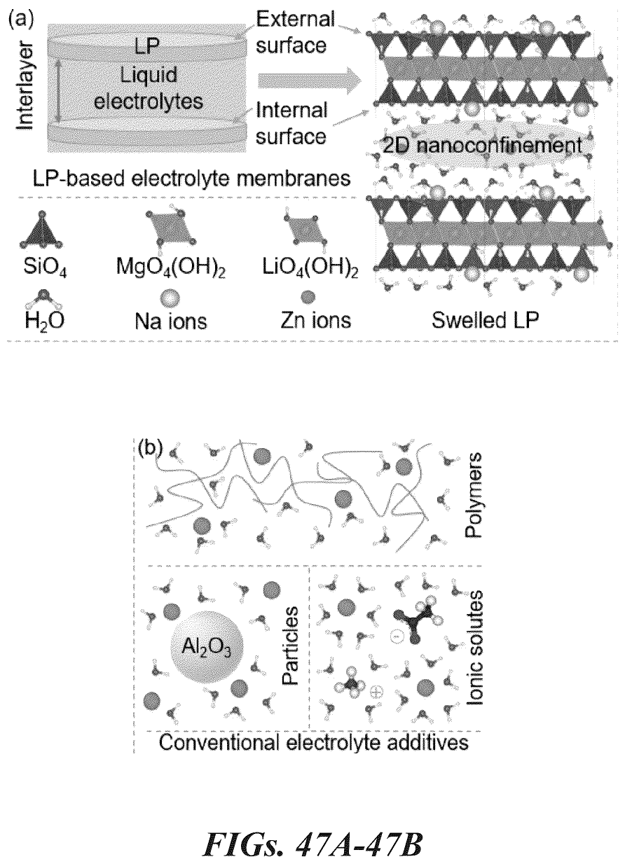

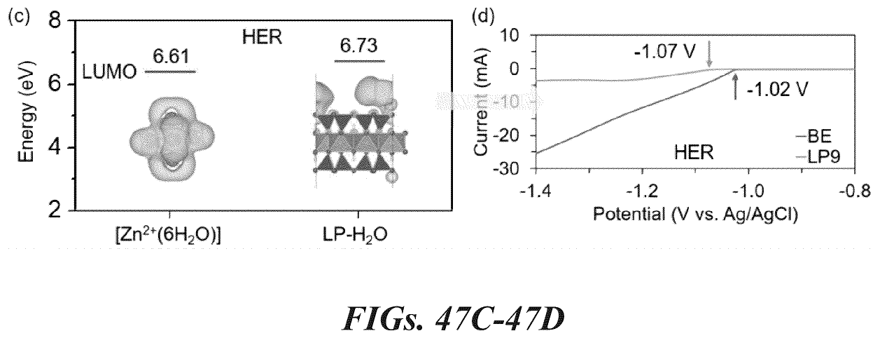

FIGS. 47A-47D shows schematic illustrations of (a) electrolyte membranes based on LP nanocrystals with 2D nanostructures and exceptional swelling capabilities and (b) conventional liquid electrolytes containing other additives, such as polymers (e.g., polyacrylamide [32]), inorganic particles (e.g., Al₂O₃ [33]), and ionic solutes (e.g., ammonia acetate [34]). (c) LUMO energies of water molecules in BE and LP9 electrolyte membrane. (d) HER performance of Zn metal electrodes in BE and LP9 electrolyte membrane.

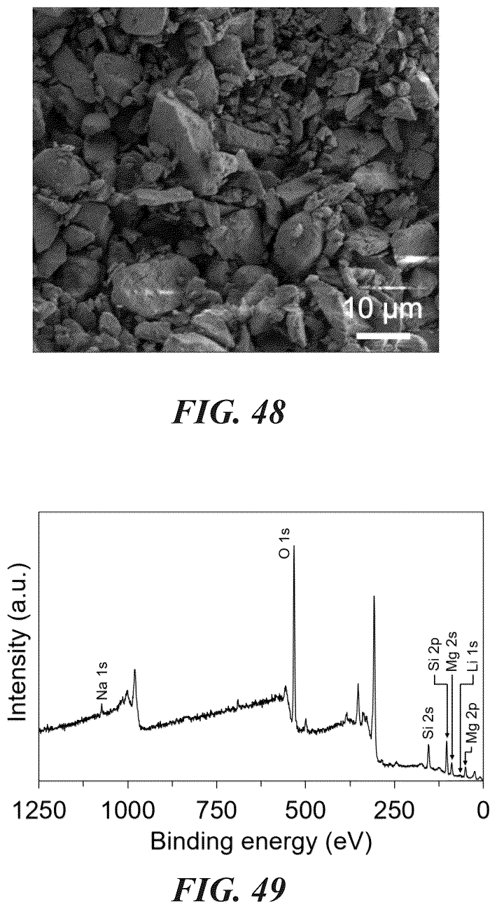

FIG. 48 shows SEM image of LP powders.

FIG. 49 shows X-ray photoelectron spectroscopy of LP powders.

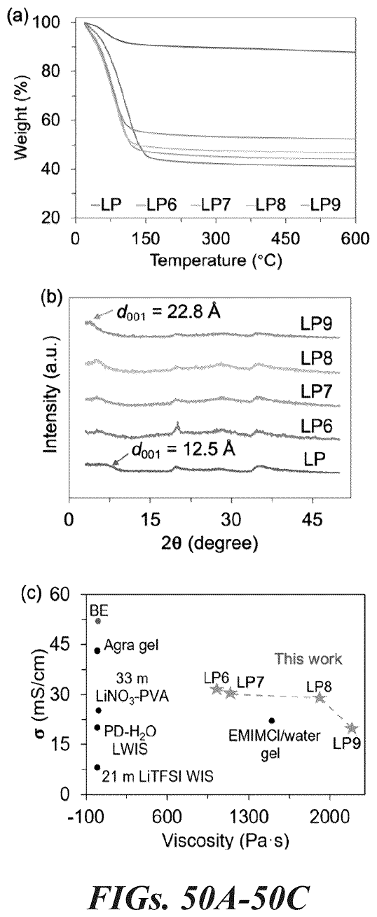

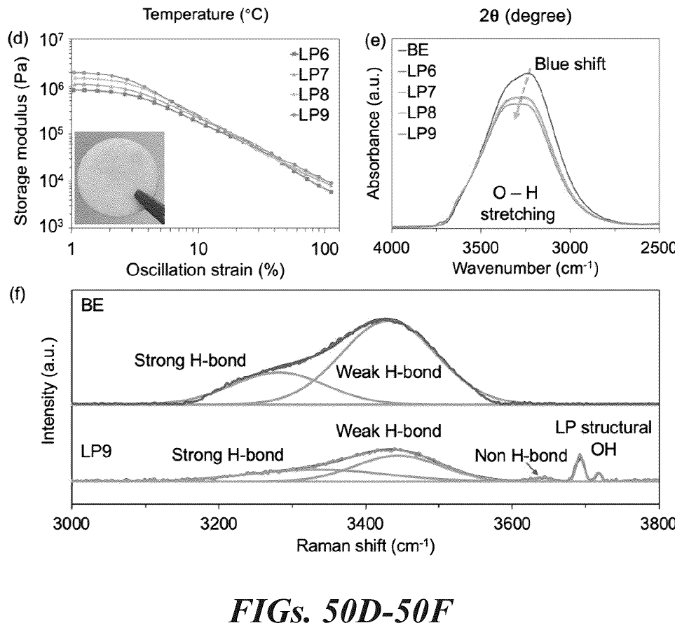

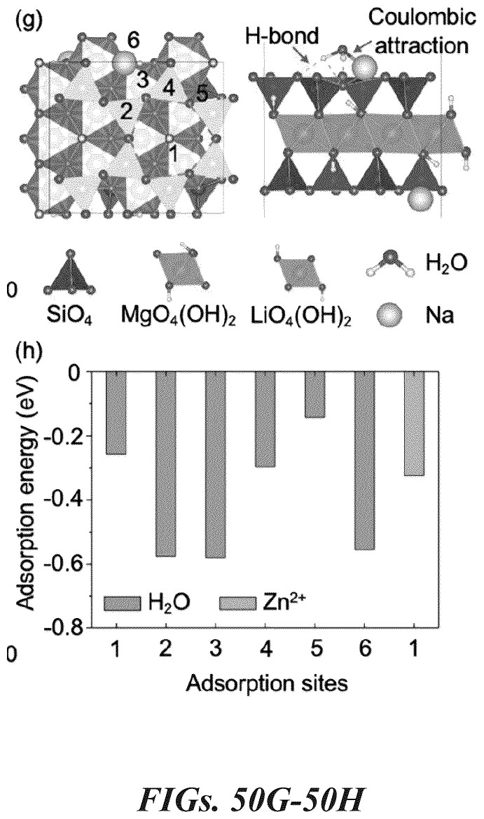

FIGS. 50A-50H show physical and chemical properties of LP, BE, and LP-based electrolyte membranes: (a) TGA curves, (b) XRD curves, (c) comparison of ionic conductivity and viscosity of the LP-based electrolyte membranes and other electrolyte systems: agar gel [35], 33 m LiNO₃-PVA (where m is molality, mol/kg) [36], PD-H₂O LWIS [37], 21 m LiTFSI [38], and EMIMCl/water gel [39], (d) storage modulus; the inserted optical image shows the appearance of a freestanding LP9 electrolyte membrane, (e) FTIR spectra, (f) Raman spectra, (g) atomic surface model and representative H₂O adsorption configurations of the LP nanocrystals, (h) H₂O and Zn²⁺ adsorption energies at different sites.

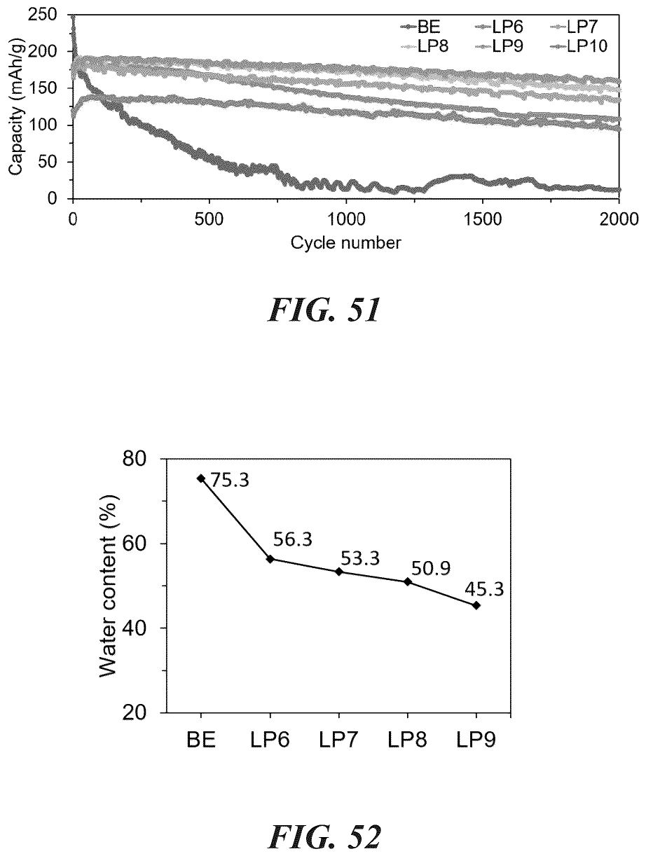

FIG. 51 shows cyclic stability of BE- and LP-based Zn∥NVO full cells at a current density of 1 A/g.

FIG. 52 shows water content in LP-based electrolyte membranes derived from TGA test.

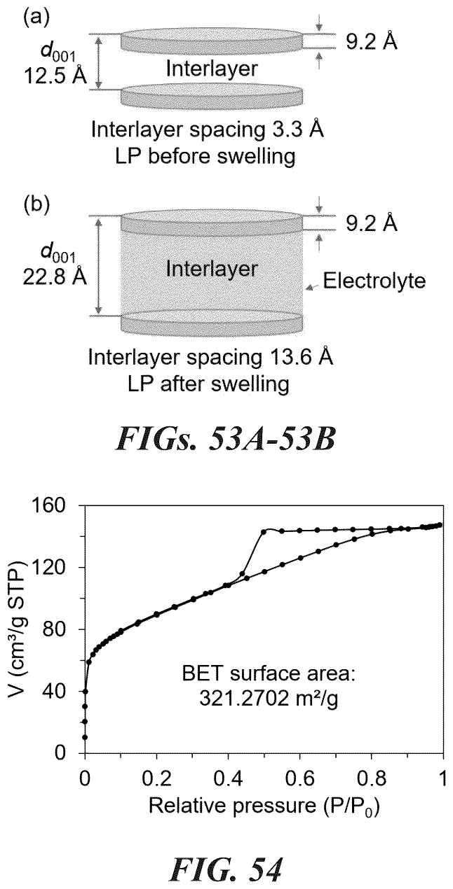

FIGS. 53A-53B show schematical illustrations of LP nanocrystals (a) before and (b) after swelling.

FIG. 54 shows BET surface area of LP powders.

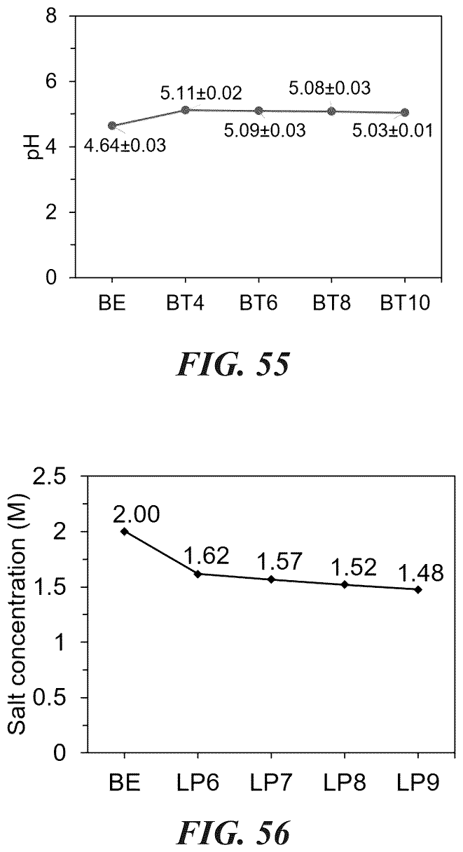

FIG. 55 shows pH of BE and LP-based electrolytes.

FIG. 56 shows concentration of ZnSO₄ in LP-based electrolyte membranes. A density of 2.53 g/cm³ was used to calculate the volume of LP and thus determine the salt concentrations in LP-based electrolyte membranes.

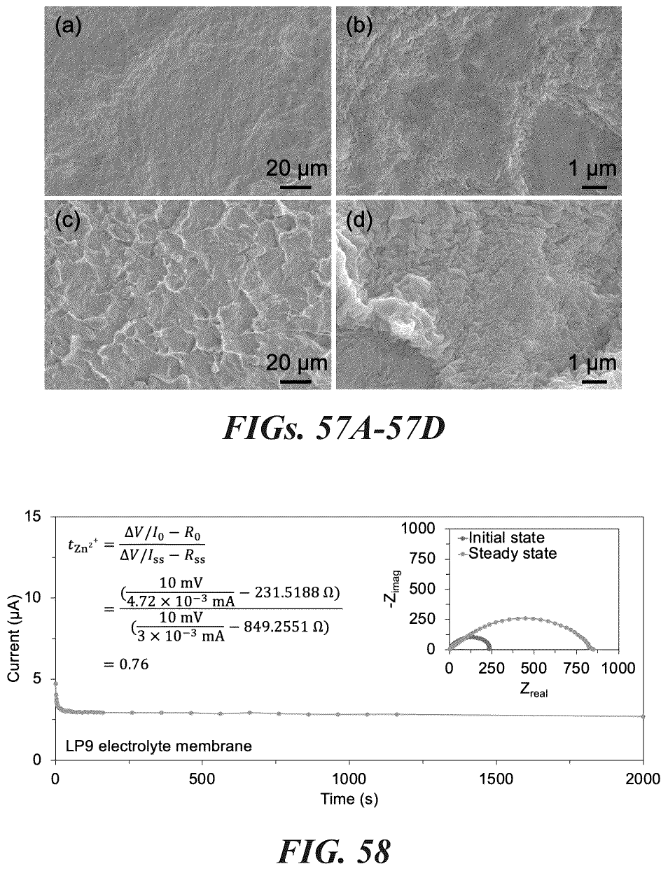

FIGS. 57A-57D show SEM images of LP9 electrolyte membrane showing its (a)-(b) surface and (c)-(d) cross-sectional morphologies.

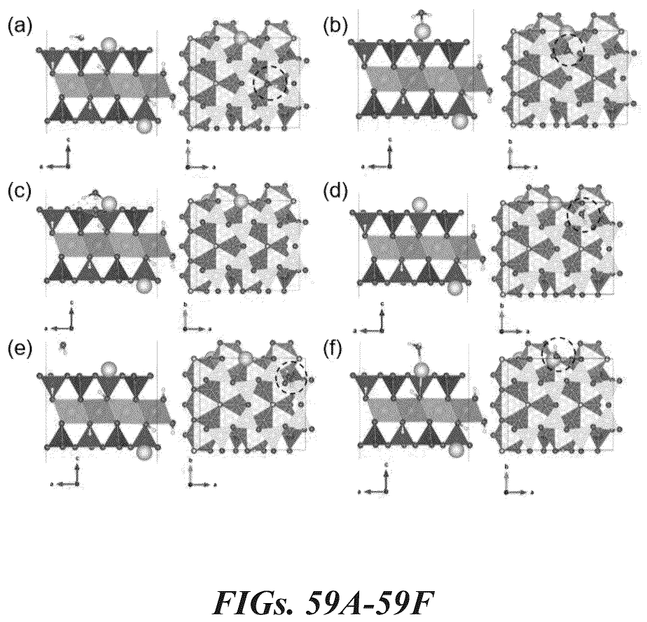

FIG. 58 shows current response with time during DC polarization of LP9-based Zn∥Zn symmetric cell with a constant potential of 10 mV. Inserts show the EIS curves and detailed calculations of Zn²⁺ transference number.

FIGS. 59A-59F show atomic surface models showing H₂O adsorption at different sites (a) 1, (b) 2, (c) 3, (d) 4, (e) 5 and (f) 6.

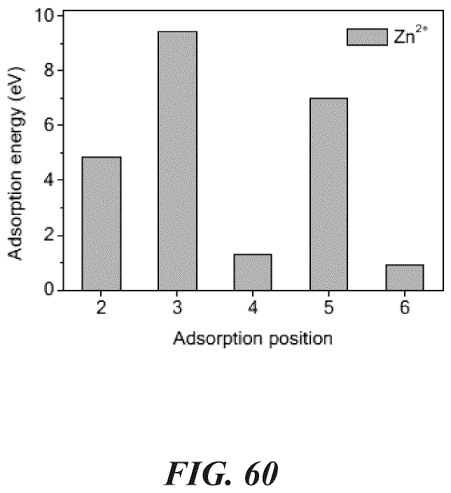

FIG. 60 shows Zn²⁺ adsorption energies at different sites from site 2 to site 6.

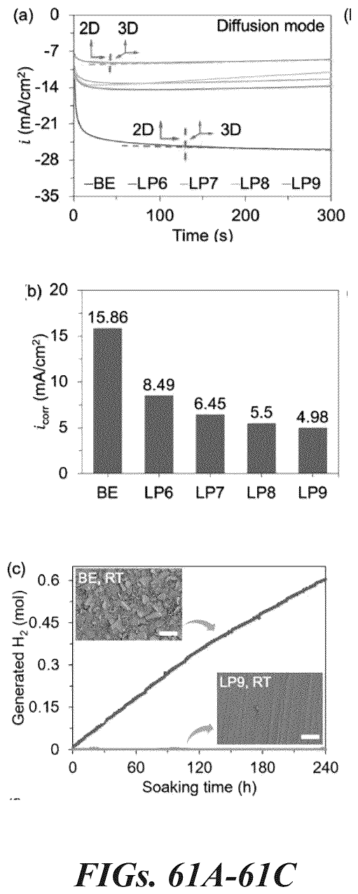

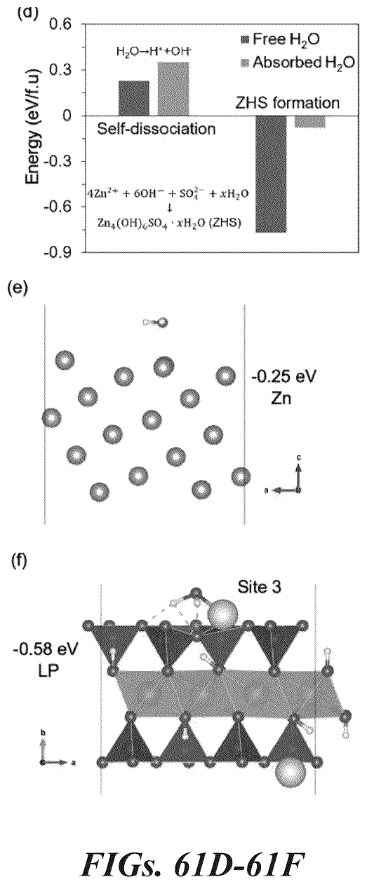

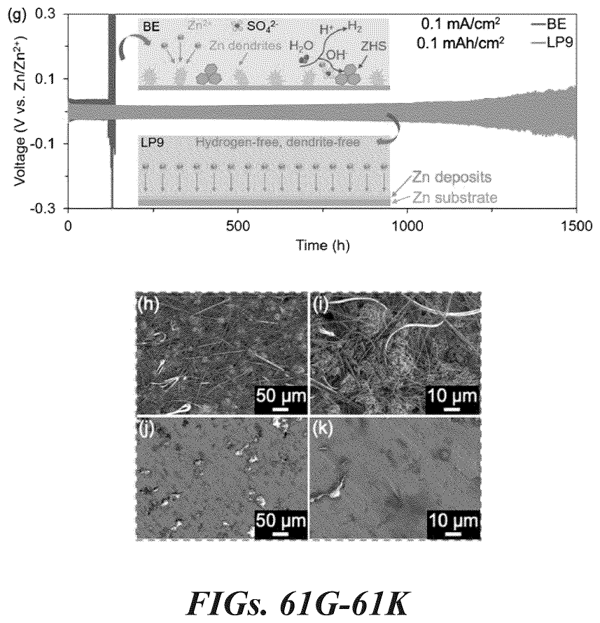

FIGS. 61A-61K show electrochemical performance of Zn metal electrodes in BE and LP-based electrolyte membranes: (a) CA curves, (b) corrosion current densities fitted from Tafel curves, (c) hydrogen generation rates during the soaking tests (insets show the surface morphology of Zn foil after the soaking tests; scale bar: 50 μm), (d) water self-dissociation and ZHS formation energies of free water molecules and absorbed water molecules on the LP surface, (e and f) water adsorption energies on (c) Zn and (f) LP surfaces, (g) long-term cycling performance of BE- and LP9-based Zn∥Zn symmetric cells (insets schematically illustrate the Zn/electrolyte interfaces in BE and LP9 electrolyte membrane), (h-k) SEM images of Zn metal anodes in symmetric cells after 30 cycles at 1 mA/cm2 and 1 mAh/cm² in different electrolytes: (h-i) BE with a GF separator and (j-k) LP9 electrolyte membrane.

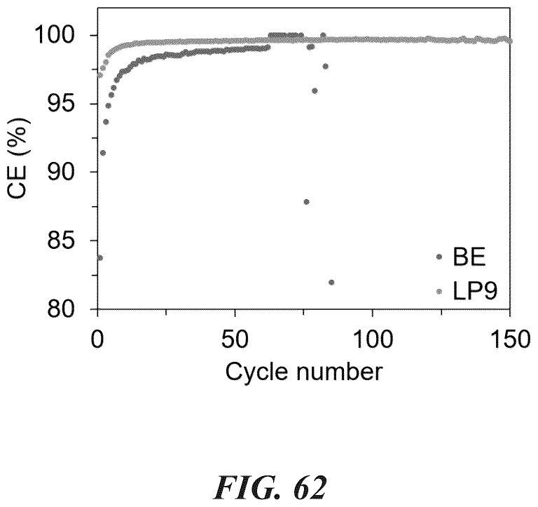

FIG. 62 shows Coulombic efficiencies of BE- and LP9-based Cu∥Zn half cells at 1 mA/cm² and 1 mAh/cm².

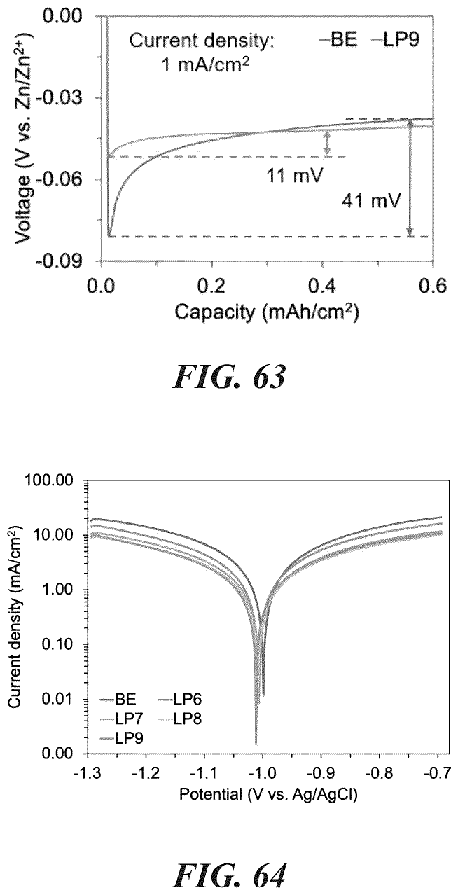

FIG. 63 shows nucleation overpotential of Zn deposition in BE and LP9 electrolyte.

FIG. 64 shows Tafel curves of Zn metal electrodes in BE and LP-based electrolytes.

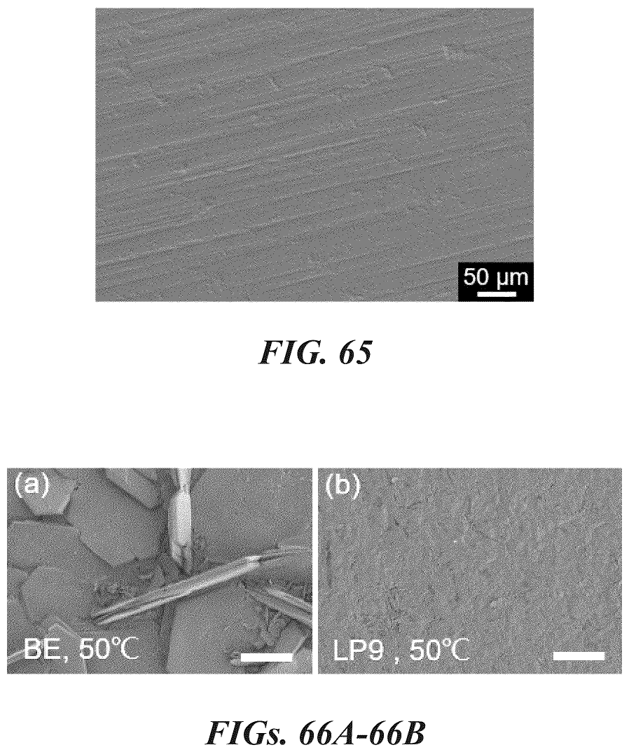

FIG. 65 shows SEM image of bare Zn.

FIGS. 66A-66B show SEM images of Zn foil soaked in (a) BE and (b) LP9 electrolyte at 50° C. for 10 days.

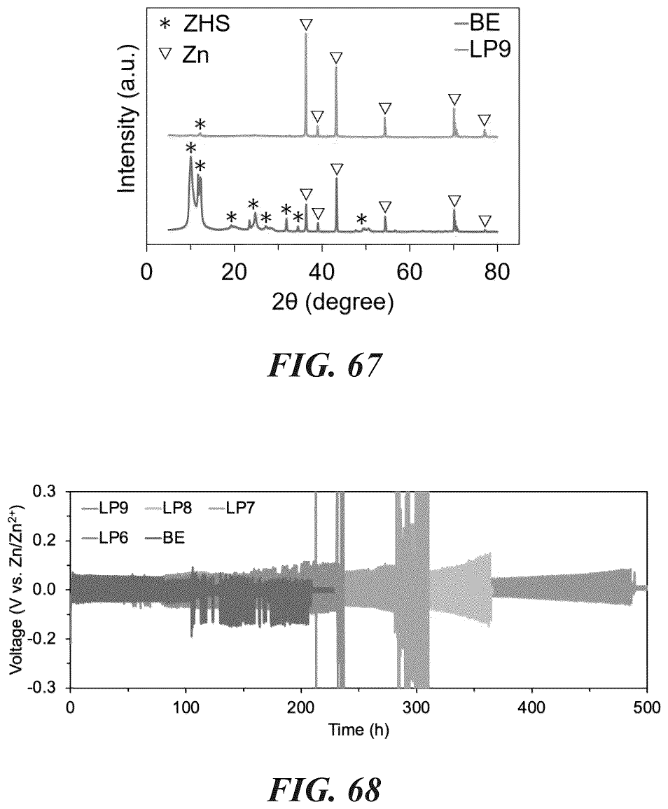

FIG. 67 shows XRD curves of Zn metal soaked in BE and LP9 electrolytes at 50° C. for 10 days.

FIG. 68 shows long-term cycling performance of Zn∥Zn symmetric cells based on BE and LP-based electrolyte membranes at a current density of 1 mA/cm² and an areal capacity of 1 mAh/cm².

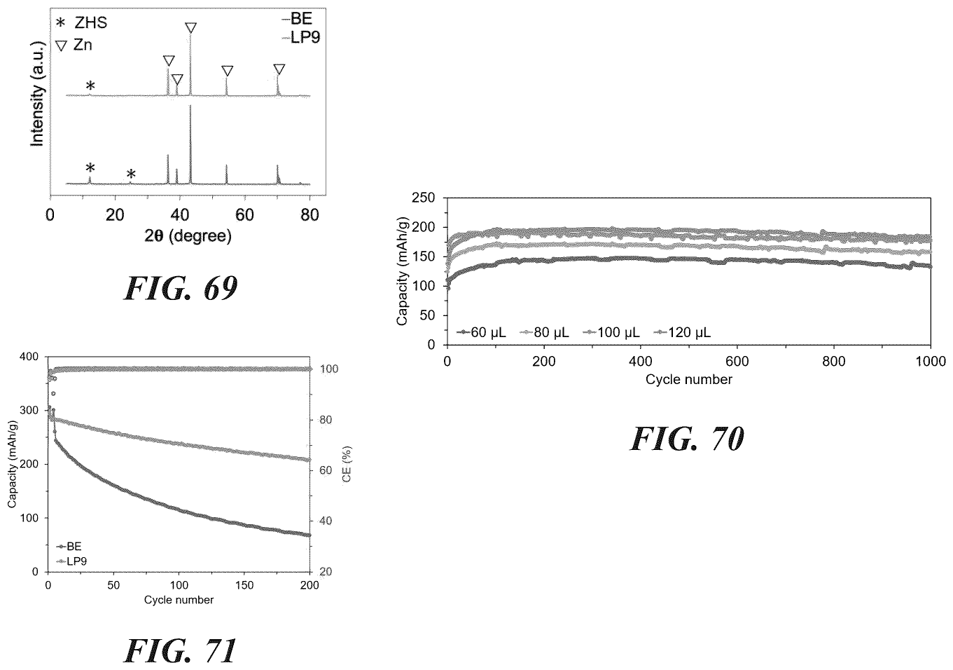

FIG. 69 shows XRD curves of Zn metal anodes in BE- and LP9-based Zn∥Zn symmetric cells after 30 cycles at 1 mA/cm² and 1 mAh/cm².

FIG. 70 shows cyclic stability of LP9-based Zn∥NVO full cells with different electrolyte volumes at a current density of 1 A/g.

FIG. 71 shows cycling test of BE- and LP9-based Zn∥NVO full cells at a current density of 0.1 A/g.

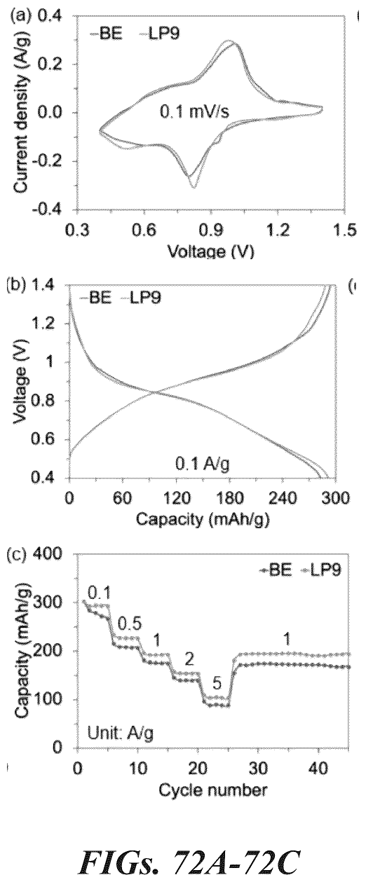

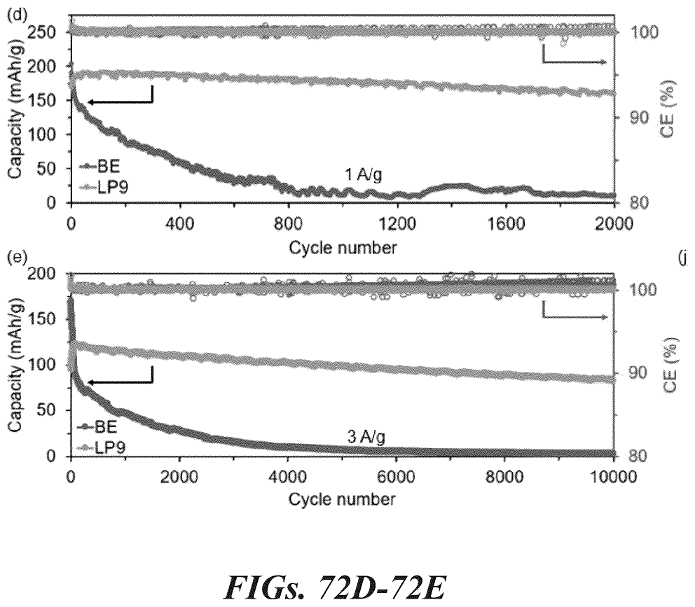

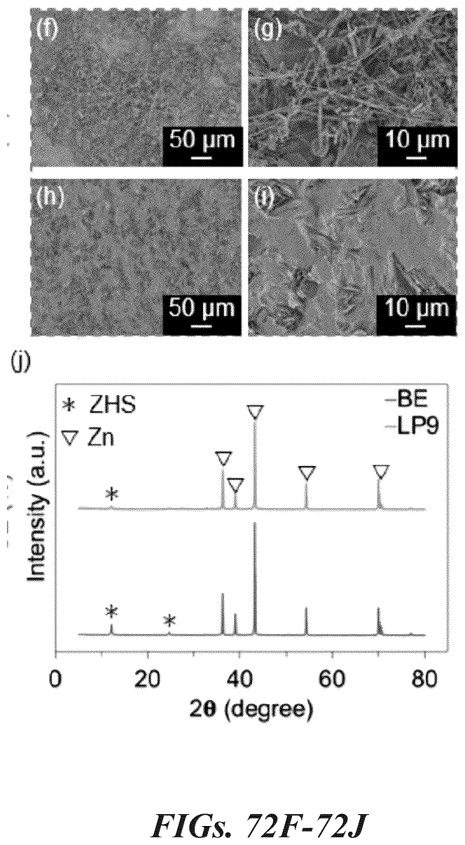

FIGS. 72A-72J show electrochemical performance of BE- and LP9-based Zn∥NVO full cells: (a) CV curves, (b) charge/discharge voltage profiles, (c) rate performance, (d-e) long-term cycling performance at (d) 1 A/g and (e) 3 A/g, (f-i) SEM images of Zn metal anodes after 1,000 cycles at 3 A/g in (f-g) the BE-based Zn∥NVO full cell with GF separator, (h-i) the separator-free LP9-based Zn∥NVO full cell, and (j) XRD curves of Zn metal anodes in Zn∥NVO full cells after 1,000 cycles at 3 A/g.

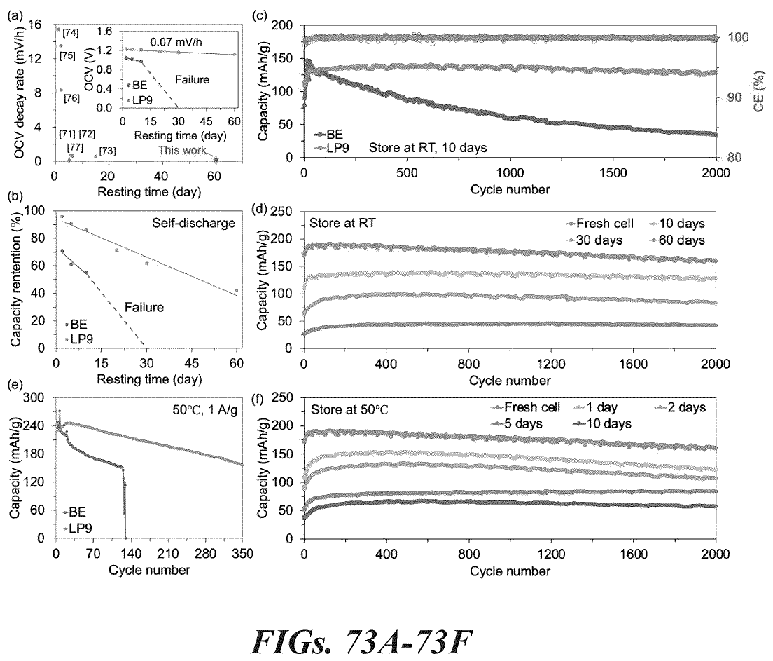

FIGS. 73A-73F show durability of BE- and LP9-based Zn∥NVO full cells: (a-b) self-discharge rate determined by the decay of (a) OCV (the figure compares self-discharge rates of previously reported aqueous batteries: Zn—I₂ batteries [71,72], zinc-ion batteries [73,74,75], Zn—Br₂ batteries [76], lithium-ion batteries [77]) and (b) capacity, (c) cyclic stability of Zn∥NVO full cells after resting at room temperature for 10 days, (d) cyclic stability of Zn∥NVO full cells after resting at room temperature for up to 60 days, (e) cyclic stability of Zn∥NVO full cells at 50° C., (f) cyclic stability of Zn∥NVO full cells after resting at 50° C. for up to 10 days. All of the cycling tests were performed at a charge/discharge current density of 1 A/g.

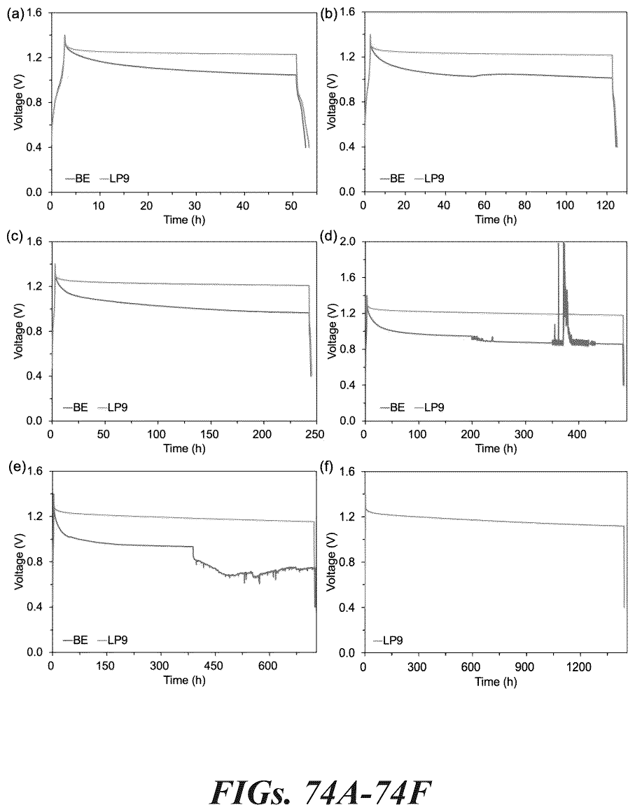

FIGS. 74A-74F shows voltage profiles of BE- and LP9-based Zn∥NVO full cells during self-discharge tests.

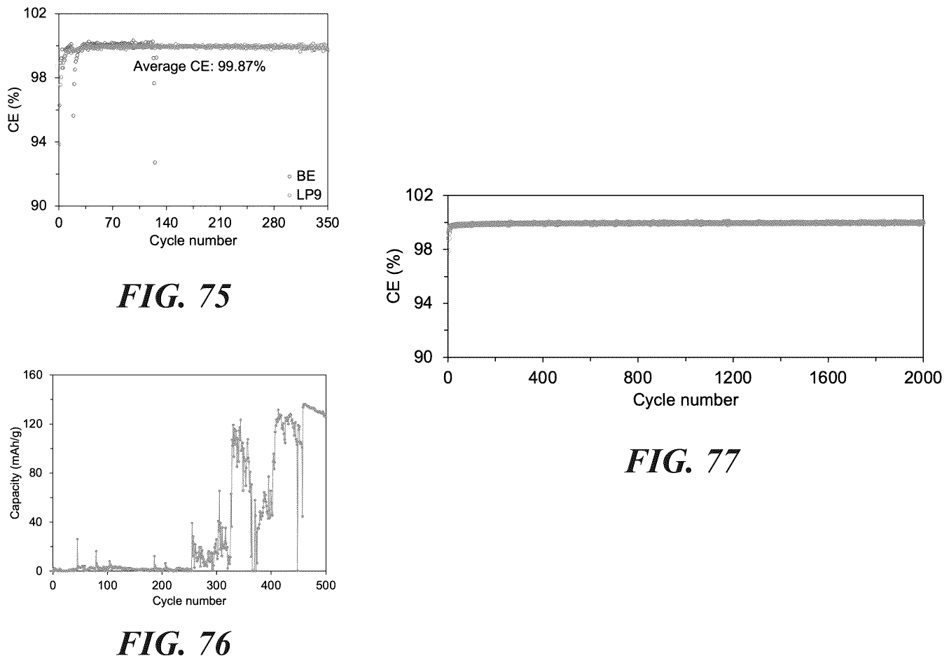

FIG. 75 shows CEs of BE- and LP-based Zn∥NVO full cells cycling at 50° C. with a current density of 1 A/g.

FIG. 76 shows cyclic stability of BE-based Zn∥NVO full cell after storing at 50° C. for 1 day.

FIG. 77 shows CEs of LP9-based Zn∥NVO full cell after being stored at 50° C. for 10 days.

### DETAILED SPECIFICATION

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the nth reference in the list. All references cited and discussed in this specification are incorporated herein by reference in their entireties and to the same extent as if each reference was individually incorporated by reference.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The expressions “ambient temperature” and “room temperature” as used herein are understood in the art and refer generally to a temperature from about 20° C. to about 35° C.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

It will be understood that, although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” or “substantially identical reference article,” or “substantially identical reference electrochemical cell” refers to a reference composition, article, or an electrochemical cell comprising substantially identical components and wherein an inventive component is substituted with a common in the art component.

The term “ion,” as used herein, refers to any molecule, portion of a molecule, a cluster of molecules, molecular complex, moiety, or atom that contains a charge (positive, negative, or both at the same time within one molecule, cluster of molecules, molecular complex, or moiety (e.g., zwitterions)) or that can be made to contain a charge.

The term “anion” is a type of ion and is included within the meaning of the term “ion.” An “anion” is any molecule, portion of a molecule (e.g., zwitterion), a cluster of molecules, molecular complex, moiety, or atom that contains a net negative charge or that can be made to contain a net negative charge.

The term “cation” is a type of ion and is included within the meaning of the term “ion.” A “cation” is any molecule, portion of a molecule (e.g., zwitterion), a cluster of molecules, molecular complex, moiety, or atom containing a net positive charge or that can be made to contain a net positive charge.

The term “electrochemical cell,” as used herein, refers to rechargeable batteries, reversible batteries, full cell batteries, symmetric batteries, half cell batteries, and batteries of various configurations including coin cells, cylindrical cells, pouch cells, among others. An electrochemical cell has basic components including a positive electrode, a negative electrode, an electrolyte, a separator, and current collectors.

The term “electrolyte composition,” as used herein, refers to a chemical composition suitable for use as an electrolyte in an electrochemical cell.

The term “electrolyte salt,” as used herein, refers to an ionic salt that is at least partially soluble in an electrolyte and that at least partially dissociates into ions in the electrolyte.

The term “anode” refers to an electrode of an electrochemical cell at which oxidation occurs. In a galvanic cell, such as a battery, the anode is the negative electrode. In a secondary (i.e., rechargeable) battery, the anode is the electrode at which oxidation occurs during discharge and reduction occurs during charging.

The term “cathode” refers to an electrode of an electrochemical cell at which reduction occurs. In a galvanic cell, such as a battery, the cathode is the positive electrode. In a secondary (i.e., rechargeable) battery, the cathode is the electrode at which reduction occurs during discharge and oxidation occurs during charging.

The term “separator,” as used herein, refers to any permeable membrane which allows electrolytes to flow and prevents the flow of working ions.

The term “semi-solid,” as used herein, refers to compositions including a higher percentage of solid material compared to liquid. Other terms used in the art may include quasi-solid. In particular, water-in-clay, swelling clays, and combinations thereof are terms used to describe the systems herein.

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods, in addition to those shown and described herein, are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less; however, other combinations of steps, elements, components, and constituents are included, even though not explicitly stated.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention nor the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

While aspects can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

In view of the described processes and compositions, hereinbelow are described certain more particularly described aspects of the inventions. These particularly recited aspects should not, however, be interpreted to have any limiting effect on any different claims containing different or more general teachings described herein, or that the “particular” aspects are somehow limited in some way other than the inherent meanings of the language and formulas literally used therein.

The present invention may be understood more readily by reference to the following detailed description of various aspects of the invention and the examples included therein and to the Figures and their previous and following description.

Disclosed herein are semi-solid electrolyte systems. The semi-solid electrolyte comprises a laminar clay material capable of interstitially absorbing water, forming a water-in-clay electrolyte. In secondary (reversible) aqueous zinc-ion batteries, parasitic reactions such as hydrogen evolution reactions and zinc corrosion lead to battery failure. In the disclosed semi-solid electrolyte system, the water-in-clay electrolyte alters the water chemistry thereby reducing water activity and preventing parasitic reactions.

In some aspects, the laminar clay material includes naturally occurring or synthetic swelling clays, such as smectites or montmorillonite or combinations thereof. While smectites and montmorillonite are example classes of clays, they are intended only for example. An exemplary clay includes those which have a laminar or layered structure and can accommodate water and various sized ions. Exemplary laminar clay materials include bentonite and laponite among others. It should be understood that the disclosure contemplates that other suitable materials may be used which comprise a laminar or layered structure.

An exemplary layered clay material includes a layer of silicates followed by a layer of metal-oxide followed by another layer of silica, thereby forming a repeating silicate-[metal-oxide]-silicate configuration. In some aspects, an intercalation layer forms between repeating silicate-[metal-oxide]-silicate layers, wherein the intercalation layer includes one or more intercalating ions and water.

In some aspects, the layered clay materials include one or more intercalated ions, wherein the one or more intercalated ions form an intercalation layer. Intercalating ions are introduced into the layer clay material by ion exchange. The interlayer distance of the layered clay material is adjusted by the selection of intercalated ion. Interlayer distance affects atomic structure and surface chemistry, which can lead to enhanced adsorption capacity. In some aspects, the intercalated ions are chosen to achieve a particular interlayer distance and/or to optimize the electrolyte performance. In some aspects, the intercalating ions are cations or anions. Exemplary intercalated ions are selected from lithium ions, calcium ions, potassium ions, magnesium ions, sodium ions, fluoride ions, chloride ions, ammonium ions, hydrogen ions, lanthanum ions, indium ions, and combinations thereof.

In some aspects, the intercalation ions are reversibly removed and inserted into the layered clay material.

In some aspects, the disclosure relates to an electrochemical cell, the electrochemical cell including an anode, a cathode, and a semi-solid electrolyte including a layered clay material including one or more intercalated ions, wherein the one or more intercalated ions form an intercalation layer; and an aqueous electrolyte salt.

In some aspects, the disclosure relates to an electrochemical symmetric cell, the electrochemical cell including zinc anode, zinc cathode, and a semi-solid electrolyte including a layered clay material including one or more intercalated ions, wherein the one or more intercalated ions form an intercalation layer; and an aqueous electrolyte salt.

In some aspects, the disclosure relates to an electrochemical half-cell, the electrochemical cell including zinc anode, copper cathode, and a semi-solid electrolyte including a layered clay material including one or more intercalated ions, wherein the one or more intercalated ions form an intercalation layer; and an aqueous electrolyte salt.

In some aspects, the techniques described herein relate to an electrochemical cell, wherein the one or more intercalated ions are selected from lithium ions, calcium ions, potassium ions, magnesium ions, sodium ions, fluoride ions, chloride ions, ammonium ions, hydrogen ions, lanthanum ions, indium ions, and combinations thereof.

In some aspects, the techniques described herein relate to an electrochemical cell, wherein the layered clay material includes naturally occurring or synthetic swelling clays, or combinations thereof. In some aspects, the layered clay material includes bentonite, laponite, or combinations thereof. It should be understood that the disclosure contemplates that other suitable materials may be used which comprise a laminar or layered structure.

In some aspects, the aqueous electrolyte salt includes a concentration of 1-3 Molar. In some aspects, the concentration of electrolyte sale in water is 1 M, 1.5 M, 2 M, 2.5 M, or 3 M. In some aspects, the electrolyte salt includes ZnSO₄, Zn(OTf)₂, and Zn(TFSI)₂. In some aspects, the semi-solid electrolyte includes a ratio of 1:2 to 1:1 weight by volume of layered clay material and aqueous electrolyte salt. In some aspects, the semi-solid electrolyte includes 5 g of layered clay material and 10 mL of salt water; 6 g of layered clay material and 10 mL of salt water; 7 g of layered clay material and 10 mL of salt water; 8 g of layered clay material and 10 mL of salt water; 9 g of layered clay material and 10 mL of salt water; or 10 g of layered clay material and 10 mL of salt water.

In some aspects, the electrochemical cell includes a zinc-based anode. In some aspects, the electrochemical cell includes vanadium-based oxides, manganese-based materials, Prussian blue analogues, cobalt-based oxides, polyanionic compounds, or combinations thereof. For example, the cathode includes vanadium oxide (V₂O₅), doped vanadium oxide, or Manganese oxide (MnO₂). It should be understood that the cathode materials disclosed are for example only and do not intend to limit the scope of the disclosure. Other suitable cathode materials known in the art are also contemplated for use in the electrochemical cell.

In an exemplary electrochemical cell, the semi-solid electrolyte acts as a separator. In some aspects, the semi-solid electrolyte includes a layered clay material, for example, laponite, that acts as a separator. Care is chosen in the selection of layered clay material that acts as a separator such that the material is mechanically and electrochemically robust.

In some aspects, the electrochemical cell is a high voltage cell and operates at over 2 volts.

In some aspects, the electrochemical cell retains at least 70% of its capacity after 200 cycles at 0.1 A/g; at least 94% of its capacity after 2000 cycles at 1 A/g; at least 86% of its capacity after 5000 cycles at 3 A/g.

In some aspects, the electrochemical cell retains at least 90% of its capacity after self-discharging for 2 days, at least 80% of its capacity after self-discharging for 10 days, at least 60% of its capacity after self-discharging for 30 days, and at least 40% of its capacity after self-discharging for 60 days.

### EXAMPLES

### Example 1: Swelling/Intercalation Clays

Preparation of Functionalized Bentonite (BT). To prepare functionalized BT, different cations (e.g., NH⁴⁺, Li⁺, Na⁺, K⁺, Mg²⁺, Ca²⁺, Mn²⁺, Zn²⁺, Fe³⁺, In³⁺, La³⁺) were intercalated into the interlayer of BT, as shown in FIG. 1. Intercalating cations in BT interlayers by ion exchange has been proven quite efficient in adjusting the interlayer distance and atomic structure and changing the surface chemistry of BT surface, leading to enhanced adsorption capacity [18-20]. The above-mentioned intercalation cations were incorporated into the BT interlayers by ion intercalation following the procedures as described in the following section. It should be noted that the above list of cations is for example only and is not intended to limit the scope of the disclosure.

(1) Li-intercalated BT (Li-BT): 10-160 g of BT powder and LiCl (4-840 g) were dispersed into water (1 L). The mixture was stirred vigorously with a homogenizer (1000 rpm) for 24 hours followed by aging the mixture under ambient conditions for 24 hours. The Li-BT solid sample was collected from the mixture by centrifugation (3000 rpm for 10 minutes) and freeze-dried for use.

(2) Na-intercalated BT (Na-BT): 10-160 g of BT powder and NaCl (5-360 g) was dispersed into water (1 L). The mixture was stirred vigorously with a homogenizer (1000 rpm) for 24 hours followed by aging the mixture under ambient conditions for 24 hours. The Na-BT solid sample was collected from the mixture by centrifugation (3000 rpm for 10 min) and freeze-dried for use.

(3) K-intercalated BT (K-BT): 10-160 g of BT powder and KCl (7-340 g) was dispersed into water (1 L). The mixture was stirred vigorously with a homogenizer (1000 rpm) for 24 hours followed by aging the mixture under ambient conditions for 24 hours. The K-BT solid sample will be collected from the mixture by centrifugation (3000 rpm for 10 minutes) and freeze-dried for use.

(4) NH₄-intercalated BT (NH₄-BT): 10-160 g of BT powder and NH₄Cl (5-383 g) was dispersed into water (1 L). The mixture will be stirred vigorously with a homogenizer (1000 rpm) for 24 hours followed by aging the mixture under ambient conditions for 24 hours. The NH₄-BT solid sample will be collected from the mixture by centrifugation (3000 rpm for 10 minutes) and freeze-dried for use.

(5) Mg-intercalated BT (Mg-BT): 10-160 g of BT powder and MgCl₂ (9-543 g) was dispersed into water (1 L). The mixture was stirred vigorously with a homogenizer (1000 rpm) for 24 hours followed by aging the mixture under ambient conditions for 24 hours. The Mg-BT solid sample will be collected from the mixture by centrifugation (3000 rpm for 10 minutes) and freeze-dried for use.

(6) Ca-intercalated BT (Ca-BT): 10-160 g of BT powder and CaCl₂) (10-745 g) was dispersed into water (1 L). The mixture was stirred vigorously with a homogenizer (1000 rpm) for 24 hours followed by aging the mixture under ambient conditions for 24 hours. The Ca-BT solid sample was collected from the mixture by centrifugation (3000 rpm for 10 minutes) and freeze-dried for use.

(7) Zn-intercalated BT (Zn-BT): 10-160 g of BT powder and ZnCl₂ (13-4320 g) was dispersed into water (1 L). The mixture was stirred vigorously with a homogenizer (1000 rpm) for 24 hours followed by aging the mixture under ambient conditions for 24 hours. The Zn-BT solid sample will be collected from the mixture by centrifugation (3000 rpm for 10 minutes) and freeze-dried for use.

(8) Mn-intercalated BT (Mn-BT): 10-160 g of BT powder and MnCl₂ (10-739 g) was dispersed into water (1 L). The mixture was stirred vigorously with a homogenizer (1000 rpm) for 24 hours followed by aging the mixture under ambient conditions for 24 hours. The Mn-BT solid sample will be collected from the mixture by centrifugation (3000 rpm for 10 minutes) and freeze-dried for use.

(9) In-intercalated BT (In-BT): 10-160 g of BT powder and InCl₃ (2-1950 g) was dispersed into water (1 L). The mixture was stirred vigorously with a homogenizer (1000 rpm) for 24 hours followed by aging the mixture under ambient conditions for 24 hours. The In-BT solid sample will be collected from the mixture by centrifugation (3000 rpm for 10 minutes) and freeze-dried for use.

(10) La-intercalated BT (La-BT): 10-160 g of BT powder and LaCl₃ (2-957 g) was dispersed into water (1 L). The mixture was stirred vigorously with a homogenizer (1000 rpm) for 24 hours followed by aging the mixture under ambient conditions for 24 hours. The La-BT solid sample will be collected from the mixture by centrifugation (3000 rpm for 10 minutes) and freeze-dried for use.

Preparation of BT-based electrolyte. 10 g of functionalized BT (e.g., Li-BT, Na-BT, K-BT, Mg-BT, Ca-BT) was added into 10 mL of conventional liquid electrolyte. The liquid electrolyte included 1-3 mol/L ZnSO₄, 1-3 mol/L Zn(Ac)₂, 1-3 mol/L Zn(OTf)₂, 1-3 mol/L Zn(TFSI)₂, 1-30 mol/kg ZnCl₂, 0.5 mol/kg Zn(ClO₄)₂+18 mol/kg NaClO₄, 1 mol/kg Zn(TFSI)₂+20 mol/kg LiTFSI, 3 mol/kg Zn(Ac)₂+3 mol/kg LiAc+30 mol/kg KAc, 1 mol/kg Zn(Ac)₂+31 mol/kg KAc, and a mixture thereof.

Cell fabrication. Standard CR2032 coin cell was used for assembling cells. Zn discs with a thickness of 0.1 mm and a diameter of 14 mm were used as the anode. Glass fiber membrane or filtration paper with a diameter of 16 mm was used as the separator. Vanadium oxide-based or manganese oxide-based materials were used as the active materials of the cathode. The active material, carbon black, and binder (PVDF) were mixed in a weight ratio of 7:2:1 and ground with NMP solvent to form a slurry. Then, the slurry was uniformly coated on carbon paper (10×10 cm²) and dried under vacuum at 80° C. overnight. The mass loading of the active material was 1.5˜2 mg/cm². Finally, cathode electrodes were obtained by punching the coated carbon paper into Φ14 mm discs and were used as the cathode for assembling full cells. 140 μL of the BT-based electrolyte was pasted on the surface of both electrodes to achieve the optimal electrochemical performance of aqueous zinc-ion batteries.

TABLE 1
Processing parameters of BT functionalization in different
salt solutions with a constant concentration of 2 mol/Kg.

| | LiCl | NaCl | KCl | CaCl2 | MgCl2 |
|---|---|---|---|---|---|
| Mass (g) | 84.8 | 116.9 | 149.1 | 294.0 | 406.6 |

A series of functionalized BT were synthesized to prepare the BT-based electrolyte for cell assembling, as summarized in Table 1. Metallic chloride salts were selected as the primary source of intercalating cations due to their low cost and higher water solubility. 10 g of functionalized BT (e.g., Li-BT or Na-BT, K-BT, Mg-BT, Ca-BT) was added into 10 mL of 2 mol/L ZnSO₄ aqueous solution. The mixture was mechanically stirred for 30 minutes and was aged for 24 hours to produce a uniform BT-based electrolyte for cell assembling. Sodium-doped vanadium oxide was used as the active material of the cathode [21].

FIG. 2 shows the cyclic stability of the high-voltage aqueous zinc-ion batteries based on the electrolyte containing different functionalized BT. The results show that the Mg-BT-based battery exhibit excellent cyclic stability over 500 cycles at a current density of 1 A/g in the working voltage range of 0.4-2.4 V, outperforming those of the batteries based on the liquid electrolyte (LE), pure BT (BT), and other functionalized BT such as Li-BT, Na-BT, K-BT and Ca-BT.

FIG. 3 shows the cyclic stability of the high-voltage aqueous zinc-ion batteries based on the electrolyte containing Ca-BT. The results show that the 2 m Ca-BT-based battery exhibit excellent cyclic stability over 300 cycles at a current density of 1 A/g in the working voltage range of 0.4-2.4 V, outperforming those of the batteries based on other Ca-BT.

FIG. 4 shows the cyclic stability of the high-voltage aqueous zinc-ion batteries based on the electrolyte containing K-BT. The results show that the 2 M K-BT-based battery exhibit excellent cyclic stability over 300 cycles at a current density of 1 A/g in the working voltage range of 0.4-2.4 V, outperforming those of the batteries based on other K-BT.

### Example 2: Bentonite Clays

Herein, a low-cost, quasi-solid-state “water-in-swelling-clay” electrolyte (WiSCE) was designed to provide a favorable aqueous environment for highly reversible Zn metal anodes. The WiSCE was prepared by mixing a high concentration (50% weight/volume, w/v) of a swelling clay, bentonite (BT, Al₂H₂O₁₂Si₄), with the baseline electrolyte (BE, 2 M ZnSO₄ in water). The resulting WiSCE possessed low salt concentration (1.2 M), high ionic conductivity (16.8 mS/cm), and increased storage modulus (1.1 MPa). Furthermore, water molecules were effectively confined between the interlayers of BT crystals, leading to significantly suppressed water activities toward Zn metal anodes and thus highly reversible Zn plating/stripping in the WiSCE. In addition, the WiSCE-based AZIB full cells exhibited high Coulombic efficiency (>99.9%), long shelf life (>60 days), ultralow self-discharge rate (1.89 mV/day), outstanding high-temperature adaptability (50° C.), and excellent cyclic stability at low and high C-rates. This example describes a cost-competitive aqueous electrolyte to design safe, durable, and reliable AZIBs. Moreover, this example opens up a new path for designing high-performance aqueous electrolytes based on swelling clays.

Electrolyte design principles. The configuration of WiSCE-based symmetric and full cells is illustrated schematically in FIG. 5A, in which an equal amount of WiSCE was uniformly pasted on each surface of the two electrodes (e.g., Zn metal anode or cathode). BT, or the synonym of montmorillonite, has two silica tetrahedral sheets (SiO₄) and a sandwiched alumina octahedral (AlO₅) sheet with extraordinary hydration swelling capability [40]. Once immersed into aqueous electrolytes, a significant amount of water molecules could be intercalated into BT crystals (see FIG. 1b), a phenomenon known as interlayer swelling [41-43]. It is contemplated that water activities are remarkably suppressed by confining water molecules within the interlayers of such mineral clays with excellent swelling capabilities, preventing Zn metal anodes from water-induced parasitic reactions and thus enhancing their reversibility in aqueous environments.

Preparation of electrolytes: The “water-in-swelling-clay” electrolytes (WiSCEs) were prepared by mixing specific amounts (4-10 g) of bentonite (BT) with 10 mL of baseline electrolyte (BE, 2 M ZnSO₄ in water). Then, the mixtures were thoroughly stirred at room temperature to form uniform pastes. The as-obtained pastes were further aged for 24 h at room temperature to allow the fully hydration and swelling of BT in the electrolyte environments. The resulting WiSCEs were denoted as BTx, where x represents the mass of BT per 10 mL of BE. For instance, the WiSCEs with 4 and 10 g of BT in 10 mL of BE were denoted as BT4 and BT10, respectively.

As a proof-of-concept, Zn∥Zn symmetric cells based on the WiSCEs with different BT contents were assembled and cycled at 1 mA/cm2 and 1 mAh/cm² (see FIG. 5C). The WiSCEs were denoted as BTx, where x represents the mass of BT per 10 mL of BE. For instance, the WiSCEs with 4 and 10 g of BT in 10 mL of BE were denoted as BT4 and BT10, respectively. The results showed that the cycle life of Zn∥Zn symmetric cells increased with increasing BT content since more water molecules could be effectively confined by BT. Notably, the BT10-based symmetric cell displayed the longest cycle life of 980 hours. In sharp contrast, the BE-based symmetric cell sustained less than 80 hours with a sudden drop in voltage hysteresis. The cyclic stability of WiSCE-based AZIB full cells exhibited the same trend when varying the concentrations of BT, and the BT10-based battery displayed the highest stability during long-term cycling (FIG. 6). Most importantly, other natural clays or inorganic materials without interlayer swelling capabilities but with similar chemical compositions such as kaolinite (KL, Al₂H₄O₉Si₂) and silicon dioxide (SiO₂) could not enhance the cyclic stability of full cells when added into BE as comparisons (FIG. 7 and FIG. 8). For KL or SiO₂, water molecules can only be absorbed on the particle surfaces, resulting in limited confinement effect and thus poor cyclic stability of AZIB full cells. Such a comparison between BT and KL (or SiO₂) highlighted the significance of confining water molecules within the interlayers. Moreover, BT has been widely used in industry with a low cost (˜$90 per ton with freight cost) and high yield (˜21 million metric tons in 2020) [44, 45], rendering it a cost-competitive electrolyte additive for AZIBs. For instance, the state-of-the-art “water-in-salt” electrolyte [46], 1 mol Zn(TFSI)₂ and 20 mol LiTFSI in 1 kg of water, costs $6.87 million per metric ton, which is 7,438 times higher than the cost ($924 per metric ton) of the WiSCE. Importantly, the WiSCE-based full cell exhibited a significantly higher capacity (313 mAh/g at 0.4 C) than that (100 mAh/g at 0.2 C) of the reported AZIB full cell based on the “water-in-salt” electrolyte [46].

Cell assembling: Standard CR2032 coin cell was used for assembling cells. Zn discs with a thickness of 0.1 mm and a diameter of 14 mm were used as anodes. A glass fiber membrane (GF/A, Whatman) with a diameter of 16 mm was used as separator. The cathode material-sodium-doped vanadium oxide (NVO) was prepared following the procedures described in prior work [4]. Briefly, 3.638 g V₂O₅ and 0.8 g NaOH were added into 80 mL of ultrapure water under magnetically stirring for 4 hours. After that, the solution was transferred to a 200 mL autoclave and kept at 180° C. for 48 hours. The solid products after hydrothermal treatment were collected and centrifuged with ultra-pure water at 5000 RPM for 15 minutes and repeated 5 times. The sediments after centrifuge were freeze-dried for 48 hours followed by vacuum drying at 80° C. for 12 hours to obtain the final active materials. The active material (NVO), carbon black, and binder (PVDF) were mixed in a weight ratio of 7:2:1 and ground with NMP to form a slurry. Then, the slurry was uniformly coated on carbon paper (10×10 cm²) and dried under vacuum at 80° C. overnight. The mass loading of the NVO was 1.5˜2 mg/cm². Finally, NVO electrodes were obtained by punching the NVO-coated carbon paper into @14 mm discs and were used as the cathode for assembling full cells. For BE, 100 μL of liquid electrolytes were used to assemble symmetric and full cells. For the quasi-solid-state WiSCEs (BT4-BT10), an equal amount of electrolyte (70 μL) was pasted on the surface of both electrodes.

Electrolyte properties and structures. The BT powder exhibited an irregular flake-like shape with an average particle size of less than 10 μm (FIG. 9) and consisted of Si, Al, and O as confirmed by X-ray photoelectron spectroscopy (FIG. 10). Upon adding high concentrations of BT into the baseline electrolyte (i.e., 2 M ZnSO₄ in water), the resulting WiSCEs turned into a quasi-solid-state (FIG. 11) due to the formation of gel structures between BT plates [47]. FIG. 13A shows the exact water contents in the WiSCEs determined by thermogravimetric analysis (TGA) tests. The BT powder contained 8% of physically adsorbed water, which rapidly evaporated before the temperature reached 100° C. In the WiSCEs, water content monotonically decreased with increasing BT concentration. Remarkably, the water content in BT10 decreased to 41.3 wt % (FIG. 12), much lower than those of BE (75.3 wt %) and previously reported polymeric hydrogel electrolytes (66.3-88.8 wt %) [48]. Moreover, the complete loss of water in the WiSCEs was significantly delayed up to 170° C., suggesting that water molecules were strongly bounded to the BT host.

The existence of interlayer water in the WiSCEs was evidenced by X-ray diffraction (XRD) tests, as shown in FIG. 13B. The BT powder showed an initial basal spacing (d₀₀₁) of 12.2 Å and several characteristic diffraction peaks of montmorillonite at 7°, 20°, 29°, 35° and quartz at 27° [49]. In the WiSCEs, the door of BT crystals increased to 18.9 Å because of water intercalation, corresponding to an enlarged interlayer spacing from 2.6 to 9.3 Å (FIG. 14) [50]. Based on the interlayer spacing, a volume expansion ratio (ER) of 54.9% of the swelled BT in BT10 electrolyte could be determined according to the method described in prior work [51], which suggested that approximately 35.6 vol % of free water from the BE was confined within the interlayers of BT crystals. Additionally, water molecules could also be adsorbed on the external surface of BT [52-54], resulting in significantly decreased amounts of free water and low water activities in the WiSCEs. Moreover, the enlarged interlayer spacing not only accommodated more water molecules between BT layers but also facilitated ion transport through the nanochannels in the viscous quasi-solid-state electrolytes. Consequently, BT10 still maintained a high ionic conductivity of 16.8 mS/cm (FIG. 13C) given the ultrahigh viscosity (1363.4 Pa·s) and diluted salt concentration (1.2 M, FIG. 15) upon BT addition. In comparison, BE with a salt concentration of 2 M exhibited an ionic conductivity of 51.9 mS/cm and a low viscosity of 6.6 Pas. In the WiSCEs, the unique layered structure of BT enabled the formation of fast ion-conducting pathways, which reduced ion diffusion length and facilitated fast ion transport [55]. The addition of BT also affected the pH of the WiSCEs because of the hydrolysis of BT and the adsorption of Zn ions [56, 57]. For the electrolytes ranging from BT4 to BT10, their pH values stabilized at approximately 5.5 (FIG. 16), which could alleviate Zn corrosion and hydrogen evolutions in such near-neutral environments [25]. In terms of viscoelastic properties, BT10 electrolyte exhibited the highest storage modulus (Ge) of 1.07 MPa (FIG. 13D), signifying its superior mechanical resistance against Zn dendrite growth [58, 59]. Moreover, the WiSCEs exhibited solid-like rheological properties (FIG. 17) due to the formation of gel structures [40, 60], which is highly desired in practical applications vulnerable to electrolyte leakage [61, 62].

To further unveil the interactions between water molecules and BT, Fourier-transform infrared (FTIR) spectroscopy and Raman spectroscopy were conducted. In the FTIR spectra (FIG. 13E and FIG. 18), the broad peak ranging from 2700 to 3700 cm⁻¹ because of O—H stretching vibration shifted to higher wavenumbers with a steadily decreased magnitude when increasing the concentration of BT. This implied the strengthened hydrogen-bonding (H-bonding) interactions between water and BT and the weakened H-bonding interactions among water molecules [63-65]. The chemical environment of water was further investigated by Raman tests, as shown in FIG. 13F. Compared with BE, the O—H stretching vibration in the Raman spectrum of BT10 electrolyte was largely suppressed because of the limited amounts of free water molecules [66]. Moreover, in the Raman spectrum of BE, the broad peak of O—H stretching vibration can be convolved into two major peaks located at 3280 and 3430 cm⁻¹ corresponding to water molecules with strong and weak H-bonds [67], respectively. In BT10 electrolyte, the H-bonds between water molecules were significantly weakened. In detail, the peak assigned to water molecules with strong H-bonds was absent, and a new peak located at 3630 cm⁻¹ appeared because of non-hydrogen-bound water molecules [67]. These results suggested that the addition of BT effectively reconstructed the H-bonding networks between water molecules and resulted in low water activities in BT10 electrolyte. The stretching vibrations of SO₄²⁻ located at 454 and 623 cm⁻¹ were also largely blue-shifted (FIG. 19) in the presence of BT, implying the changes of solvation environments [68].

To validate the experimental results, the adsorption of H₂O and Zn²⁺ onto the surface of BT crystals was examined by density functional theory (DFT) calculations, as shown in FIG. 13G. Three adsorption configurations (FIGS. 20A-20C and FIGS. 21A-21C) were defined due to the symmetricity of the (001) basal plane of BT crystals. FIG. 13H shows the adsorption energies of Zn²⁺ and H₂O at different sites. At site 1, the center of the hexagon-like oxygen rings, Zn²⁺ adsorption was thermodynamically stable with an adsorption energy of −0.96 eV attributed to the Coulombic interactions between Zn²⁺ and oxygen atoms on BT surface. The strong Zn²⁺ adsorption of BT could potentially alter the solvation environment of Zn²⁺ and their diffusion pathways, thus facilitating fast ion diffusions and reversible Zn plating/stripping. Nevertheless, molecular dynamics simulations (FIG. 22) indicated that the Zn ions existing within the BT interlayers or in BE possessed the same solvation structure with a coordination number of 6 (FIG. 23) since the interlayer spacing (9.3 Å) of swelled BT is larger than the size (8.6 Å) of solvated zinc ions —Zn²⁺·(H₂O)₆ [69]. Meanwhile, stable water adsorptions were observed on the entire BT surface with a lowest adsorption energy of −0.18 eV at site 1, suggesting the excellent hydration swelling capabilities of BT. Notably, at site 1, a strong H-bond was formed between the adsorbed H2O and the oxygen atom on BT surface (FIG. 20A). These results implied that the strong water adsorption by BT was enabled by the formation of H-bonds between the two species, which further resulted in the low water activities in the quasi-solid-state WiSCEs.

Stability of Zn metal in the WiCEs. FIG. 24A shows the comparative chronoamperometry (CA) curves of the Zn metal electrodes in BE and WiSCEs with a constant overpotential of −150 mV. In BE, the current density of the Zn metal electrode increased rapidly over 120 second, indicating a long 2D diffusion process and remarkable tipping effect induced by Zn dendrite growth [70, 71]. On the contrary, the plating of Zn in the WiSCEs quickly developed into a stable 3D diffusion process after a very short period (˜20 seconds) of Zn nucleation and 2D diffusion. This result suggested the formation of a smooth and flat Zn/electrolyte interface owing to localized Zn²⁺ reduction and uniform Zn deposition in the WiSCEs [71]. The HER behavior of Zn metal electrodes in BE and BT10 electrolytes was investigated by linear sweep voltammetry (LSV) tests, as shown in FIG. 24B. In BT10 electrolyte, the HER onset potential was delayed to −1.04 V vs. Ag/AgCl with a low current during hydrogen evolutions, which could be attributed to the limited free water molecules, low water activities, and near-neutral pH (˜5.5) environment of the quasi-solid-state electrolyte. The oxygen evolution reaction (FIG. 25) was also retarded and suppressed in BT10 electrolyte, suggesting the high stability of water molecules.

The comparative anti-corrosion performance of Zn metal in BE and WiSCEs was investigated by Tafel and soaking tests. As shown in FIG. 24C, the high corrosion current density (i_{corr}=15.86 mA/cm²) indicated the aggressive corrosion of Zn metal in BE. In WiSCEs, the i_{corr} monotonically decreased to 4.20 mA/cm² in BT10 when increasing the BT content. The Zn metal electrodes also exhibited more negative corrosion potentials (approximately −1.01 V vs. Ag/AgCl) in WiSCEs compared with that (−1.00 V vs. Ag/AgCl) in BE (FIG. 26). These results reflected the low corrosion rate and excellent corrosion resistance of Zn metal in the WiSCEs due to the effective suppression of water activities. The extraordinary anti-corrosion performance of Zn metal in the highly concentrated WiSCEs was further confirmed by soaking tests. After being soaked in BE for 30 days at room temperature, the pristine smooth Zn surface (FIG. 27) was passivated by numerous flake-like byproducts (FIG. 24D), indicating the severe corrosion and passivation of Zn in the mild acidic electrolyte. In contrast, the Zn metal soaked in BT10 electrolyte under the same condition remained nearly intact and free of precipitated byproducts (FIG. 24E and FIG. 28A). Even at an elevated temperature (50° C.), Zn metal still demonstrated superior corrosion resistance in BT10 electrolyte. Unlike the intense passivation of Zn surface by the precipitation of large-flake byproducts in BE (FIG. 3f), the Zn surface remained nearly free of byproducts (FIG. 24G and FIG. 28A) after being soaked in BT10 electrolyte for 10 days at 50° C., which was further evidenced by XRD tests (FIG. 29). Moreover, the rate of hydrogen evolutions during the soaking test was quantified using an analytical balance. As shown in FIG. 30, the hydrogen generation rate reached 28 μmol/(h·cm²) or 0.68 mL/(h·cm²) in BE while no hydrogen evolutions were observed in BT10 electrolyte.

Quantification of hydrogen evolutions during the soaking test. A large piece of Zn foil (10×8.7 cm²) was placed in a petri dish containing 100 mL of BE or BT10 electrolyte. Then the entire petri dish was tightly sealed with layers of plastic wrap and parafilm to prevent the escape of moisture while allowing the generated hydrogen gas to permeate. The mass of the scaled petri dish was monitored by an analytic balance with an accuracy of 0.01 mg. The decreased mass of the entire petri dish represents the mass of the generated hydrogen during the soaking test.

Reversibility of Zn metal anodes in the WiCEs. Zn∥Zn and Cu∥Zn cells were assembled to investigate the reversibility of Zn metal anodes in the WiCEs. FIG. 31A compares the cyclic stability of Zn∥Zn symmetric cells based on BE and BT10 electrolytes at a current density of 1 mA/cm² and a capacity of 1 mAh/cm². A typical BE-based Zn∥Zn symmetric cell failed after approximately 80 hours with significant voltage fluctuations. During long-term cycling, abundant byproducts and porous Zn deposits were formed on the surface of Zn metal anodes (FIGS. 32A-32B), which resulted in a short cycle life of the BE-based symmetric cell. However, in BT10 electrolyte, the cycled Zn metal anode exhibited a dendrite-free morphology (FIGS. 32C-32D) because of the significantly suppressed hydrogen evolutions, Zn corrosion, and dendrite growth. Therefore, the cycle life of the BT10-based Zn∥Zn symmetric cell can be prolonged to 980 h with lower voltage hysteresis (FIG. 33). Nevertheless, the voltage hysteresis gradually increased during cycling because a small amount of byproducts were still produced on the surface of Zn metal anode, as confirmed by SEM (FIG. 32C) and XRD (FIG. 34). As shown in FIG. 35, BT10-based Zn∥Zn symmetric cell also exhibited a lower charge transfer resistance of 230Ω compared with that (270Ω) of the BE-based Zn∥Zn cell, implying its fast kinetics during Zn plating/stripping.

FIG. 31B shows the rate capabilities of the Zn∥Zn symmetric cells based on BE and BT10 electrolytes. The BT10-based symmetric cell exhibited a stable voltage profile with low voltage hysteresis upon changing current densities. Comparatively, the BE-based symmetric cell quickly failed when switching the current density from 10 to 1 mA/cm². As shown in FIG. 31C, when cycled at lower areal capacities of 0.5 and 0.1 mAh/cm² with a C-rate of 1 C, the cycle life of the BT10-based symmetric cells was further extended to 1370 hours and 2000 hours, respectively. The enhanced Zn plating/stripping reversibility could be mainly attributed to the low water activities and high mechanical stiffness of the quasi-solid-state BT10 electrolyte, making it effective in suppressing HER, Zn corrosion, and dendrite growth over long-term cycling. Meanwhile, the quasi-solid-state BT10 electrolyte significantly inhibited water-induced parasitic reactions that would otherwise result in low Coulombic efficiency (CE) during Zn plating/stripping. As shown in FIG. 31D, the BE-based Cu∥Zn half-cell possessed a low initial CE of 83.75% and failed after 60 cycles at 1 mA/cm² with a significant drop of voltage hysteresis (FIG. 36). In comparison, the initial CE of the BT10-based Cu∥Zn half-cell increased to 96.87%, and a high average CE of 99.53% was achieved during the cycling. The corresponding voltage profiles shown in FIG. 31E remained unchanged from 50 to 150 cycles, confirming remarkably inhibited water-induced parasitic reactions in the quasi-solid-state BT10 electrolyte. Furthermore, the nucleation overpotential dropped dramatically from 41 to 12 mV (FIG. 37), suggesting a lower energy barrier of Zn reduction in BT10 electrolyte, which is conducive to the uniform nucleation and deposition of Zn metal [34].

To demonstrate the advantages of the WiSCEs in practical applications, AZIB full cells were assembled using the widely reported cathode material, sodium doped V₂O₅ (NVO) [72, 73]. FIGS. 38A-38B show the cyclic voltammetry (CV) and galvanostatic charge/discharge curves of the Zn∥NVO full cells based on BE and BT10 electrolytes, respectively. Similar redox peaks during the CV test and nearly identical voltage profiles during charge/discharge were observed, suggesting that no extra redox or parasitic reactions were introduced by BT. FIG. 38C shows the rate capabilities of the full cells based on the two electrolytes, in which the BT10-based cell exhibited discharge capacities of 313.0, 217.2, 181.2, 146.1, 86.1 mAh/g at current densities of 0.1, 0.5, 1, 2, 5 A/g, respectively. The specific capacity of the BT10-based full cell recovered to 180.1 mAh/g when the current density returned to 1 A/g, higher than that of the BE-based cell (170.8 mAh/g). Moreover, the BT10-based full cell exhibited a lower charge transfer resistance compared with that of the BE-based cell (FIG. 39), consistent with the results obtained in symmetric cells.

FIGS. 38D-38F show the comparative long-term cyclic stability and CEs of the Zn∥NVO full cells based on BE and BT10 electrolytes at three different current densities. At a current density of 1 A/g, the BT10-based full cell exhibited an initial discharge capacity of 122.1 mAh/g and maintained a discharge capacity of 118.0 mAh/g after 2000 cycles (FIG. 38D), corresponding to an ultrahigh capacity retention rate of 96.64%. In contrast, the capacity of the BE-based full cell retained only 32.01% after 1000 cycles and failed after approximately 1900 cycles. At a lower current density of 0.1 A/g, the BT10-based full cell displayed a high initial discharge capacity of 318.5 mAh/g, as shown in FIG. 38E. The capacity decreased to 284.5 mAh/g at the 2^{nd} cycle and retained 257.4 mAh/g at the 200^{th} cycle, corresponding to a high retention rate of 90.47% over 200 cycles, while the BE-based full cell only retained 21.49% of its initial capacity after 200 cycles at 0.1 A/g due to the severe parasitic reactions. At a high current density of 3 A/g, the capacity of the BT10-based full cell retained 88.29% after 5000 cycles, substantially outperforming that (4.44%) of the BE-based full cell under the same condition (FIG. 38F). Moreover, the CEs of the BT10-based full cells were much more stable than those of BE-based batteries at the three current densities. Compared with previously reported AZIBs with different electrolyte additives, the BT10-based full cells exhibited substantially better cyclic stability at practical C-rates. To understand the remarkably improved cyclic stability of BT10-based full cells, the morphology of the cycled Zn metal anode was characterized by SEM (FIGS. 40A-40D). After 1000 cycles at 3 A/g, the Zn metal anode cycled in BT10 electrolyte maintained a dendrite-free morphology due to the high stiffness of the quasi-solid-state electrolyte and suppressed water activities, which is in sharp contrast with that of the Zn metal anode cycled in BE. These results confirmed that BT, a low-cost and high-availability electrolyte additive, provided a favorable aqueous environment for Zn metal anodes. Thus, the cyclability of BT10-based full cells could be significantly enhanced at low and high charge/discharge C-rates, which is highly desired in practical grid-scale energy storage applications.

In addition, FIG. 38G exhibits the comparative self-discharge performance of the Zn∥NVO full cells based on BE and BT10 electrolytes, which was evaluated by monitoring the open circuit voltage (OCV) of fully charged cells during rest time up to 60 days before being fully discharged to 0.4 V. FIG. 41 shows the corresponding voltage profiles of the Zn∥NVO full cells during resting. Because of the severe parasitic reactions, the OCV of the BE-based full cells quickly dropped to 1.04 V after resting for two days and retained only 0.96 V after resting for ten days. When further extending the resting time, drastic voltage drops were observed for the BE-based full cells, indicating the failure of these batteries because of severe hydrogen evolutions and Zn corrosion during long-term resting. On the contrary, for the BT10-based full cells, the OCV dropped to 1.24 V after resting for two days and retained 1.13 V after resting for sixty days, corresponding to an ultralow voltage degradation rate of 1.89 mV/day or 0.079 mV/h, which is one order of magnitude lower than those of previously reported aqueous batteries [74, 75]. Moreover, the BT10-based full cell still retained 43.74% of its charge capacity after resting for 60 days (FIG. 42), demonstrating that the quasi-solid-state electrolyte is highly promising for practical AZIBs that require long-term storage capabilities.

The superior long-term-storage capability of the BT10-based full cells was further demonstrated by storing the assembled full cells at room temperature for up to sixty days before cyclic galvanostatic charge/discharge tests. As shown in FIG. 44A, after sixty days of storage, the BT10-based full cell still featured extraordinary cyclic stability and high average CE (99.94%, FIG. 43) over 2000 cycles at 1 A/g, indicating its ultralong shelf life and outstanding resistance to performance degradation during long-term storage. In comparison, FIG. 44B exhibits that the BE-based full cell suffered from severe capacity degradation after ten days of storage and failed when further extending the storage time (FIG. 45). At a higher temperature of 50° C., the shelf life of the BE-based full cell was further decreased to less than one day (FIG. 46) due to the significantly accelerated hydrogen evolutions and Zn corrosion. However, as shown in FIG. 44C, the BT10-based full cell still exhibited excellent cyclic stability over 2000 cycles at 1 A/g after ten days of storage at 50° C., signifying its long shelf life at elevated temperatures. Moreover, FIG. 44D shows that the as-assembled BT10-based full cell could safely operate at 50° C. over 400 cycles at 1 A/g and retained 84.54% of its initial capacity of 220.5 mAh/g, outperforming the high-temperature adaptability of most AZIBs reported in prior work. These results manifested the extraordinary shelf life and high-temperature adaptability of the BT10-based full cells toward practical energy storage applications.

Discussion. To date, many strategies have been proposed to address water-induced issues and construct stable Zn/electrolyte interfaces in aqueous electrolytes, including Zn surface modification [7-9], Zn crystallography modulation [10-12], separator functionalization [13-15] and electrolyte engineering [16-18]. Among them, electrolyte engineering has been widely considered the most promising strategy that fundamentally regulates water activities to promote reversible Zn-metal-based battery chemistries in aqueous environments [19]. A wide range of additives have been added to baseline electrolytes (e.g., 1-3 M ZnSO₄ in water), including inorganic oxides [20-23], salts [24-27], polymers [28-30], graphene quantum dots and organic compounds [32-35]. However, grid-scale energy storage devices mainly operate at current rates (C-rates, 1 C means that a battery can be fully charged or discharged in an hour) lower than 0.5 C with peak rates up to 10 C (i.e., 6 min per charge or discharge) [36, 37]. Unfortunately, the majority of electrolyte additives have limited effect in enhancing the cyclic stability of AZIBs at low C-rates (≤10 C) or low current densities (≤1 A/g). This is because a high cycle number but a short run time of AZIBs achieved at high C-rates can tremendously underrate the irreversibility of time-dependent, water-induced parasitic reactions, such as HER and Zn corrosion, which has been elaborated in several reviews [37-39]. Moreover, the high cost and limited material availability of conventional additives adversely affect the advantages of AZIBs as economic and scalable alternatives. Therefore, finding low-cost and high-availability electrolyte additives that can simultaneously improve the long-term stability of AZIBs remains a daunting task for their practical applications in grid-scale energy storage.

Conclusions. A new type of quasi-solid-state WiSCE was developed to reduce free water contents and suppress water activities for highly reversible Zn plating/stripping in aqueous environments. By introducing a low-cost and high-availability swelling clay, bentonite, into the mild acidic electrolyte, water molecules could be strongly confined within the interlayers of BT crystals, leading to low water activities in the quasi-solid-state electrolyte. The formation of gel structures between BT plates also enabled the high stiffness and high viscosity of the BT-based electrolyte. Therefore, the dendrite growth, Zn corrosion, and gas evolutions at the Zn/electrolyte interface could be effectively inhibited. In addition, the WiSCE-based Zn∥NVO full cells exhibited ultrahigh cyclic stability at low and high current densities. Particularly, the capacities of the full cells retained 90.47% after 200 cycles at 0.1 A/g, 96.64% after 2000 cycles at 1 A/g, and 88.29% after 5000 cycles at 3 A/g. This work revealed that a natural swelling clay, bentonite, with layered structures could effectively enhance the cyclic stability, safety, and durability of AZIBs. Benefiting from the low cost, high availability, and facile functionalization of BT, the WiSCE would be promising to design high-performance AZIBs and accelerate their commercialization in grid-scale energy storage applications.

Additional example can be found in Siyu Tian, et. al., “Suppressing Dendrite Growth and Side Reactions via Mechanically Robust Laponite-Based Electrolyte Membranes for Ultra-stable Aqueous Zinc-Ion Batteries,” ACS Nano 2023 17 (15), 14930-1494 and supporting information, which is incorporated herein in its entirety.

### Example 3: Laponite Clays

Described herein is a freestanding, mechanically robust laponite (LP)-based electrolyte membrane with low water activity that was designed for ultra-stable, separator-free AZIBs. As schematically illustrated in FIG. 47A, the plate-like LP nanocrystals, with a trioctahedral 2:1 layered nanostructure and exceptional swelling capabilities, can absorb large amounts of water molecules and confine them on their external/internal surfaces and within the interlayers, thus significantly suppressing water activity and water-induced side reactions. Such an interlayer confinement phenomenon is significantly different from previously reported electrolyte systems containing conventional additives such as polymers, inorganic particles, and ionic solutes.³²⁻³⁴ In these conventional electrolyte systems, no two-dimensional (2D) nanoconfinement effect on water molecules exists, as shown in FIG. 47B. Moreover, the strong LP-water interactions play a key role in regulating the water activity in the LP-based electrolyte membranes. As shown in FIG. 47C, density functional theory (DFT) calculations show that the lowest unoccupied molecular orbital (LUMO) energy level of the water molecules absorbed by LP nanocrystals is above that of water molecules in the baseline electrolyte (BE, 2 M ZnSO₄ in water). This observation implies enhanced electrochemical stability for these adsorbed water molecules against electrochemical reduction (HER). FIG. 47D further shows that the Zn metal electrode exhibits a delayed HER onset potential and a lower HER current in the optimal LP9 (i.e., 9 g of LP in 10 mL of BE) electrolyte membrane in comparison to BE. For instance, at a constant potential of −1.4 V vs. Ag/AgCl, the HER currents in BE and LP9 electrolytes are 25.3 and 3.6 mA, respectively. These results provide strong evidence that the HER activity could be significantly suppressed by confining water molecules on the external/internal surfaces of the LP nanocrystals. Therefore, the LP-based separator-free AZIB full cells exhibit excellent long-term cyclic stability and outstanding reliability during long-term storage, primarily due to the significantly suppressed water-induced side reactions and uniform Zn deposition. Particularly, the LP-based full cells exhibit high-capacity retention rates of 94.10% after 2,000 cycles and 86.32% after 10,000 cycles at current densities of 1 and 3 A/g, respectively. The freestanding LP-based electrolyte membrane is demonstrated to be a promising candidate for fabricating cost-competitive, high-performance AZIBs.

Electrolyte Characterization. FIG. 48 and FIG. 49 show the SEM image and X-ray photoelectron spectroscopy (XPS) spectrum of the Laponite (LP) powders, respectively. The LP powders mainly consisted of Si, Mg, Li, Na, and O elements, consistent with the empirical chemical formula of Na⁺_{0.7} [Mg_{5.5}Li_{0.3}Si₈O₂₀(OH)₄]^{-0.7} [40]. Such a 2:1 phyllosilicate nano-clay contains two magnesium octahedral layers and a sandwiched silica tetrahedral layer. The single LP nanocrystal possessed a diameter of 25 nm and a thickness of 0.92 nm [41]. In the LP nanocrystals, lithium partially substituted magnesium atoms, resulting in a negatively charged basal plane, which was neutralized by interlayer sodium ions [40]. The electrolyte membranes with different amounts of LP are denoted as LPx, where x represents the mass of LP in 10 mL of BE. For instance, the electrolyte membranes with 6 and 9 g of LP in 10 mL of BE are denoted as LP6 and LP9, respectively. Note that the electrolyte membranes with lower concentrations of LP (e.g., LP5) were not sufficiently robust to function as a separator. Moreover, the separator-free LP9-based Zn∥NVO full cell exhibited superior stability over long-term cycling in comparison with other electrolyte membranes containing lower LP concentrations. At higher LP concentrations, such as the LP10 electrolyte membrane, inadequate electrolyte-electrode wetting was observed, resulting in the low capacity of AZIB full cells, as shown in FIG. 51.

FIG. 50A and FIG. 52 show the thermogravimetric analysis (TGA) curves and the water contents of LP-based electrolyte membranes, respectively. Compared to BE containing an excess amount (75.3 wt %) of water, the water content in LP9 electrolyte membrane decreased to 45.3 wt %. In addition, water molecules from the BE intercalated into the interlayers and were absorbed on the internal surface of LP nanocrystals, which was induced by the hydration effect [42]. As shown in FIG. 50B, the basal spacing (d001) of LP nanocrystals increased from 12.5 to 22.8 Å in the LP9 electrolyte membrane. Since the layer thickness of LP nanocrystals was 9.2 Å[40], the interlayer spacing of the LP nanocrystals increased from 3.3 Å in the initial state to 13.6 Å upon water intercalation (FIG. 53). It was estimated that approximately 30% of the free water in BE was confined within the interlayers of LP nanocrystals. Furthermore, FIG. 54 shows that the LP powders possessed a large surface area of 321.3 m²/g, offering abundant adsorption sites for the effective immobilization of water molecules on their external surfaces. Additionally, the pH and salt concentration of the LP9 electrolyte membrane were measured to be 5.03 M (see FIG. 55) and 1.48 M (see FIG. 56), respectively. Compared to BE, the addition of LP nanocrystals results in a slight increase of pH from 4.64 to 5.03 due to their weak alkalinity arising from proton adsorption [43]. Meanwhile, the pH of the LP-based electrolyte membranes varied only slightly due to the high LP concentrations [44, 45].

LP nanocrystals formed a stable gel structure when dispersed in water due to the strong electrostatic attractions between the negatively charged basal planes and the positively charged edges of the nanocrystals [46, 47]. FIG. 57 depicts the surface and cross-sectional morphologies of the LP9 electrolyte membrane. Different from the highly porous structure of polymer-based hydrogels, the LP9 electrolyte membrane exhibits a dense structure without the presence of pores. As shown in FIG. 50C, the LP9 electrolyte membrane possessed an ultrahigh viscosity of 2,191.7 Pa·s, which is 332 times greater than that (6.6 Pa·s) of the BE. Despite the substantially increased viscosity, the LP9 electrolyte membrane exhibited a high ionic conductivity of 19.6 mS/cm, albeit lower than that (51.9 mS/cm) of the BE, surpassing the performance of previously reported gel electrolytes and water-in-salt electrolytes [36,37]. Moreover, as shown in FIG. 58, the LP9 electrolyte membrane exhibited a Zn²⁺ transference number of 0.76, higher than those of conventional liquid electrolytes [49,50]. This could be attributed to the 2D nanostructures and the highly negatively charged basal plane of the LP nanocrystals, which facilitate fast cation diffusion in the quasi-solid-state electrolyte membrane [48,49,51]. The storage modulus (G′) of the LP-based electrolyte membranes is shown in FIG. 50D, and the inserted optical image shows the appearance of a freestanding LP9 electrolyte membrane. Notably, the LP6 and LP9 electrolyte membranes exhibited high G′ values of 0.8 and 2.0 MPa, respectively, signifying their exceptional mechanical resistance against Zn dendrite growth. The exceptional mechanical strength of the LP-based electrolyte membranes ensures their function as robust separators for their successful integration into separator-free AZIBs. These characteristics of LP make it promising for regulating water activity in aqueous batteries.

To investigate the interactions between LP and water, Fourier-transform infrared (FTIR) and Raman spectroscopy tests were conducted. FIG. 50E displays the FTIR spectra of the BE and LP-based electrolyte membranes. Due to the presence of water molecules, a typical broad O—H stretching vibration peak ranging from 2,700 to 3,800 cm⁻¹ was observed. Comparatively, the broad O—H stretching vibration peak of the LP-based electrolyte membranes exhibited a lower magnitude and was blue-shifted to higher wavenumbers, suggesting the formation of strong hydrogen bonds (H-bonds) between water and LP and the weakened H-bonds among water molecules [52,53,54]. FIG. 50F further shows the comparative Raman spectra of the BE and LP9 electrolyte membrane. In the LP9 electrolyte membrane, the intensity of the O—H stretching vibration originating from water molecules was largely suppressed because of reduced free water content [55]. In addition, the convolution of the O—H stretching vibration peak indicates that the water molecules in the BE were dominated by strong and weak H-bonds, consistent with prior work [56]. In contrast, for the LP9 electrolyte membrane, new peaks appear, which could be attributed to the O—H stretching vibration of non-H-bound water molecules at 3,650 cm⁻¹ and the vibrations of structural-OH of the LP nanocrystals in the range of 3,675-3,730 cm⁻¹. These results infer that the water molecules in the LP9 electrolyte membrane were strongly bound by LP nanocrystals, resulting in significantly suppressed water activity [57,58].

To understand the interactions between LP and BE, DFT calculations were performed to investigate the H₂O and Zn²⁺ adsorption behaviors. Detailed atomic structures of the absorbed water molecules on the LP surface are presented in FIG. 59. The adsorption sites on the LP surface are shown in FIG. 50G and illustrate the strong interactions between LP and absorbed H₂O at site 3 near the sodium ion. Strong H-bonding interaction and Coulombic attraction exist between H₂O and LP due to the abundant oxygen and sodium ions on the LP surface, posing a strong confinement effect on water molecules and thus leading to their low activity. FIG. 50H summarizes the adsorption energies of H₂O and Zn²⁺ at different sites. The H₂O adsorption energies were negative across the entire LP surface, indicating stable water adsorption. Furthermore, the water adsorption energies at sites 2, 3, and 6 close to the sodium cation were considerably lower (approximately-0.58 eV) than those at other adsorption sites, implying the significant role of sodium cations in the superior water-binding and hydration swelling capabilities of the LP nanocrystals. In contrast, Zn²⁺ adsorption was found to be stable only at site 1 due to the existence adsorption sites, Zn²⁺ adsorption was unstable because of the electrostatic repulsion between sodium and zinc cations (see FIG. 60). These results indicate that water molecules were effectively confined by LP nanocrystals due to H-bonding interaction and Coulombic attraction, further suppressing water activity in LP-based electrolyte membranes and inhibiting water-induced side reactions at the Zn/electrolyte interface.

Water-Induced Side Reactions at the Zn/Electrolyte Interface. To investigate how water-LP interactions affect water-induced side reactions at the Zn/electrolyte interface, electrochemical tests of the Zn metal electrodes were conducted in different electrolytes. FIG. 61A shows the chronoamperometry (CA) curves of the Zn metal electrodes in different electrolytes. A rapid increase in current density was observed during the initial 120 seconds in the BE, indicating a prolonged 2D diffusion process attributed to the inhomogeneous Zn nucleation and fast dendrite growth [59]. In the LP9 electrolyte membrane, Zn plating was dominated by 3D diffusion, leading to uniform and dense Zn deposition.⁶⁰ Therefore, the current density reached equilibrium in 35 seconds and remains nearly constant throughout the subsequent galvanizing process. To investigate the Zn plating/stripping reversibility, Cu∥Zn half cells were assembled and cycled at a current density of 1 mA/cm². FIG. 62 and FIG. 63 show the Coulombic efficiency and nucleation overpotential of the BE- and LP9-based Cu∥Zn half cells, respectively. The BE-based Cu∥Zn half-cell quickly failed after approximately 60 cycles and possessed a high nucleation overpotential of 41 mV. In comparison, the separator-free LP9-based Cu∥Zn half-cell exhibited an average CE of 99.6% over 150 cycles. Moreover, the nucleation overpotential significantly decreased to 11 mV, which could be attributed to the uniform Zn nucleation/deposition facilitated by the LP9 electrolyte membrane.^{61,62} FIG. 61B and FIG. 64 exhibit the corrosion performance of Zn metal electrodes evaluated by Tafel tests. The corrosion current densities (i_{corr}) of Zn metal electrodes in BE and LP9 electrolyte were 15.86 and 4.96 mA/cm², respectively. Meanwhile, the corrosion potential (E_{corr}) in the LP9 electrolyte increased to −1.01 V. The lower i_{corr} and higher E_{corr} observed in the LP9 electrolyte indicate that Zn corrosion was considerably inhibited compared to that in BE. These results strongly support that water-induced side reactions and dendrite growth at the Zn/electrolyte interface were effectively inhibited in the LP9 electrolyte membrane.

To further investigate the corrosion performance and HER activity, soaking tests were performed by immersing a large piece of Zn foil in BE and LP9 electrolytes. During the entire soaking process, the mass of the sample was monitored by using an analytical balance to calculate the hydrogen generation rates. As shown in FIG. 61C, the hydrogen generation in BE reached a rate of 28.32 μmol/(h·cm²) or 0.68 mL/(h·cm²). Meanwhile, large amounts of ZHS flakes were observed on the Zn surface, resulting from Zn corrosion and byproduct formation. In sharp contrast, no hydrogen evolution was detected in the LP9 electrolyte, and the Zn surface remained nearly the same as that of the pristine Zn foil (see FIG. 65). Even at an elevated temperature of 50° C., the Zn foil embedded in the LP9 electrolyte membrane displayed a flat and nearly byproduct-free surface after 10 days, as evidenced by the SEM images and XRD patterns shown in FIG. 66 and FIG. 67, respectively. In contrast, large ZHS plated covered the Zn foil when the foil was immersed in BE under the same conditions, indicating that water-induced side reactions in BE were accelerated at an elevated temperature. FIG. 61D shows the water self-dissociation energies and the ZHS formation energies calculated by DFT considering whether the water molecules were in a free state or were absorbed by LP nanocrystals. The self-dissociation energy of the water molecules confined by LP increased to 0.35 eV, higher than that (0.23 eV) of the free water molecules, which suggests that the water self-dissociation rate was largely suppressed by LP because of strong water-LP interactions. In addition, the free water molecules were more favorable for ZHS formation with a low reaction energy of −0.77 eV. When the water molecules were absorbed by LP nanocrystals, the associated ZHS formation energy significantly increases to −0.08 eV, implying substantially suppressed ZHS formation kinetics in the LP-based electrolyte membranes. FIGS. 61E-61F further exhibit the water adsorption energies on the Zn metal and LP surfaces, respectively. The water molecules were preferentially absorbed by LP nanocrystals with a lower water adsorption energy of −0.58 eV compared with that (−0.25 eV) for absorption on the Zn metal surface. These results demonstrate that the strong LP-water interactions played a decisive role in lowering the water activities related to self-dissociation and byproduct formation.

For characterizing the hydrogen evolution behavior, the HER overpotential (η) in aqueous electrolytes was calculated by the Nernst equation:⁶³

η=E_{H}_{₂}_{O/H}_{₂}−E_{H}_{₂}_{O/H}_{₂}^{⊖}=2.303RT/F[log₁₀α_{H}_{₂}_{O}+14−pH] (4)

where α denotes the activity, E represents the potential, E^{⊖} refers to the standard potential, R is the gas constant, T is the temperature, and F is the Faraday constant. At a constant temperature and pH, the water activity in the LP-based electrolytes determines the HER behavior. In an ideal aqueous solution, the water activity H₂O is related to the molar fraction x₁ and activity coefficient γ₁ of the water molecules [64]:

ln[(α_{H}_{₂}_{O})^{ideal}]=ln(x₁γ₁) (5)

For an ideal aqueous solution, the activity coefficient of water is unity [64]. Therefore, the water activity was determined solely by its concentration. For instance, in the LP9 electrolyte membrane, the water (45.3 wt %, FIG. 2a) and proton (pH=5.03, see FIG. 55) concentrations were lower than those of the BE, leading to decreased water activity and higher HER overpotential. Moreover, the strong interactions between LP and water further lowered the water activity in LP-based electrolyte membranes, according to the hydrate theory proposed by Scatchard [65,66]. In a nonideal aqueous solution that considers solute-water interactions, water activity is correlated to solute hydration following the given equation 6 [64]:

ln(α_{H}_{₂}_{O};hydration)=−nⱼ/(n_{H}_{₂}_{O}°−hnⱼ) (6)

where H₂O represents the water activity considering solute hydration, nⱼ is the molarity of solute j, n_{H}_{₂}_{O}° denotes the molarity of water under ideal conditions, and h is the hydration number of the solute. In eq 6, hnⱼ quantifies the water content that could be confined by the solute because of solute-water interactions. In LP-based electrolyte membranes, the LP nanocrystals with exceptional water-binding and hydration swelling capabilities can absorb significant amounts of water from the free water phase, attributed to the strong water-LP interactions as revealed by DFT calculations. Although the characterization of the exact hydration number remains rather challenging, the high hydration capability and low water adsorption energies strongly support that LP nanocrystals have a high h, resulting in the low water activity and high HER overpotential (η) of the LP9 electrolyte membrane. Consequently, the HER of Zn metal electrodes in the LP9 electrolyte membrane are significantly suppressed. These analyses highlight the finding that electrolyte additives (e.g., LP) with high hydration capability and low water adsorption energy are the key to designing advanced aqueous electrolytes for next-generation high performance AZIBs.

To investigate the effectiveness of the LP-based electrolyte membranes, Zn∥Zn symmetric cells were assembled and cycled at different current densities and areal capacities. As shown in FIG. 68, the separator-free LP-based Zn∥Zn symmetric cells exhibit prolonged cycle life with increasing LP content at a current density of 1 mA/cm² and an areal capacity of 1 mAh/cm². FIG. 61G further demonstrates that the cycle life of the LP9-based Zn∥Zn symmetric cell could be extended to 1,500 hours at a lower current density of 0.1 mA/cm² and an areal capacity of 0.1 mAh/cm², indicating significantly enhanced Zn plating/stripping reversibility. The failure of the LP9-based Zn∥Zn symmetric cell due to increased polarization was ascribed to the accumulation of slight irreversible reactions (e.g., ZHS formation) at the Zn/electrolyte interface. These side reactions gradually deteriorate the interfacial contact and impair charge transfer kinetics, leading to increased voltage polarization during Zn plating/stripping.⁶⁷ As shown in FIG. 3h-i, considerable mossy, porous Zn deposits with embedded glass fibers originating from the GF separator were evident on the surface of the Zn metal anode after 30 cycles in the BE. The presence of the two diffraction peaks at 12.2° and 24.6° (FIG. 69) indicates the formation of ZHS byproducts, stemming from the side reactions between Zn metal and active water molecules in the BE during long-term cycling. In contrast, the Zn metal anode paired with the LP9 electrolyte membrane exhibited a level and dendrite-free surface after cycling (FIG. 61J-61K). Moreover, only a minor diffraction peak at 12.2° was observed (see FIG. 69), which was ascribed to the reduced water activity in the LP9 electrolyte membrane, confirming the effective inhibition of water-induced side reactions.

The inserted schematics in FIG. 61G illustrate the Zn deposition mechanisms in the BE and LP9 electrolyte membrane. Due to the uneven Zn nucleation and deposition in the BE with a GF separator, considerable amounts of Zn dendrites formed on the surface of Zn metal anodes. Additionally, the protons (H⁺) originating from water self-dissociation reacted with Zn metal and undergo electrochemical reduction, resulting in severe Zn corrosion and HER during Zn plating/stripping.

The consumption of H⁺ increased the local OH⁻ concentration, further promoting the formation of ZHS byproducts at the Zn/electrolyte interface. Consequently, the reversibility of Zn metal anodes was severely deteriorated by water-induced side reactions in the BE. In contrast, the LP9 electrolyte membrane with low water activity diminished interfacial instabilities by inhibiting Zn dendrite growth and water-induced side reactions, including hydrogen evolution, Zn corrosion, and byproduct formation due to the strong water-LP interactions. Therefore, highly reversible Zn metal anodes achieved when integrated with the freestanding LP9 electrolyte membrane.

Electrochemical Performance of the Separator-Free Zn∥NVO Full Cell. To demonstrate the advantages of the LP9 electrolyte membrane for practical applications, full cells were assembled and evaluated under different conditions. Sodium-doped vanadium oxide (NVO) was used as the cathode material, which has been widely reported in prior work [68]. FIG. 70 displays the cycling performance of the LP9-based Zn∥NVO full cells with different electrolyte volumes. The full cell with an electrolyte volume of 100 μL exhibits optimal electrochemical performance, including a high capacity and excellent cyclic stability. In comparison to BE-based batteries, the volumetric energy density of the LP9-based Zn∥NVO full cells was expected to be higher due to the absence of GF separators. Meanwhile, the LP9 electrolyte membrane exhibits a higher density of 1.63 g/cm3 than that (1.31 g/cm3) of the BE, which slightly decreases the gravimetric energy density of the LP9-based batteries. However, such a decrease is compensated for by the removal of GF separators. FIGS. 4a and b present the cyclic voltammetry (CV) and galvanostatic charge/discharge curves of the BE- and LP9-based Zn∥NVO full cells, respectively. Compared with the BE-based batteries, the LP9-based Zn∥NVO full cells exhibit similar redox peaks and charge/discharge voltage profiles, suggesting that no extra redox reactions or parasitic reactions are introduced by LP. FIG. 4c shows the rate capabilities of the BE- and LP9-based Zn∥NVO full cells. At current densities of 0.1, 0.5, 1, 2, and 5 A/g, the LP9-based Zn∥NVO full cell exhibits discharge capacities of 302.0, 232.9, 195.3, 156.7, and 108.4 mAh/g, respectively. When the current density is changed from 5 to 1 A/g, the LP9-based Zn∥NVO full cell maintains a discharge capacity of 192.8 mAh/g, higher than that (170.8 mAh/g) of the BE-based cell. This improvement could be attributed to the enhanced reversibility of the Zn metal anode in the LP9-based cell.

The long-term cyclic stability of the LP9-based full cells was further investigated at different current densities ranging from 0.1 to 3 A/g. As shown in FIG. 71, the LP9-based Zn∥NVO full cell retains 70.65% of its initial capacity after 200 cycles at 0.1 A/g, much higher than that (22.11%) of the BE-based full cell. FIG. 72D displays the cyclic stability of BE- and LP9-based Zn∥NVO full cells at a current density of 1 A/g. In sharp contrast to the BE-based full cell with fast capacity degradation, the LP9-based full cell exhibits substantially enhanced cyclic stability with a high-capacity retention rate of 94.10% after 2,000 cycles. FIG. 72E shows the cyclic stability of BE- and LP9-based Zn∥NVO full cells at a higher current density of 3 A/g. Notably, the LP9-based full cell exhibits a high-capacity retention rate of 86.32% after 10,000 cycles. In contrast, the capacity of the BE-based Zn∥NVO full cell drops dramatically to nearly zero after approximately 5,000 cycles. These results strongly support the effectiveness of the LP9 electrolyte membrane and the exceptional long-term cyclic stability of the separator-free LP9-based batteries at low and high current densities. Moreover, the separator-free LP9-based Zn∥NVO full cells exhibit stable and high average CEs (˜100%) over long-term cycling. The substantially enhanced cyclic stability of the LP9-based Zn∥NVO full cells strongly supports that the mechanically robust electrolyte membrane with low water activity can effectively suppress water-induced side reactions, thereby enhancing the cyclic stability of Zn∥NVO full cells. The separator-free LP9-based Zn∥NVO batteries demonstrate superior electrochemical performance in comparison to state-of-the-art AZIBs based on other electrolyte systems with different additives.

To understand the enhanced cyclic stability of the LP9-based Zn∥NVO full cells, the surface morphology of the cycled Zn metal anodes in the full cells was characterized by SEM. As shown in FIGS. 752F-72G, numerous small-sized Zn dendrites and flake-like byproducts were observed on the surface of the Zn metal anode after 1,000 cycles at a current density of 3 A/g in the BE with a GF separator because of inhomogeneous Zn deposition and severe water-induced side reactions. The fibers from the GF separator were embedded by Zn dendrites, ultimately penetrating the GF separator and causing battery failures. In contrast, FIGS. 72H-72I shows that the Zn metal anode paired with the LP9 electrolyte membrane was free of dendrites after cycling, attributed to the excellent mechanical stiffness of the electrolyte membrane and the uniform Zn deposition during long-term cycling. As presented in FIG. 72J, the XRD patterns of the cycled Zn metal anodes revealed that ZHS formation is significantly restricted in the LP9 electrolyte membrane, confirming the effective suppression of water-induced side reactions during long-term cycling.

Durability of the Separator-Free Zn∥NVO Full Cells. To further investigate the practicality of the LP9 electrolyte membrane, self-discharge tests of the Zn∥NVO full cells were conducted by monitoring their open circuit voltage (OCV) during resting. FIGS. 74A-74F present the voltage profiles of the BE- and LP9-based Zn∥NVO full cells. All the cells were charged to 1.4 V and rested for up to 60 days before being fully discharged to 0.4 V. FIG. 73A summarizes the OCV of the Zn∥NVO full cells before discharge. The BE-based Zn∥NVO full cells exhibited rapid voltage decay during resting and experience significant voltage fluctuations after approximately 15 days (FIGS. 74A-74F), suggesting a fast discharge rate and short shelf life of the BE-based batteries, which was attributed to severe Zn corrosion and HER during long-term resting. For the separator-free LP9-based Zn∥NVO full cells, the voltage primarily dropped within the first 5 hours (FIGS. 74A-74F). When the resting time was extended from 2 to 60 days, the OCV only dropped slightly from 1.2 to 1.1 V, corresponding to a record-low voltage decay rate of 1.7 mV/day or 0.07 mV/h. This value was substantially lower than those of previously reported aqueous batteries [69,70], as summarized in FIG. 73A. FIG. 73B shows the capacity retention rates of the Zn∥NVO full cells during the self-discharge tests. After a 2-day resting, the separator-free LP9-based full cell exhibited a capacity retention rate of 95.85%, higher than that (70.89%) of the BE-based full cell. Notably, the LP9-based Zn∥NVO full cells retained 61.73% and 41.93% of their charge capacities after resting for 30 and 60 days, respectively. These results indicate that the self-discharge rate of the LP9-based Zn∥NVO full cells were effectively decreased due to the inhibition of water-induced side reactions.

To investigate the influence of resting time on the long-term cyclic stability of the separator-free LP9-based Zn∥NVO full cells, galvanostatic charge/discharge tests were performed. FIG. 73C shows the cyclic stability of the aged BE- and LP9-based Zn∥NVO full cells at a current density of 1 A/g. After a 10-day resting, the BE-based Zn∥NVO full cell exhibited an initial capacity of 78.7 mAh/g, significantly lower than that (201.6 mAh/g, FIG. 4d) of the fresh BE-based full cell due to the severe Zn corrosion and byproduct formation during resting. In contrast, the aged LP9-based full cell provided an initial capacity of 113.9 mAh/g, and the capacity gradually increases to 139.2 mAh/g after approximately 300 cycles due to electrochemical activation [29]. During the subsequent cycling processes, the capacity slightly decreased to 128.5 mAh/g after 2,000 cycles, which can be attributed to the slight byproduct formation and possible structural degradation of the cathode materials [78]. FIG. 73D further demonstrates that the LP9-based Zn∥NVO full cells maintained excellent cyclic stability even after resting for up to 60 days, signifying the long shelf life of the separator-free AZIBs due to the low water activity in the LP9 electrolyte membrane.

The durability of the separator-free LP9-based Zn∥NVO full cells was further investigated at an elevated temperature of 50° C. As shown in FIG. 5e, the BE-based Zn∥NVO full cell failed rapidly after 125 cycles at a current density of 1 A/g, which was attributed to accelerated dendrite growth and water-induced side reactions. Under the same conditions, the LP9-based Zn∥NVO full cell exhibited a high initial capacity of 226.5 mAh/g and retained 68.65% of its initial capacity after 350 cycles with a high average CE of 99.87% (FIG. 75). In addition, the shelf life of the LP9-based Zn∥NVO full cells under elevated temperatures was investigated by resting the fresh cells at 50° C. for up to 10 days and then testing them at room temperature. FIG. 76 shows that the BE-based full cell failed after resting for 1 day because of the greatly accelerated water-induced side reactions at elevated temperatures. In contrast, as shown in FIG. 5f, the LP9-based full cells exhibited outstanding cyclic stability with a high average CE of 99.93% (FIG. 77) after being stored at 50° C. for 10 days. These results reveal the extraordinary cyclic stability and durability of the separator-free LP9-based Zn∥NVO full cells because of the low water activity and effectively suppressed water-induced side reactions.

Preparation of Electrolytes. The electrolyte membranes were prepared by mixing specific amounts (6-9 g) of laponite (LP) with 10 mL of baseline electrolyte (BE, 2MZnSO4 in water). Then, the mixtures were thoroughly stirred at room temperature to form uniform pastes. The as-obtained pastes were further aged for 24 hours at room temperature to allow the full hydration and swelling of LP in the electrolyte environments. The resulting electrolyte membranes were denoted as LPx, where x represents the mass of LP per 10 mL of BE. For instance, the electrolyte membranes with 6 and 9 g of LP in 10 mL of BE were denoted as LP6 and LP9, respectively.

Material Characterization. Scanning electron microscopy (SEM) was conducted on a scanning electron microscope (Sigma 500 VP, Zeiss). The Brunauer-Emmett-Teller (BET) surface area of the materials was determined by a surface area analyzer (Micromeritics ASAP 2020 Plus) via N₂ adsorption-desorption isotherms at 77 K. The material structures were analyzed by X-ray diffraction (XRD, Rigaku Ultima IV diffractometer), X-ray photoelectron spectroscopy (XPS, Versa Probe II), Fourier transform infrared spectroscopy (FTIR, Agilent 660), and Raman spectroscopy (NRS-5100, Jasco). The thermal properties were measured by thermogravimetric analysis (TGA, SDT Q600, TA Instruments) at a heating rate of 10° C./min. The rheological properties of the BE and LP-based electrolyte membranes were measured by a rotational rheometer (Discovery HR-2, TA Instruments) using a stainless-steel Peltier plate (8 mm). The ionic conductivities of the BE and LP-based electrolytes were measured by a conductivity meter (EC600, EXTECH).

Cell Assembly. Standard CR2032 coin cells were used for assembling cells. Zn discs with a thickness of 0.1 mm and a diameter of 14 mm were used as anodes. A glass fiber membrane (GF/A, Whatman) with a diameter of 16 mm was used as separator. The cathode material, sodium-doped vanadium oxide (NVO), was prepared following the procedures described in prior work [68]. Briefly, 3.638 g of V₂O₅ and 0.8 g of NaOH were added into 80 mL of ultrapure water under magnetic stirring for 4 hours. After that, the solution was transferred to a 200 mL autoclave and kept at 180° C. for 48 hours. The solid products after hydrothermal treatment were collected and centrifuged with ultrapure water at 5,000 rpm for 15 minutes, and this was repeated 5 times. The sediments after centrifuge were freeze-dried for 48 hours followed by vacuum drying at 80° C. for 12 hours to obtain the final active materials. The active material (NVO), carbon black, and binder (PVDF) were mixed in a weight ratio of 7:2:1 and ground with NMP to form a slurry. Then, the slurry was uniformly coated on carbon paper (10×10 cm²) and dried under vacuum at 80° C. overnight. The mass loading of NVO was 1.5-2 mg/cm². Finally, NVO electrodes were obtained by punching the NVO-coated carbon paper into Φ14 mm discs and were used as the cathode for assembling full cells. For BE, 100 μL of liquid electrolytes was used to assemble symmetric and full cells. For the LP-based electrolyte membrane (LP6-LP9), 100 μL of the electrolyte was mechanically compressed into a membrane with a diameter of 16 mm to assemble cells. GF separators were not used for all the LP-based cells.

Electrochemical Measurements. All of the cells were rested for 2 hours before electrochemical tests. The cyclic voltammetry (CV, 0.4-1.4 V), linear sweep voltammetry (LSV), Tafel, chronoamperometry (CA), and electrochemical impedance spectroscopy (EIS, 0.01 Hz to 100 kHz) tests were conducted on an electrochemical workstation (Interface 1010E, Gamry). Among them, Tafel and LSV tests were performed in a three-electrode configuration, in which Pt, Pt, and Ag/AgCl were used as the working, counter, and reference electrodes, respectively. Tafel tests were performed with a voltage window between −300 and 300 mV vs the open circuit potential at a scan rate of 1 mV/s. LSV measurements were carried out at a sweep rate of 5 mV/s from −0.8 to −1.4 V and from 1.2 to 2.0 V to characterize hydrogen and oxygen evolution reactions, respectively. CA tests were performed with an overpotential of −150 mV in a three-electrode configuration, in which Pt, Pt, and Ag/AgCl were used as the working, counter, and reference electrodes, respectively. Galvanostatic charge/discharge tests were performed on a multichannel battery testing system (NEWARE). The Zn²⁺ transference number of the LP9 electrolyte membrane was measured by combining alternating-current (AC) impedance and direct-current (DC) potentio-static polarization tests using Zn∥Zn symmetric cells. Typically, the electrochemical impedance of the LP9-based Zn∥Zn symmetric cell at the initial state was recorded after resting for 2 hours. Then, the cell was polarized under a DC potential of 10 mV for 2,000 seconds and the response current was recorded. The electrochemical impedance of the symmetric cell was measured immediately after the DC polarization to obtain the steady-state interfacial impedance. The Zn²⁺ transference number (t_{Zn}_{²⁺}) was calculated according to equation 7:

$${t}_{{Zn}^{2 +}} = \frac{ΔV / ( {I}_{0} - {R}_{0} )}{ΔV / ( {I}_{ss} - {R}_{ss} )} \qquad ( 7 )$$

where ΔV is the applied DC potential. I₀ and Iₛₛ are the initial and steady-state response currents under 10 mV of DC polarization, respectively. The interfacial impedance values at the initial state (R₀) and steady state (Rₛₛ) are the intersect values of the Zᵣₑₐₗ axis in the Nyquist plots.

Computational Modeling. The atomic structures of LP were examined using the density functional theory method. 79 The calculations were performed in the Vienna Ab Initio Simulation Package (VASP) implementing the spin-polarized generalized gradient approximation parametrized using the Perdew-Burke-Ernzerhof (PBE) exchange correlation functional [80]. The cut-off energy for the plane wave basis set was 500 cV and a Monkhorst-Pack grid 2×2×1 k-point was used to model the surface of LP, which was organized from the (001) plane of bulk phyllosilicate, Na⁺_{0.7} [Mg_{5.5}Li_{0.3}Si₈O₂₀(OH)₄]^{-0.7}, according to prior work [40]. All the structures were fully relaxed and equilibrated before calculations using the conjugate gradient algorithm by including van der Waals interactions [81].

Calculation of the Volume Expansion Ratio of Swelled LP, the Amount of Interlayer Water, and the Salt Concentrations in the LP-Based Electrolyte Membranes. The volume expansion ratio of the swelled LP was calculated by equation 8 [82]:

$$\begin{matrix}ER = ( {d}_{001 , swelled} - {d}_{001 , init} ) / {d}_{001 , init} \times 100 \% \\ = \frac{22.8 - 12.5}{12.5} \times 100 \% = 82.4 \%\end{matrix} \qquad ( 8 )$$

where d_{001,swelled} is the basal spacing of LP in the swelled state and d_{001,init} is the initial basal spacing of the LP powder. Therefore, the ratio of the water (RoW) existing within the interlayer spacing can be estimated by equation 9:

$$RoW = \frac{\frac{{m}_{LP}}{{ρ}_{LP}} \times ER}{{V}_{BE}} = \frac{\frac{9}{2.53} \times 84 \%}{10} = 29.8 \% \qquad ( 9 )$$

where m_{LP} and ρ_{LP} are the mass and density of the LP powder, respectively. V_{BE} is the volume of BE (10 mL in this case). Note that a density of 2.53 g/cm³ for LP was used in the calculation according to prior work [41].

The salt (ZnSO₄) concentrations in the LP-based electrolyte membranes were calculated by equation 10:

$${c}_{LP} = ( {c}_{BE} \times {V}_{BE} ) / ( {V}_{BE} + {V}_{LP} ) \qquad ( 10 )$$

where c_{LP} and c_{BE} represent the salt concentration in the LP-based electrolyte membranes and the BE, respectively. V_{LP} is the volume of LP, which can be calculated based on its mass and density.

Quantification of Hydrogen Evolutions during the Soaking Test. A large piece of Zn foil (10×8.7 cm²) was placed in a Petri dish containing 100 mL of BE or LP9 electrolyte. Then the entire Petri dish was tightly sealed with layers of plastic wrap and parafilm to prevent the escape of moisture while allowing the permeation of generated hydrogen gas. The mass of the sealed Petri dish was monitored by an analytic balance with an accuracy of 0.01 mg. The decreased mass of the entire Petri dish represents the mass of the generated hydrogen during the soaking test.

Discussion In the past few decades, tremendous efforts have been devoted to utilizing renewable energy resources such as wind and sunlight to address the worldwide energy crisis and global warming [1]. However, managing the intermittent power generated from these renewable energy devices remains challenging due to the lack of high-performance, low-cost, and high-safety grid-scale energy storage systems [2]. Recently, aqueous zinc-ion batteries (AZIBs) have emerged as promising candidates for grid-scale energy storage applications due to their distinct advantages, including low-cost, eco-friendliness, high material abundance, high theoretical capacity, and low safety risks [3,4]. Despite the recent progress in enhancing the electrochemical performance of AZIBs, their practical applications are still impeded by the poor cyclic stability and unsatisfactory durability arising from water-induced side reactions at the Zn/electrolyte interface. These undesirable side reactions, including hydrogen evolution, zinc corrosion, byproduct formation, and dendrite growth, severely impair the stability of the Zn/electrolyte interface, resulting in poor cyclic stability and unsatisfactory durability of AZIBs during long-term cycling or storage [5,6]. In AZIBs, water plays a critical role in determining the physicochemical properties of electrolytes, electrode/electrolyte interfacial chemistries, and ultimately the electrochemical performance of batteries [7]. The main bottleneck of aqueous electrolytes is the narrow electrochemical stability window (ESW) of water, which is 1.23 V as determined by its thermodynamic oxidation (oxygen evolution reaction—OER) and reduction (hydrogen evolution reaction—HER) potentials [8]. In mild acidic electrolytes, such as zinc sulfate solutions, water molecules exhibit high activity due to the excess free water content and the self-dissociation (H₂O↔H⁺+OH⁻) of free water molecules [9]. Therefore, spontaneous Zn corrosion and HER could easily occur at the Zn/electrolyte interface following the given reactions [10,11]:

$$\begin{matrix}Zn + 2 {H}^{+} \to {Zn}^{2 +} + {H}_{2 ↑} & Zn corrosion \\ 2 {H}^{+} + 2 {e}^{-} \to {H}_{2 ↑} & HER\end{matrix}$$

Notably, Zn corrosion and HER lead to irreversible electrolyte consumption, continuous water decomposition, uneven and porous Zn deposition, fast dendrite growth, and increased pH at the Zn/electrolyte interface. The localized high-pH environment further facilitates the formation of byproducts, zinc hydroxide sulfate hydrate (ZHS), through the reaction [12,13]:

$$4 {Zn}^{2 +} + 6 {OH}^{-} + {SO}_{4}^{2 -} + x {H}_{2} O \to {{Zn}_{4} ( OH )}_{6} {SO}_{4} \cdot x {H}_{2} O \qquad ZHS formation$$

Different from the protective solid-electrolyte interphase (SEI) in lithium-ion batteries, the formation of ZHS cannot eliminate the occurrence of water-induced side reactions at the Zn/electrolyte interface, deteriorating the cyclic stability of AZIBs [14]. In addition, the ion- and electron-insulating ZHS passivates the active surface of Zn metal, leading to increased internal resistance and uneven Zn plating/stripping [13]. Therefore, understanding and regulating water activity to protect Zn metal anodes against water-induced side reactions are crucial for designing advanced aqueous electrolytes for highly stable AZIBs.

To date, extensive efforts have been made to regulate water activity and suppress water-induced side reactions at the Zn/electrolyte interface. Effective strategies that can enhance the cyclic stability of AZIBs include anode modification [15,16,17], separator functionalization [18], and electrolyte engineering [19,20]. From the perspective of water molecules, they exist in the bulk electrolyte phase or at the electrode/electrolyte interfaces. Moreover, regulating the water activity in aqueous electrolytes through additives has shown great potential to enhance the cyclic stability of AZIBs [7,21]. Electrolyte additives, including organic molecules [22,23,24], inorganic salts [25,26,27], metal oxide particles [28,29,30], and carbon materials [31], have been added to the baseline electrolytes (e.g., 1-3 M ZnSO₄). However, the water activity and how it is affected by the additive-water interactions in these engineered electrolyte systems have not been thoroughly understood. Moreover, a high-cost glass fiber (GF) separator is frequently required for these electrolytes to ensure the operation of batteries, further mitigating the cost competitiveness of AZIBs and posing significant challenges for their large-scale implementation. Therefore, exploring more efficient electrolyte systems and understanding the ambiguous relationship between additive-water interactions and water activity are important to advance the development of AZIBs.

Conclusions. In conclusion, a mechanically robust electrolyte membrane based on LP nano-clay is designed for ultra-stable and reliable separator-free AZIBs. The outstanding water binding and adsorption capabilities of the LP nanocrystals enabled by the strong water-LP interactions play a crucial role in suppressing water activity. A combination of experimental results and DFT calculations reveals that the water molecules absorbed by LP nanocrystals are less active in water-induced side reactions, including self-dissociation, byproduct formation, Zn corrosion, and HER. In addition, the LP9 electrolyte membrane eliminates Zn dendrite growth because of its high mechanical resistance and the uniform Zn nucleation/deposition. Consequently, the separator-free LP9-based Zn∥NVO full cells exhibit significantly enhanced cyclic stability with a high-capacity retention rate of 94.10% after 2,000 cycles at 1 A/g. At a higher current density of 3 A/g, the LP9-based full cell retains 86.32% of its initial capacity after 10,000 cycles. Furthermore, the separator-free batteries exhibit significantly enhanced durability during long-term storage and improved cyclic stability at an elevated temperature. Because of the low cost and excellent processability, the separator-free LP9-based AZIBs with exceptional safety and reliability exhibit great potential as candidates for large-scale stationary energy storage applications.

Additional example can be found in Siyu Tian, et. al., “Suppressing Dendrite Growth and Side Reactions via Mechanically Robust Laponite-Based Electrolyte Membranes for Ultra-stable Aqueous Zinc-Ion Batteries,” ACS Nano 2023 17 (15), 14930-1494 and supporting information, which is incorporated herein in its entirety.

### EXEMPLARY EMBODIMENTS

Exemplary Aspect 1. An electrolyte system for an aqueous battery comprising a bentonite material which is intercalated with one or more ions selected from lithium ions, calcium ions, potassium ions, magnesium ions, sodium ions, ammonium ions, hydrogen ions, lanthanum ions, indium ions and a combination thereof.

Exemplary Aspect 2. An electrolyte system for an aqueous battery comprising a laponite material which is intercalated with one or more ions selected from lithium ions, calcium ions, potassium ions, magnesium ions, sodium ions, ammonium ions, hydrogen ions, lanthanum ions, indium ions and a combination thereof.

Exemplary Aspect 3. A battery cell comprising the electrolyte system of exemplary aspect 1 or of exemplary aspect 2, and a zinc-based anode.

Exemplary Aspect 4. The battery cell of exemplary aspect 3 further comprising a cathode wherein vanadium oxide-based or manganese oxide-based materials are used as active materials of the cathode.

### REFERENCES

### Example 1

1. M Armand and J-M Tarascon, Building better batteries. Nature, 2008. 451 (7179): p. 652-657.
2. H Kim, J Hong, K-Y Park, H Kim, S-W Kim, and K Kang, Aqueous rechargeable Li and Na ion batteries. Chemical Reviews, 2014. 114 (23): p. 11788-11827.
3. C Dong, F Xu, L Chen, Z Chen, and Y Cao, Design Strategies for High-Voltage Aqueous Batteries. Small Structures, 2021. 2 (7): p. 2100001.
4. B Dunn, H Kamath, and J-M Tarascon, Electrical energy storage for the grid: a battery of choices. Science, 2011. 334 (6058): p. 928-935.
5. Z Yang, J Zhang, MC Kintner-Meyer, X Lu, D Choi, J P Lemmon, and J Liu, Electrochemical energy storage for green grid. Chemical Reviews, 2011. 111 (5): p. 3577-3613.
6. D Chao, W Zhou, F Xie, C Ye, H Li, M Jaroniec, and S-Z Qiao, Roadmap for advanced aqueous batteries: From design of materials to applications. Science advances, 2020. 6 (21): p. eaba4098.
7. N Guo, W Huo, X Dong, Z Sun, Y Lu, X Wu, L Dai, L Wang, H Lin, and H Liu, A review on 3D zinc anodes for zinc ion batteries. Small Methods, 2022. 6 (9): p. 2200597.
8. C Xie, Y Li, Q Wang, D Sun, Y Tang, and H Wang, Issues and solutions toward zinc anode in aqueous zinc-ion batteries: A mini review. Carbon Energy, 2020. 2 (4): p. 540-560.
9. V Verma, S Kumar, W Manalastas Jr, and M Srinivasan, Undesired reactions in aqueous rechargeable zinc ion batteries. ACS Energy Letters, 2021. 6 (5): p. 1773-1785.
10. B Tang, L Shan, S Liang, and J Zhou, Issues and opportunities facing aqueous zinc-ion batteries. Energy & Environmental Science, 2019. 12 (11): p. 3288-3304.
11. W Yang, Y Yang, H Yang, and H Zhou, Regulating water activity for rechargeable zinc-ion batteries: Progress and perspective. ACS Energy Letters, 2022. 7 (8): p. 2515-2530.
12. J Cao, D Zhang, Y Yue, R Chanajaree, S Wang, J Han, X Zhang, J Qin, and Y Huang, Regulating solvation structure to stabilize zinc anode by fastening the free water molecules with an inorganic colloidal electrolyte. Nano Energy, 2022. 93: p. 106839.
13. C Li, X Xie, H Liu, P Wang, C Deng, B Lu, J Zhou, and S Liang, Integrated ‘all-in-one’ strategy to stabilize zinc anodes for high-performance zinc-ion batteries. National Science Review, 2022. 9 (3): p. nwab177.
14. J Gao, X Xie, S Liang, B Lu, and J Zhou, Inorganic colloidal electrolyte for highly robust zinc-ion batteries. Nano-Micro Letters, 2021. 13: p. 1-12.
15. J Zhou, L Zhang, M Peng, X Zhou, Y Cao, J Liu, X Shen, C Yan, and T Qian, Diminishing interfacial turbulence by colloid-polymer electrolyte to stabilize zinc ion flux for deep-cycling Zn metal batteries. Advanced Materials, 2022. 34 (21): p. 2200131.
16. R Shivkumar, G P Kalaignan, and T Vasudevan, Effect of additives on zinc electrodes in alkaline battery systems. Journal of power sources, 1995. 55 (1): p. 53-62.
17. H-I Kim and H-C Shin, SnO additive for dendritic growth suppression of electrolytic zinc. Journal of Alloys and Compounds, 2015. 645: p. 7-10.
18. P P Prabhu and B Prabhu. A review on removal of heavy metal ions from waste water using natural/modified bentonite. in MATEC Web of conferences. 2018. EDP Sciences.
19. M Wieczorek, A Krysztafkiewicz, and T Jesionowski, Influence of modification by N-2-(aminoethyl)-3-aminopropyltrimethoxysilane on physicochemical properties of bentonite. Journal of Physics and Chemistry of Solids, 2004. 65 (2-3): p. 447-452.
20. B Makhoukhi, M A Didi, and D Villemin, Modification of bentonite with diphosphonium salts: Synthesis and characterization. Materials Letters, 2008. 62 (16): p. 2493-2496.
21. S Tian, L Zhou, W He, Y Tian, Y Zhou, S Wu, R Jian, K J Balkus, T Luo, and G Xiong, A self-assembled nanoporous polyelectrolytic interlayer for highly stable zinc metal anodes. Chemical Engineering Journal, 2023. 462: p. 142276.

### Example 2

1. Chao, D., et al., Roadmap for advanced aqueous batteries: From design of materials to applications. Science Advances. 6 (21): p. eaba4098.
2. Guo, N., et al., A Review on 3D Zinc Anodes for Zinc Ion Batteries. Small Methods, 2022. 6 (9): p. 2200597.
3. Du, W., et al., Challenges in the material and structural design of zinc anode towards high-performance aqueous zinc-ion batteries. Energy & Environmental Science, 2020. 13 (10): p. 3330-3360.
4. Guo, W., et al., Dendrite-free Zn anode with dual channel 3D porous frameworks for rechargeable Zn batteries. Energy Storage Materials, 2020. 30: p. 104-112.
5. Chen, Z., et al., Grafted MXene/polymer electrolyte for high performance solid zinc batteries with enhanced shelf life at low/high temperatures. Energy & Environmental Science, 2021. 14 (6): p. 3492-3501.
6. Xie, C., et al., Issues and solutions toward zinc anode in aqueous zinc-ion batteries: A mini review. Carbon Energy, 2020. 2 (4): p. 540-560.
7. Hong, L., et al., Toward Hydrogen-Free and Dendrite-Free Aqueous Zinc Batteries: Formation of Zincophilic Protective Layer on Zn Anodes. Advanced Science, 2022. 9 (6): p. 2104866.
8. Deng, C., et al., A Sieve-Functional and Uniform-Porous Kaolin Layer toward Stable Zinc Metal Anode. Advanced Functional Materials, 2020. 30 (21): p. 2000599.
9. Liu, X., et al., Zeolitic Imidazolate Frameworks as Zn2+ Modulation Layers to Enable Dendrite-Free Zn Anodes. Advanced Science, 2020. 7 (21): p. 2002173.
10. Chen, Z., et al., Texture Control of Commercial Zn Foils Prolongs Their Reversibility as Aqueous Battery Anodes. ACS Energy Letters, 2022. 7 (10): p. 3564-3571.
11. Pu, S. D., et al., Achieving Ultrahigh-Rate Planar and Dendrite-Free Zinc Electroplating for Aqueous Zinc Battery Anodes. Advanced Materials, 2022. 34 (28): p. 2202552.
12. Yi, Z., et al., An Ultrahigh Rate and Stable Zinc Anode by Facet-Matching-Induced Dendrite Regulation. Advanced Materials, 2022. 34 (37): p. 2203835.
13. Yang, Y., et al., Regulating Dendrite-Free Zn Deposition by a Self-Assembled OH− Terminated SiO₂ Nanosphere Layer toward a Zn Metal Anode. ACS Applied Materials & Interfaces, 2022. 14 (33): p. 37759-37770.
14. Guo, Y., et al., An ion redistributor enabled by cost-effective weighing paper interlayer for dendrite free aqueous zinc-ion battery. Energy Storage Materials, 2022. 50: p. 580-588.
15. Cao, J., et al., Manipulating Crystallographic Orientation of Zinc Deposition for Dendrite-free Zinc Ion Batteries. Advanced Energy Materials, 2021. 11 (29): p. 2101299.
16. Meng, R., et al., Tuning Zn-Ion Solvation Chemistry with Chelating Ligands toward Stable Aqueous Zn Anodes. Advanced Materials, 2022. 34 (37): p. 2200677.
17. Lv, Y., et al., Engineering a self-adaptive electric double layer on both electrodes for high-performance zinc metal batteries. Energy & Environmental Science, 2022. 15 (11): p. 4748-4760.
18. Qin, H., et al., Building Metal-Molecule Interface towards Stable and Reversible Zn Metal Anodes for Aqueous Rechargeable Zinc Batteries. Advanced Functional Materials, 2022. 32 (47): p. 2206695.
19. Meng, Y. S., V. Srinivasan, and K. Xu, Designing better electrolytes. Science. 378 (6624): p. eabq3750.
20. Hesse, H. C., et al. Lithium-Ion Battery Storage for the Grid—A Review of Stationary Battery Storage System Design Tailored for Applications in Modern Power Grids. Energies, 2017. 10, DOI: 10.3390/en10122107.
21. Zampardi, G. and F. La Mantia, Open challenges and good experimental practices in the research field of aqueous Zn-ion batteries. Nature Communications, 2022. 13 (1): p. 687.
22. Blanc, L. E., D. Kundu, and L. F. Nazar, Scientific Challenges for the Implementation of Zn-Ion Batteries. Joule, 2020. 4 (4): p. 771-799.
23. Li, C., et al., Toward practical aqueous zinc-ion batteries for electrochemical energy storage. Joule, 2022. 6 (8): p. 1733-1738.
24. Luckham, P. F. and S. Rossi, The colloidal and rheological properties of bentonite suspensions. Advances in Colloid and Interface Science, 1999. 82 (1): p. 43-92.
25. Hendricks, S. B. and M. E. Jefferson, Structures of Kaolin and Talc-Pyrophyllite Hydrates and Their Bearing on Water Sorption of the Clays. American Mineralogist, 1938. 23 (12): p. 863-875.
26. Garside, M. Production volume of bentonite worldwide in 2020, by country. 2022; Available from: statista.com/statistics/1312558/bentonite-production-volume-worldwide-by-country/.
27. Garside, M. Average bentonite price in the United States from 2010 to 2021. 2022; Available from: statista.com/statistics/248186/average-bentonite-price/.
28. Choo, K. Y. and K. Bai, Effects of bentonite concentration and solution pH on the rheological properties and long-term stabilities of bentonite suspensions. Applied Clay Science, 2015. 108: p. 182-190.
29. Wu, M., et al., A sustainable chitosan-zinc electrolyte for high-rate zinc-metal batteries. Matter, 2022. 5 (10): p. 3402-3416.
30. Verma, V., et al., Undesired Reactions in Aqueous Rechargeable Zinc Ion Batteries. ACS Energy Letters, 2021. 6 (5): p. 1773-1785.
31. Zhang, T., et al., Fundamentals and perspectives in developing zinc-ion battery electrolytes: a comprehensive review. Energy & Environmental Science, 2020. 13 (12): p. 4625-4665.
32. A. Salah, B., M. S. Gaber, and A. H. T. Kandil The Removal of Uranium and Thorium from Their Aqueous Solutions by 8-Hydroxyquinoline Immobilized Bentonite. Minerals, 2019. 9, DOI: 10.3390/min9100626.
33. Komine, H., Theoretical Equations on Hydraulic Conductivities of Bentonite-Based Buffer and Backfill for Underground Disposal of Radioactive Wastes. Journal of Geotechnical and Geoenvironmental Engineering, 2008. 134 (4): p. 497-508.
34. Suzuki, S., et al., In situ observations of the swelling of bentonite aggregates in NaCl solution. Applied Clay Science, 2005. 29 (2): p. 89-98.
35. Anderson, D. M. and P. F. Low, Density of Water adsorbed on Wyoming Bentonite. Nature, 1957. 180 (4596): p. 1194-1194.
36. Kraehenbuehl, F., et al., Study of the water-bentonite system by vapour adsorption, immersion calorimetry and X-ray techniques: I. Micropore volumes and internal surface areas, following Dubinin's theory. Clay Minerals, 1987. 22 (1): p. 1-9.
37. Montes-H, G., et al., Influence of interlayer cations on the water sorption and swelling-shrinkage of MX80 bentonite. Applied Clay Science, 2003. 23 (5): p. 309-321.
38. Wang, D., et al., A Nanofibrillated Cellulose/Polyacrylamide Electrolyte-Based Flexible and Sewable High-Performance Zn—MnO2 Battery with Superior Shear Resistance. Small, 2018. 14 (51): p. 1803978.
39. Huang, S., et al., Antifreezing Hydrogel Electrolyte with Ternary Hydrogen Bonding for High-Performance Zinc-Ion Batteries. Advanced Materials, 2022. 34 (14): p. 2110140.
40. Dong, H., et al., Investigation of a Biomass Hydrogel Electrolyte Naturally Stabilizing Cathodes for Zinc-Ion Batteries. ACS Applied Materials & Interfaces, 2021. 13 (1): p. 745-754.
41. Pomerantseva, E. and Y. Gogotsi, Two-dimensional heterostructures for energy storage. Nature Energy, 2017. 2 (7): p. 17089.
42. Kaufhold, S., et al., The pH of aqueous bentonite suspensions. Clays and Clay Minerals, 2008. 56 (3): p. 338-343.
43. Kumararaja, P., et al., Chitosan-g-poly (acrylic acid)-bentonite composite: a potential immobilizing agent of heavy metals in soil. Cellulose, 2018. 25 (7): p. 3985-3999.
44. Han, D., et al., A Self-Regulated Interface toward Highly Reversible Aqueous Zinc Batteries. Advanced Energy Materials, 2022. 12 (9): p. 2102982.
45. Wang, M., et al., Biomimetic Solid-State Zn2+ Electrolyte for Corrugated Structural Batteries. ACS Nano, 2019. 13 (2): p. 1107-1115.
46. Liu, C., et al., Electrolyte Strategies toward Better Zinc-Ion Batteries. ACS Energy Letters, 2021. 6 (3): p. 1015-1033.
47. van Olphen, H., Forces Between Suspended Bentonite Particles. Clays and Clay Minerals, 1955. 4 (1): p. 204-224.
48. Lv, Y., et al., Recent Advances in Electrolytes for “Beyond Aqueous” Zinc-Ion Batteries. Advanced Materials, 2022. 34 (4): p. 2106409.
49. Wu, K., et al., Recent Advances in Polymer Electrolytes for Zinc Ion Batteries: Mechanisms, Properties, and Perspectives. Advanced Energy Materials, 2020. 10 (12): p. 1903977.
50. Mizuno, K., et al., NMR and FT-IR Studies of Hydrogen Bonds in Ethanol-Water Mixtures. The Journal of Physical Chemistry, 1995. 99 (10): p. 3225-3228.
51. Chua, R., et al., Hydrogen-Bonding Interactions in Hybrid Aqueous/Nonaqueous Electrolytes Enable Low-Cost and Long-Lifespan Sodium-Ion Storage. ACS Applied Materials & Interfaces, 2020. 12 (20): p. 22862-22872.
52. Jørgensen, P., Infrared study of water adsorbed on Wyoming bentonite. Geologiska Föreningen i Stockholm Förhandlingar, 1968. 90 (2): p. 213-220.
53. Zhu, J., et al., A Molecular-Sieve Electrolyte Membrane enables Separator-Free Zinc Batteries with Ultralong Cycle Life. Advanced Materials, 2022. 34 (43): p. 2207209.
54. Zhang, Q., et al., Modulating electrolyte structure for ultralow temperature aqueous zinc batteries. Nature Communications, 2020. 11 (1): p. 4463.
55. Ben Mabrouk, K., et al., Raman study of cation effect on sulfate vibration modes in solid state and in aqueous solutions. Journal of Raman Spectroscopy, 2013. 44 (11): p. 1603-1608.
56. Huang, C., et al., Stabilizing Zinc Anodes by Regulating the Electrical Double Layer with Saccharin Anions. Advanced Materials, 2021. 33 (38): p. 2100445.
57. Zhao, Z., et al., Long-life and deeply rechargeable aqueous Zn anodes enabled by a multifunctional brightener-inspired interphase. Energy & Environmental Science, 2019. 12 (6): p. 1938-1949.
58. Zhou, S., et al., Anti-Corrosive and Zn-Ion-Regulating Composite Interlayer Enabling Long-Life Zn Metal Anodes. Advanced Functional Materials, 2021. 31 (46): p. 2104361.
59. Zhang, W., et al., Highly Reversible Zinc Metal Anode in a Dilute Aqueous Electrolyte Enabled by a pH Buffer Additive. Angewandte Chemie International Edition, 2022. n/a (n/a): p. e202212695.
60. Zhong, Y., et al., Monosodium glutamate, an effective electrolyte additive to enhance cycling performance of Zn anode in aqueous battery. Nano Energy, 2022. 98: p. 107220.
61. Zhou, J., et al., Diminishing Interfacial Turbulence by Colloid-Polymer Electrolyte to Stabilize Zinc Ion Flux for Deep-Cycling Zn Metal Batteries. Advanced Materials, 2022. 34 (21): p. 2200131.
62. He, P., et al., Sodium Ion Stabilized Vanadium Oxide Nanowire Cathode for High-Performance Zinc-Ion Batteries. Advanced Energy Materials, 2018. 8 (10): p. 1702463.
63. Yong, B., et al., Understanding the Design Principles of Advanced Aqueous Zinc-Ion Battery Cathodes: From Transport Kinetics to Structural Engineering, and Future Perspectives. Advanced Energy Materials, 2020. 10 (45): p. 2002354.
64. Trócoli, R., et al., Self-discharge in Li-ion aqueous batteries: A case study on LiMn2O4. Electrochimica Acta, 2021. 373: p. 137847.
65. Suo, L., et al., “Water-in-Salt” electrolytes enable green and safe Li-ion batteries for large scale electric energy storage applications. Journal of Materials Chemistry A, 2016. 4 (17): p. 6639-6644.

### Example 3

1. Ellabban, O.; Abu-Rub, H.; Blaabjerg, F. Renewable energy resources: Current status, future prospects and their enabling technology. Renewable Sustainable Energy Rev. 2014, 39, 748-764.
2. Abdalla, A. N.; Nazir, M. S.; Tao, H.; Cao, S.; Ji, R.; Jiang, M.; Yao, L. Integration of energy storage system and renewable energy sources based on artificial intelligence: An overview. J. Energy Storage 2021, 40, 102811.
3. Fang, G.; Zhou, J.; Pan, A.; Liang, S. Recent advances in aqueous zinc-ion batteries. ACS Energy Lett. 2018, 3 (10), 2480-2501.
4. Tang, B.; Shan, L.; Liang, S.; Zhou, J. Issues and opportunities facing aqueous zinc-ion batteries. Energy Environ. Sci. 2019, 12 (11), 3288-3304.
5. Xie, C.; Li, Y.; Wang, Q.; Sun, D.; Tang, Y.; Wang, H. Issues and solutions toward zinc anode in aqueous zinc-ion batteries: A mini review. Carbon Energy 2020, 2 (4), 540-560.
6. Verma, V.; Kumar, S.; Manalastas, W., Jr; Srinivasan, M. Undesired reactions in aqueous rechargeable zinc ion batteries. ACS Energy Lett. 2021, 6 (5), 1773-1785.
7. Yang, W.; Yang, Y.; Yang, H.; Zhou, H. Regulating water activity for rechargeable zinc-ion batteries: Progress and perspective. ACS Energy Lett. 2022, 7 (8), 2515-2530.
8. Chao, D.; Zhou, W.; Xic, F.; Ye, C.; Li, H.; Jaroniec, M.; Qiao, S.-Z. Roadmap for advanced aqueous batteries: From design of materials to applications. Sci. Adv. 2020, 6, eaba4098.
9. Sui, Y.; Ji, X. Anticatalytic strategies to suppress water electrolysis in aqueous batteries. Chem. Rev. 2021, 121 (11), 6654-6695.
10. Chen, R.; Liu, Q.; Xu, L.; Zuo, X.; Liu, F.; Zhang, J.; Zhou, X.; Mai, L. Zwitterionic bifunctional layer for reversible Zn anode. ACS Energy Lett. 2022, 7 (5), 1719-1727.
11. Bayaguud, A.; Fu, Y.; Zhu, C. Interfacial parasitic reactions of zinc anodes in zinc ion batteries: Underestimated corrosion and hydrogen evolution reactions and their suppression strategies. J. Energy Chem. 2022, 64, 246-262.
12. Xiao, P.; Li, H.; Fu, J.; Zeng, C.; Zhao, Y.; Zhai, T.; Li, H. An anticorrosive zinc metal anode with ultra-long cycle life over one year. Energy Environ. Sci. 2022, 15 (4), 1638-1646.
13. Lv, Y.; Zhao, M.; Du, Y.; Kang, Y.; Xiao, Y.; Chen, S. Engineering a self-adaptive electric double layer on both electrodes for high-performance zinc metal batteries. Energy Environ. Sci. 2022, 15 (11), 4748-4760.
14. Hao, J.; Li, X.; Zeng, X.; Li, D.; Mao, J.; Guo, Z. Deeply understanding the Zn anode behaviour and corresponding improvement strategies in different aqueous Zn-based batteries. Energy Environ. Sci. 2020, 13 (11), 3917-3949.
15. Shin, J.; Lee, J.; Park, Y.; Choi, J. W. Aqueous zinc ion batteries: focus on zinc metal anodes. Chem. Sci. 2020, 11 (8), 2028-2044.
16. Du, W.; Ang, E. H.; Yang, Y.; Zhang, Y.; Ye, M.; Li, C. C. Challenges in the material and structural design of zinc anode towards high-performance aqueous zinc-ion batteries. Energy Environ. Sci. 2020, 13 (10), 3330-3360.
17. Tian, S.; Zhou, L.; He, W.; Tian, Y.; Zhou, Y.; Wu, S.; Jian, R.; Balkus, K. J.; Luo, T.; Xiong, G. A self-assembled nanoporous polyelectrolytic interlayer for highly stable zinc metal anodes. Chem. Eng. J. 2023, 462, 142276.
18. Chen, J.; Chen, M.; Ma, H.; Zhou, W.; Xu, X. Advances and perspectives on separators of aqueous zinc ion batteries. Energy Rev. 2022, 1, 100005.
19. Liu, C.; Xie, X.; Lu, B.; Zhou, J.; Liang, S. Electrolyte strategies toward better zinc-ion batteries. ACS Energy Lett. 2021, 6 (3), 1015-1033.
20. Zhang, T.; Tang, Y.; Guo, S.; Cao, X.; Pan, A.; Fang, G.; Zhou, J.; Liang, S. Fundamentals and perspectives in developing zinc-ion battery electrolytes: a comprehensive review. Energy Environ. Sci. 2020, 13 (12), 4625-4665.
21. Tian, S.; Hwang, T.; Malakpour Estalaki, S.; Tian, Y.; Zhou, L.; Milazzo, T.; Moon, S.; Wu, S.; Jian, R.; Balkus, K., Jr; Luo, T.; Cho, K.; Xiong, G. A low-cost quasi-solid-state “water-in-swelling-clay” electrolyte enabling ultra-stable aqueous zinc-ion batteries. Adv. Energy Mater. 2023, 2300782.
22. Chen, M.; Chen, J.; Zhou, W.; Han, X.; Yao, Y.; Wong, C. P. Realizing an all-round hydrogel electrolyte toward environmentally adaptive dendrite-free aqueous Zn—MnO2 batteries. Adv. Mater. 2021, 33 (9), 2007559.
23. Sun, P.; Ma, L.; Zhou, W.; Qiu, M.; Wang, Z.; Chao, D.; Mai, W. Simultaneous regulation on solvation shell and electrode interface for dendrite-free Zn ion batteries achieved by a low-cost glucose additive. Angew. Chem. 2021, 133 (33), 18395-18403.
24 Meng, R.; Li, H.; Lu, Z.; Zhang, C.; Wang, Z.; Liu, Y.; Wang, W.; Ling, G.; Kang, F.; Yang, Q. H. Tuning Zn-ion solvation chemistry with chelating ligands toward stable aqueous Zn anodes. Adv. Mater. 2022, 34 (37), 2200677.
25. Han, D.; Wang, Z.; Lu, H.; Li, H.; Cui, C.; Zhang, Z.; Sun, R.; Geng, C.; Liang, Q.; Guo, X. A self-regulated interface toward highly reversible aqueous zinc batteries. Adv. Energy Mater. 2022, 12 (9), 2102982.
26. Zhang, W.; Dai, Y.; Chen, R.; Xu, Z.; Li, J.; Zong, W.; Li, H.; Li, Z.; Zhang, Z.; Zhu, J.; Guo, F.; Gao, X.; Du, Z.; Chen, J.; Wang, T.; He, G.; Parkin, I. P. Highly reversible zinc metal anode in a dilute aqueous electrolyte enabled by a pH buffer additive. Angew. Chem. Int. Ed. 2023, 62 (5), e202212695.
27. Hu, Z.; Zhang, F.; Zhao, Y.; Wang, H.; Huang, Y.; Wu, F.; Chen, R.; Li, L. A self-regulated electrostatic shielding layer toward dendrite-free Zn batteries. Adv. Mater. 2022, 34 (37), 2203104.
28. Zhou, J.; Zhang, L.; Peng, M.; Zhou, X.; Cao, Y.; Liu, J.; Shen, X.; Yan, C.; Qian, T. Diminishing interfacial turbulence by colloid-polymer electrolyte to stabilize zinc ion flux for deep-cycling Zn metal batteries. Adv. Mater. 2022, 34 (21), 2200131.
29. Cao, J.; Zhang, D.; Yue, Y.; Chanajaree, R.; Wang, S.; Han, J.; Zhang, X.; Qin, J.; Huang, Y. Regulating solvation structure to stabilize zinc anode by fastening the free water molecules with an inorganic colloidal electrolyte. Nano Energy 2022, 93, 106839.
30. Gao, J.; Xie, X.; Liang, S.; Lu, B.; Zhou, J. Inorganic colloidal electrolyte for highly robust zinc-ion batteries. Nano-Micro Lett. 2021, 13, 69.
31. Zhang, H.; Guo, R.; Li, S.; Liu, C.; Li, H.; Zou, G.; Hu, J.; Hou, H.; Ji, X. Graphene quantum dots enable dendrite-free zinc ion battery. Nano Energy 2022, 92, 106752.
32. Zhang, Q.; Luan, J.; Fu, L.; Wu, S.; Tang, Y.; Ji, X.; Wang, H. The three-dimensional dendrite-free zinc anode on a copper mesh with a zinc-oriented polyacrylamide electrolyte additive. Angew. Chem. Int. Ed. 2019, 58 (44), 15841-15847.
33. Luan, J.; Yuan, H.; Wang, H.; Zhao, N.; Zhong, C.; Lu, J. Nanofluid electrolyte with fumed Al2O3 additive strengthening zincophilic and stable surface of zinc anode toward flexible zinc-nickel batteries. Adv. Funct. Mater. 2023, 33 (7), 2210807.
34. Han, D.; Wang, Z.; Lu, H.; Li, H.; Cui, C.; Zhang, Z.; Sun, R.; Geng, C.; Liang, Q.; Guo, X.; Mo, Y.; Zhi, X.; Kang, F.; Weng, Z.; Yang, Q.-H. A self-regulated interface toward highly reversible aqueous zinc batteries. Adv. Energy Mater. 2022, 12 (9), 2102982.
35. Stojadinović, J.; Dushina, A.; Trócoli, R.; La Mantia, F. Electrochemical characterization of gel electrolytes for aqueous lithium-ion batteries. ChemPlusChem. 2014, 79 (10), 1507-1511.
36. Chen, S.; Sun, P.; Sun, B.; Humphreys, J.; Zou, P.; Xie, K.; Tao, S. Nitrate-based ‘oversaturated gel electrolyte’ for high-voltage and high-stability aqueous lithium batteries. Energy Storage Mater. 2021, 37, 598-608.
37. Jaumaux, P.; Yang, X.; Zhang, B.; Safaei, J.; Tang, X.; Zhou, D.; Wang, C.; Wang, G. Localized water-in-salt electrolyte for aqueous lithium-ion batteries. Angew. Chem. Int. Ed. 2021, 60 (36), 19965-19973.
38. Xiao, D.; Dou, Q.; Zhang, L.; Ma, Y.; Shi, S.; Lei, S.; Yu, H.; Yan, X. Optimization of organic/water hybrid electrolytes for high-rate carbon-based supercapacitor. Adv. Funct. Mater. 2019, 29 (42), 1904136.
39. Liu, X.; Wu, D.; Wang, H.; Wang, Q. Self-recovering tough gel electrolyte with adjustable supercapacitor performance. Adv. Mater. 2014, 26 (25), 4370-4375.
40. Ruzicka, B.; Zaccarelli, E. A fresh look at the Laponite phase diagram. Soft Matter 2011, 7 (4), 1268-1286.
41. Cummins, H. Z. Liquid, glass, gel: The phases of colloidal Laponite. J. Non-Cryst. Solids 2007, 353 (41), 3891-3905.
42. Hensen, E. J. M.; Smit, B. Why Clays Swell. J. Phys. Chem. B 2002, 106 (49), 12664-12667.
43. Mourchid, A.; Levitz, P. Long-term gelation of laponite aqueous dispersions. Phys. Rev. E 1998, 57 (5), R4887-R4890.
44. Thompson, D. W.; Butterworth, J. T. The nature of laponite and its aqueous dispersions. J. Colloid Interface Sci. 1992, 151 (1), 236-243.
45. Kumar, S.; Aswal, V. K.; Harikrishnan, G. Polymer concentration regulated aging in aqueous Laponite suspensions. Rheol. Acta 2016, 55, 411-421.
46. Suman, K.; Joshi, Y. M. Microstructure and soft glassy dynamics of an aqueous laponite dispersion. Langmuir 2018, 34 (44), 13079-13103.
47. Mourchid, A.; Delville, A.; Lambard, J.; LeColier, E.; Levitz, P. Phase diagram of colloidal dispersions of anisotropic charged particles: Equilibrium properties, structure, and rheology of laponite suspensions. Langmuir 1995, 11 (6), 1942-1950.
48. Dong, M.; Zhang, K.; Wan, X.; Wang, S.; Fan, S.; Ye, Z.; Wang, Y.; Yan, Y.; Peng, X. Stable two-dimensional nanoconfined ionic liquids with highly efficient ionic conductivity. Small 2022, 18 (14), 2108026.
49. Yan, H.; Li, S.; Nan, Y.; Yang, S.; Li, B. Ultrafast zinc-ion-conductor interface toward high-rate and stable zinc metal batteries. Adv. Energy Mater. 2021, 11 (18), 2100186.
50. Hao, J.; Yuan, L.; Ye, C.; Chao, D.; Davey, K.; Guo, Z.; Qiao, S. Z. Boosting zinc electrode reversibility in aqueous electrolytes by using low-cost antisolvents. Angew. Chem. Int. Ed. 2021, 60 (13), 7366-7375.
51. Huo, X.; Xu, L.; Xic, K.; Zhang, K.; Li, J.; Wang, D.; Shu, K. Cation-selective interface for kinetically enhanced dendrite-free Zn anodes. Adv. Energy Mater. 2023, 13, 2203066.
52. Mizuno, K.; Miyashita, Y.; Shindo, Y.; Ogawa, H. NMR and FTIR studies of hydrogen bonds in ethanol-water mixtures. J. Phys. Chem. 1995, 99 (10), 3225-3228.
53. Chua, R.; Cai, Y.; Lim, P. Q.; Kumar, S.; Satish, R.; Manalastas, W., Jr.; Ren, H.; Verma, V.; Meng, S.; Morris, S. A.; Kidkhunthod, P.; Bai, J.; Srinivasan, M. Hydrogen-bonding interactions in hybrid aqueous/nonaqueous electrolytes enable low-cost and long-lifespan sodium-ion storage. ACS Appl. Mater. Interfaces 2020, 12 (20), 22862-22872.
54. Jørgensen, P. Infrared study of water adsorbed on Wyoming bentonite. Geol. fören. Stockh. förh. 1968, 90 (2), 213-220.
55. Zhu, J.; Bic, Z.; Cai, X.; Jiao, Z.; Wang, Z.; Tao, J.; Song, W.; Fan, H. J. A molecular-sieve electrolyte membrane enables separator-free zinc batteries with ultralong cycle life. Adv. Mater. 2022, 34 (43), 2207209.
56. Zhang, Q.; Ma, Y.; Lu, Y.; Li, L.; Wan, F.; Zhang, K.; Chen, J. Modulating electrolyte structure for ultralow temperature aqueous zinc batteries. Nat. Commun. 2020, 11 (1), 4463.
57. Chen, W.; Guo, S.; Qin, L.; Li, L.; Cao, X.; Zhou, J.; Luo, Z.; Fang, G.; Liang, S. Hydrogen bond-functionalized massive solvation modules stabilizing bilateral interfaces. Adv. Funct. Mater. 2022, 32 (20), 2112609.
58. Wang, H.; Ye, W.; Yin, B.; Wang, K.; Riaz, M. S.; Xic, B.-B.; Zhong, Y.; Hu, Y. Modulating cation migration and deposition with xylitol additive and oriented reconstruction of hydrogen bonds for stable zinc anodes. Angew. Chem. Int. Ed. 2023, 135, e202218872.
59. Zhou, M.; Guo, S.; Li, J.; Luo, X.; Liu, Z.; Zhang, T.; Cao, X.; Long, M.; Lu, B.; Pan, A.; Fang, G.; Zhou, J.; Liang, S. Surface-preferred crystal plane for a stable and reversible zinc anode. Adv. Mater. 2021, 33 (21), 2100187.
60. Zhao, Z.; Zhao, J.; Hu, Z.; Li, J.; Li, J.; Zhang, Y.; Wang, C.; Cui, G. Long-life and deeply rechargeable aqueous Zn anodes enabled by a multifunctional brightener-inspired interphase. Energy Environ. Sci. 2019, 12 (6), 1938-1949.
61. Zeng, Y.; Zhang, X.; Qin, R.; Liu, X.; Fang, P.; Zheng, D.; Tong, Y.; Lu, X. Dendrite-free zinc deposition induced by multifunctional CNT frameworks for stable flexible Zn-ion batteries. Adv. Mater. 2019, 31 (36), 1903675.
62. Shi, J.; Sun, T.; Bao, J.; Zheng, S.; Du, H.; Li, L.; Yuan, X.; Ma, T.; Tao, Z. Water-in-deep eutectic solvent” electrolytes for high-performance aqueous Zn-ion batteries. Adv. Funct. Mater. 2021, 31 (23), 2102035.
63. Wang, D.; Li, Q.; Zhao, Y.; Hong, H.; Li, H.; Huang, Z.; Liang, G.; Yang, Q.; Zhi, C. Insight on organic molecules in aqueous Zn-ion batteries with an emphasis on the Zn anode regulation. Adv. Energy Mater. 2022, 12 (9), 2102707.
64. Blandamer, M. J.; Engberts, J. B. F. N.; Gleeson, P. T.; Reis, J. C. R. Activity of water in aqueous systems; A frequently neglected property. Chem. Soc. Rev. 2005, 34 (5), 440-458.
65. Scatchard, G. The speed of reaction in concentrated solutions and the mechanism of the inversion of sucrose. J. Am. Chem. Soc. 1921, 43 (11), 2387-2406.
66. Scatchard, G. The hydration of sucrose in water solution as calculated from vapor-pressure measurements. J. Am. Chem. Soc. 1921, 43 (11), 2406-2418.
67. Dong, N.; Zhao, X.; Yan, M.; Li, H.; Pan, H. Synergetic control of hydrogen evolution and ion-transport kinetics enabling Zn anodes with high-areal-capacity. Nano Energy 2022, 104, 107903.
68. Zhou, J.; Zhang, L.; Peng, M.; Zhou, X.; Cao, Y.; Liu, J.; Shen, X.; Yan, C.; Qian, T. Diminishing interfacial turbulence by colloid-polymer electrolyte to stabilize zinc ion flux for deep-cycling Zn metal batteries. Adv. Mater. 2022, 34 (21), 2200131.
69. Trócoli, R.; Morata, A.; Erinmwingbovo, C.; La Mantia, F.; Tarancón, A. Self-discharge in Li-ion aqueous batteries: A case study on LiMn2O4. Electrochim. Acta 2021, 373, 137847.
70. Suo, L.; Han, F.; Fan, X.; Liu, H.; Xu, K.; Wang, C. Water-in-Salt” electrolytes enable green and safe Li-ion batteries for large scale electric energy storage applications. J. Mater. Chem. A 2016, 4 (17), 6639-6644.
71. Sonigara, K. K.; Zhao, J.; Machhi, H. K.; Cui, G.; Soni, S. S. Self-assembled solid-state gel catholyte combating iodide diffusion and self-discharge for a stable flexible aqueous Zn—I2 battery. Adv. Energy Mater. 2020, 10 (47), 2001997.
72. Machhi, H. K.; Sonigara, K. K.; Bariya, S. N.; Soni, H. P.; Soni, S. S. Hierarchically porous metal-organic gel hosting catholyte for limiting iodine diffusion and self-discharge control in sustainable aqueous zinc-I2 batteries. ACS Appl. Mater. Interfaces 2021, 13 (18), 21426-21435.
73. Zhu, Y.; Yin, J.; Zheng, X.; Emwas, A.-H.; Lei, Y.; Mohammed, O. F.; Cui, Y.; Alshareef, H. N. Concentrated dual-cation electrolyte strategy for aqueous zinc-ion batteries. Energy Environ. Sci. 2021, 14 (8), 4463-4473.
74. Cui, J.; Wu, X.; Yang, S.; Li, C.; Tang, F.; Chen, J.; Chen, Y.; Xiang, Y.; Wu, X.; He, Z. Cryptomelane-type KMn8O16 as potential cathode material for aqueous zinc ion battery. Front. Chem. 2018, 6, 352.
75. Tang, F.; Gao, J.; Ruan, Q.; Wu, X.; Wu, X.; Zhang, T.; Liu, Z.; Xiang, Y.; He, Z.; Wu, X. Graphene-wrapped MnO/C composites by MOFs-derived as cathode material for aqueous zinc ion batteries. Electrochim. Acta 2020, 353, 136570.
76. Gao, L.; Li, Z.; Zou, Y.; Yin, S.; Peng, P.; Shao, Y.; Liang, X. A high-performance aqueous zinc-bromine static battery. Iscience 2020, 23 (8), 101348.
77. Trócoli, R.; Morata, A.; Erinmwingbovo, C.; La Mantia, F.; Tarancon, A. Self-discharge in Li-ion aqueous batteries: A case study on LiMn2O4. Electrochim. Acta 2021, 373, 137847.
78. Yang, G.; Li, Q.; Ma, K.; Hong, C.; Wang, C. The degradation mechanism of vanadium oxide-based aqueous zinc-ion batteries. J. Mater. Chem. A 2020, 8 (16), 8084-8095.
79. Kresse, G.; Furthmüller, J. Efficiency of ab-initio total energy calculations for metals and semiconductors using a plane-wave basis set. Comput. Mater. Sci. 1996, 6 (1), 15-50.
80. Perdew, J. P.; Burke, K.; Ernzerhof, M. Generalized gradient approximation made simple. Phys. Rev. Lett. 1996, 77 (18), 3865-3868.
81. Liu, Y.; Merinov, B. V.; Goddard, W. A. Origin of low sodium capacity in graphite and generally weak substrate binding of Na and Mg among alkali and alkaline earth metals. Proc. Natl. Acad. Sci. 2016, 113 (14), 3735-3739.
82. Suzuki, S.; Prayongphan, S.; Ichikawa, Y.; Chae, B.-G. In situ observations of the swelling of bentonite aggregates in NaCl solution. Appl. Clay Sci. 2005, 29 (2), 89-98.

What is claimed is:

1. An electrolyte comprising:
a layered clay material comprising one or more intercalated ions, wherein the one or more intercalated ions form an intercalation layer.

2. The electrolyte of claim 1, wherein the one or more intercalated ions are selected from lithium ions, calcium ions, potassium ions, magnesium ions, sodium ions, ammonium ions, fluoride ions, chloride ions, hydrogen ions, lanthanum ions, indium ions, and combinations thereof.

3. The electrolyte of claim 1, wherein the layered clay material comprises naturally occurring or synthetic swelling clays, or combinations thereof.

4. The electrolyte of claim 3, wherein the layered clay material comprises silicate, alumina, magnesia, or combinations thereof.

5. The electrolyte of claim 1, wherein the intercalation layer further comprises water.

6. The electrolyte of claim 5, wherein the intercalated water is reversibly removed and absorbed.

7. The electrolyte of claim 1, wherein an intercalation layer distance is varied by intercalation ion composition.

8. An electrochemical cell comprising:
an anode and a cathode; and
a semi-solid electrolyte comprising:
a layered clay material comprising one or more intercalated ions, wherein the one or more intercalated ions form an intercalation layer; and
an aqueous electrolyte.

9. The electrochemical cell of claim 8, wherein the one or more intercalated ions are selected from lithium ions, calcium ions, potassium ions, magnesium ions, sodium ions, fluoride ions, chloride ions, ammonium ions, hydrogen ions, lanthanum ions, indium ions, or combination thereof.

10. The electrochemical cell of claim 8, wherein the layered clay material comprises naturally occurring or synthetic swelling clays, or combinations thereof.

11. The electrochemical cell of claim 10, wherein the layered clay material comprises silicate, alumina, magnesia, or combinations thereof.

12. The electrochemical cell of claim 8, wherein the aqueous electrolyte salt comprises a concentration of 1-3 Molar.

13. The electrochemical cell of claim 8, wherein the semi-solid electrolyte comprises about up to 100% w/v of layered clay material in aqueous electrolyte.

14. The electrochemical cell of claim 8, wherein the intercalation layer absorbs water from the aqueous electrolyte.

15. The electrochemical cell of claim 8, wherein the semi-solid electrolyte acts as a separator.

16. The electrochemical cell of claim 8, wherein the anode is a zinc-based anode.

17. The electrochemical cell of claim 8, wherein the cathode comprises vanadium-based oxides, manganese-based materials, Prussian blue analogues, cobalt-based oxides, polyanionic compounds, or combinations thereof.

18. The electrochemical cell of claim 8, wherein the electrochemical cell operates at over 2 volts.
